(19) United States
(12) Patent Application Publication
(10) Pub. No.: US 2006/0293873 A1
(43) Pub. Date: Dec. 28, 2006

(54) Systems and methods for reverse engineering models of biological networks

(75) Inventors: Timothy S. Gardner, Needham, MA (US); James J. Collins, Newton, MA (US); Diego di Bernardo, Naples (IT); Jesper Tegner, Stockholm (SE); Man Kit Stephen Yeung, Logan, UT (US)

Correspondence Address: CHOATE, HALL & STEWART LLP, TWO INTERNATIONAL PLACE, BOSTON, MA, 02110, US

(73) Assignee: Trustees of Boston University, Boston, MA (US)

(21) Appl. No.: 10/506,734

(22) PCT Filed: Mar. 5, 2003
(86) PCT No.: PCT/US03/06491

§ 371 Date: Oct. 31, 2005

Related U.S. Application Data
(60) Provisional application No. 60/362,242, filed on Mar. 6, 2002.
(60) Provisional application No. 60/362,241, filed on Mar. 6, 2002.
(60) Provisional application No. 60/441,564, filed on Jan. 21, 2003.

(51) Int. Cl. G06G 7/48; G06G 7/58

(52) U.S. Cl. 703/11

(57) ABSTRACT

The present invention provides methods and accompanying computer-based systems and computer-executable code stored on a computer-readable medium for constructing a model of a biological network. The invention further provides methods for performing sensitivity analysis on a biological network and for identifying major regulators of species in the network and of the network as a whole. In addition, the invention provides methods for identifying targets of a perturbation such as that resulting from exposure to a compound or an environmental change. The invention further provides methods for identifying phenotypic mediators that contribute to differences in phenotypes of biological systems.

### PRIORITY CLAIM

The present application claims priority to U.S. Ser. No. 60/362,241, filed Mar. 6, 2002, U.S. Ser. No. 60/362,242, filed Mar. 6, 2002, and U.S. Ser. No. 60/441,564 filed Jan. 21, 2003. The entire contents of these applications are incorporated herein by reference.

### GOVERNMENT SUPPORT

This invention was made with Government Support under Contract Number F30602-01-2-0579, awarded by the Air Force Research Laboratory, Grant Number EIA-0130331 awarded by the National Science Foundation, and Grant Number N00014-99-1-0554 awarded by the Office of Naval Research. The Government has certain rights in the invention.

### BACKGROUND OF THE INVENTION

The functioning of a complex biological system such as a living cell or organism is governed by a myriad of regulatory relationships and interactions between different genes, proteins, and metabolites. Elucidating networks of interacting biochemical species and identifying the regulatory relationships between them is of great scientific interest and practical importance for once they are understood it becomes much more feasible to develop ways to influence the state of the system.

Biology has traditionally proceeded in a “bottom-up” fashion, focusing on understanding the functions of individual genes, proteins, and metabolites and their roles in particular biochemical pathways. However, technical developments such as cDNA microarray based measurement of RNA expression and proteomics have opened the opportunity for large-scale acquisition of biological data. These advances have led to an increasing emphasis on a “top-down” approach, leading towards a more comprehensive understanding of the interactions between cellular constituents on a global scale.

In addition to shedding light on the manner in which cells orchestrate their activities, understanding networks of biological components and interactions has a number of applications in, for example, medicine and the discovery and development of pharmaceuticals. For example, microarray analysis has identified many differences between the gene transcription profiles of normal and malignant cells in a variety of different tumor types. Knowledge of the regulatory relationships between these genes can suggest methods of diagnosis and also help identify the most appropriate targets for therapeutic intervention.

Approaches to defining the components and organization of biological networks include experimental and computational methods for identifying putative gene, protein and metabolite interactions (e.g., 3, 5) and for identifying regulatory modules and characteristics (e.g., 9, 11). Although these methods have achieved some success, they tend to be data intensive or, in many cases, provide limited functional information. Computational modeling and simulation (e.g., 12, 14) has provided valuable insights into network function, but typically requires extensive and quantitative prior information which is not generally available, particularly for larger regulatory networks. On the other hand, experimental methods typically use little prior knowledge of the network, but generally define only structural features; they often fail to identify the regulatory role of individual elements or the overall functional properties of the network. There remains a need in the art for improved methods for identifying and modeling gene, protein, and metabolite regulatory interactions. In addition, there remains a need in the art for improved methods of identifying key genes within such a network.

### SUMMARY OF THE INVENTION

The present invention provides methods and accompanying computer-based systems and computer-executable code stored on a computer-readable medium for constructing a model of a biological network. Certain of the inventive methods involve constructing such models using measurements of inputs to and outputs from the network, and may thus be referred to as “reverse engineering” the network. The invention further provides methods for performing sensitivity analysis on a biological network and for identifying major regulators of species in the network and of the network as a whole. In addition, the invention provides methods for identifying targets of a perturbation such as that resulting from exposure to a compound or an environmental change. The invention further provides methods for identifying phenotypic mediators that contribute to differences in phenotypes of biological systems.

In one aspect, the invention provides a model of a biological network, comprising a set of differential equations or difference equations in which the activities of the individual elements of the network, i.e., the biochemical species, are represented by variables. The equations express the regulatory relationships between the different biochemical species. The invention further provides a model of a biological network comprising an approximation (e.g., a Taylor polynomial approximation) to a set of differential equations or difference equations in which the activities of the elements of the network are represented by variables.

In another aspect, the invention provides a method of constructing a model of a biological network comprising steps of: (i) providing a biological system or a plurality of biological systems, each biological system comprising a biological network comprising a plurality of biochemical species having activities; (ii) perturbing the activity of at least one of the biochemical species, thereby causing a response in the biological network; (iii) allowing the biological network to reach a steady state; (iv) determining the response of at least one of the biochemical species in the biological network; and (v) estimating parameters of the model. In certain embodiments of the invention the model comprises an approximation (e.g., a Taylor polynomial approximation) to a set of differential or difference equations in which the activities of the elements of the network (biochemical species) are represented by variables.

According to certain embodiments of the invention the parameters of the model are estimated by (i) selecting a fitness function; and either computing the values of the parameters that optimize the fitness function; or (i) selecting a search procedure; and (ii) applying the selected search procedure so as to identify the values of the parameters that optimize (e.g., minimize or maximize) the selected fitness function. In certain embodiments of the invention the search procedure comprises (a) generating all putative network structures including one or more regulatory inputs per biochemical species, but not more regulatory inputs than the maximum number of regulatory inputs; (b) calculating or searching for parameters that optimize a chosen fitness function for each putative network structure; and (c) selecting as a solution whichever of the putative networks of step (b), comprising a network structure and parameters, optimizes the fitness function. In other embodiments of the invention the search procedure comprises (a) generating one or more putative network structures including one or more regulatory inputs per gene (but not more regulatory inputs than the maximum number of regulatory inputs); (b) calculating or searching for the parameters that optimize a chosen fitness function for each putative network structure; (c) selecting one or more of the putative networks of step (b) (i.e., network structure/parameter combinations) with optimal fitness as determined by the fitness function; (d) stopping the search if the one or more of the putative networks selected in part (c) satisfies some chosen stop criterion, such as a particular level of fitness, in which case one or more of the resulting network structures and parameters are the desired solutions; (e) if the stop criterion is not met, then generating one or more variants of the network structures selected in step (c) and returning to step (b).

In another aspect, the invention provides a method of performing sensitivity analysis on a biological network comprising steps of: (i) generating a model of the biological network according to any of the inventive methods for constructing a model of a biological network described herein; and (ii) determining the sensitivity of the activities of a first set of one or more species in the network to a change in the activities of a second set of one or more species in the network using the model.

According to another aspect, the invention provides methods of identifying a target of a perturbation comprising steps of (i) providing a biological system comprising a biological network comprising a plurality of biochemical species having activities; (ii) providing or generating a model of the biological system constructed according to any of the inventive methods for constructing a model of a biological network described herein; (iii) perturbing one or more biochemical species in the network; (iv) allowing the biological network to reach a steady state; (v) determining the response of at least one of the biochemical species in the biological network to the compound; and (vi) calculating predicted perturbations of biochemical species in the biological network that would be expected to yield the determined responses according to the model. The methods may further comprise the step of identifying a biochemical species as a target of the perturbation if the predicted perturbation to that biochemical species meets a predefined criterion or criteria.

According to another aspect, the invention provides the invention provides a method for identifying phenotypic mediators comprising steps of: (i) comparing parameters of models of biological networks for a plurality of biological systems, wherein the models are generated according to any of the inventive methods for constructing models of biological networks described herein, and wherein the biological networks comprise overlapping or substantially identical sets of biochemical species; and (ii) identifying biochemical species for which associated parameters differ between the models as candidate phenotypic mediators.

In another aspect, the present invention provides a computer system for implementing and applying the methods of the invention, storing results, etc. In particular, the invention provides a computer system for constructing a model of a biological network, the computer system comprising: (i) memory that stores a program comprising computer-executable process steps; and (ii) a processor which executes the process steps so as to estimate parameters of a model of a biological network, the model comprising an approximation to a set of differential equations or a set of difference equations that represent evolution over time of activities of a plurality of biochemical species in a biological network. The process steps may perform any of the inventive methods described herein.

In another aspect, the invention further provides computer-executable process steps stored on a computer-readable medium, the computer-executable process steps to construct a model of a biological network, the computer-executable process steps comprising: code to estimate parameters of a model of a biological network, the model comprising an approximation to a set of differential equations or a set of difference equations that represent evolution over time of activities of at least one biochemical species in a biological network. The code may implement any of the inventive methods described herein.

This application refers to various patents, journal articles, and other publications, all of which are incorporated herein by reference. In addition, the following standard reference works are incorporated herein by reference: Current Protocols in Molecular Biology, Current Protocols in Immunology, Current Protocols in Protein Science, and Current Protocols in Cell Biology, John Wiley & Sons, N.Y., edition as of July 2002; Sambrook, Russell, and Sambrook, Molecular Cloning: A Laboratory Manual, 3^{rd} ed., Cold Spring Harbor Laboratory Press, Cold Spring Harbor, 2001. Unless otherwise stated, mathematical symbols are to be given their standard meaning.

### BRIEF DESCRIPTION OF THE DRAWING

FIG. 1 presents a diagram of interactions in the SOS network.

FIG. 2A presents a diagram of the pBADX53 expression plasmid used to perturb expression of transcripts in the test network, where gene X is one of the nine test-network genes. The endogenous ribosome binding site (RBS) for each gene X is included in the plasmid.

FIG. 2B is a schematic diagram showing the induction of RNA synthesis following addition of arabinose to a culture, and the achievement of steady state after several hours.

FIG. 3 illustrates model recovery performance for simulations and experiment. Simulations are represented by filled squares. Experimental results are represented by open triangles. The figure illustrates results for models recovered using a nine-perturbation training set (main figures) and a seven-perturbation training set (insets).

FIG. 4 is a bar graph illustrating identification of perturbed genes using the model. Cells were perturbed either with a lexA/recA double perturbation or MMC. The mean relative expression changes (x), normalized by their standard deviations (Sx), are illustrated for the double perturbation (A) and the MMC perturbation (C). Arrows indicate the genes targeted by the perturbation. The network model recovered using the nine-perturbation training set was applied to the expression data in A and C. The predicted perturbations to each gene ( ), normalized by their standard deviations (S), are illustrated for the double perturbation (B) and the MMC perturbation (D). In all panels, hatched bars indicate statistically significant, and solid bars indicate statistically non-significant. Horizontal lines (other than line at 0) denote significance levels: P=0.3 (dashed), P=0.1 (solid).

FIG. 5 is a bar graph illustrating perturbation recovery performance for simulated networks. Coverage (genes correctly identified as perturbed by the network model/total number of perturbed genes) and specificity (genes correctly identified as unperturbed by the network model/total number of unperturbed genes) were calculated for models recovered using a nine-perturbation training set (leftmost bars and bars second from right in each set) and a seven-perturbation training set (remaining bars). Solid bars denote coverage; open bars denote specificity.

FIG. 6 shows the effect of n (maximum connectivity allowed in model structure, i.e., maximum number of regulatory inputs to each species) on the recovery of randomly connected networks of nine genes with an average of five regulatory inputs per gene. Coverage and false positives were calculated for n=6 (circles), n=5 (squares), n=4 (triangles).

FIG. 7 is a bar graph illustrating identification of perturbed genes using a network model recovered from a seven-perturbation training set that excluded the lexA and recA training perturbations. Cells were perturbed either with a lexA/recA double perturbation or MMC. The mean relative expression changes (x) normalized by their standard errors (Sx) are illustrated for the double perturbation (A) and the MMC perturbation (C). Arrows indicate the genes targeted by the perturbation. The network model recovered using the seven-perturbation training set was applied to the expression data in A and C. The predicted perturbations to each gene ( ), normalized by their standard deviations (S), are illustrated for the double perturbation (B) and the MMC perturbation (D). In all panels, hatched bars indicate statistically significant, solid bars indicate statistically non-significant. Horizontal lines (other than the line at 0) denote significance levels: P=0.3 dashed, P=0.1 solid.

FIG. 8 illustrates performance of clustering and correlation for identifying perturbed genes. (A) Expression profiles for the MMC perturbation and all perturbations in the training set are compared using average-linkage clustering. (B) Pair-wise correlation of the MMC perturbation profile with each perturbation in the training set. Hatched bars indicate statistically significant; solid bars indicate statistically non-significant. Horizontal lines (other than at 0) denote significance levels: P=0.3 (dashed), P=0.1 (solid).

FIG. 9 depicts a representative embodiment of a computer system of the invention.

### DETAILED DESCRIPTION OF CERTAIN EMBODIMENTS OF THE INVENTION

I. Biological Networks and Network Models

The present invention provides methods and accompanying apparatus for constructing a model of a biological network comprising a plurality of biochemical species, and for using the model for a variety of purposes. In particular, the invention provides a method of constructing a model of a biological network comprising steps of: (i) providing a biological system or a plurality of biological systems, each biological system comprising a biological network comprising a plurality of biochemical species having activities; (ii) perturbing the activity of at least one of the biochemical species, thereby causing a response in the biological network; (iii) allowing the biological network to reach a steady state; (iv) determining the response of at least one of the biochemical species in the biological network; and (v) estimating parameters of the model. In general, a biological network is a component of a biological system such as a cell, cell population, tissue, organ, multicellular organism, etc. For purposes of description it will be assumed that the biological system is a cell, but the methods described herein may readily be extended to other types of biological systems. As used herein, the term “biochemical species” encompasses cellular constituents of a variety of different types, such as deoxyribonucleic acid (DNA) molecules, genes, ribonucleic acid (RNA) molecules, proteins, metabolites (i.e., molecules that have been synthesized, modified, or acted upon by one or more RNAs or proteins present in or on the cell or within an organism), and other molecules present in or on the cell or within an organism.

In accordance with the present invention, a biological network comprises a group of biochemical species in which individual biochemical species may influence or affect the activity of other biochemical species within the network. A biological network may include biochemical species of only a single type or may include biochemical species of multiple different types. For example, a network may include genes but not RNA molecules, proteins, metabolites, or other molecules. Alternately, a network may include a combination of different types of biochemical species, e.g., genes and proteins. Where the biological system is a cell population, tissue, organ, or multicellular organism, the biochemical species may be individual cells (in the case of a cell population or tissue), individual cells or tissues (in the case of an organ), or individual cells, tissues, or organs (in the case of a multicellular organism), in addition to any of the biochemical species mentioned above. It will be appreciated that when the biological system is a cell, measurements of activities typically involve populations of cells. Nevertheless, the model may be considered to represent a biological network as present in a single cell.

A biological network may be defined to include any number of biochemical species, provided it is possible to measure their activity and, preferably, feasible to perturb it (although it is not a requirement that all species in a network be perturbed or perturbable). Thus the species included in the network may be selected in any manner desired by the experimenter. The methods described herein identify interactions between any arbitrarily (or otherwise) set of biochemical species, and construct a model of a biological network comprising the species.

In general, each biochemical species included in a network will have one or more associated properties or features, referred to as “activities”. In the case of genes, the activity typically represents the level of expression of the gene (e.g., whether or not it is transcribed (“on/off”) or, preferably, a quantitative amount of expression), which may be measured in terms of RNA or protein level. By “expression level of a gene” is meant the abundance of either RNA transcribed using that gene as a template or the abundance of protein encoded by that gene. By “expression level” of species other than a gene is meant the abundance of that species in the biological system. In the case of RNA molecules, proteins, metabolites, or other molecules the activity may represent the expression level or abundance of the biochemical species within the biological system. In general, an expression level or abundance of a species may be expressed in terms of absolute or relative abundance, absolute or relative concentration, or using any other appropriate means. Alternately, the activity may represent a property such as ability to catalyze a biochemical reaction (enzymatic activity), etc.

Many of the cellular constituents mentioned above may exist in a variety of different forms or states. For example, genes may be methylated or unmethylated. RNA molecules may be spliced, polyadenylated, or otherwise processed. Proteins may be phosphorylated, glycosylated, cleaved, etc. In addition, cellular constituents may associate with other cellular constituents and/or be present in complexes with other constituents. Each of these different forms or states of any individual cellular constituent may be considered a biochemical species as may complexes comprising multiple cellular constituents. For example, a methylated form of an enzyme may be considered a first biochemical species with an activity that represents the concentration of the methylated form, while the unmethylated form of the same enzyme may be considered a second species with an activity that represents its catalytic rate. Alternately, one or more different forms or states of a cellular constituent may be considered to be a single biochemical species, with each form or state having a different activity. For example, a phosphorylated protein may be assigned an activity of 1, while the unphosphorylated form may be assigned an activity of 0. A number between 0 and 1 then reflects the degree of phosphorylation of the protein, considered as a single biochemical species, within the biological system.

It will be evident that any particular biochemical species may have multiple activities that may be significant in terms of the interaction of the biochemical species with other biochemical species in the network. For example, a protein may have both an expression level and a phosphorylation state.

In the physical world, a biological network comprises actual genes, RNA molecules, proteins, metabolites, and other molecules. These elements may interact (e.g., physically interact) so as to influence or regulate each other's activity. For example, a transcription factor may bind to a promoter located upstream of a coding sequence in a gene, which ultimately leads to increased transcription of an mRNA for which the gene provides a template. A protein kinase may transfer a phosphate group to a substrate protein, which may increase or decrease the enzymatic activity of the substrate.

The methods described herein are applicable to cells of any type, including prokaryotic, e.g., bacterial, and eukaryotic, e.g., yeast and other fingi, insect, and mammalian, including human. The methods may be applied to either wild type or mutant cells, cells obtained from an individual suffering from a condition such as a particular disease, cells that have become resistant to therapy, cells that have been genetically altered, etc. As described below, the models of biological networks have a number of applications. For example, the models can be used to identify regulators of particular biological species major regulators of the network, and biochemical targets of compounds and environmental changes.

In general, biological networks can be represented graphically and/or mathematically. The present invention provides a model of a biological network, comprising a set of differential equations or difference equations in which the activities of the individual elements of the network, i.e., the biochemical species, are represented by variables. The equations express the regulatory relationships between the different biochemical species. In particular, for any given biochemical species i in the network, the equations quantitatively describe the manner in which the activities of the various biochemical species in the network (including i) affect the activity of i. For purposes of description, the invention will be described with reference to differential equations, but the methods may also be used with difference equations.

In accordance with the invention, the time evolution of activities of biochemical species (e.g., genes, RNA molecules, proteins, metabolites, and other molecules) in a biological network may be described by a set of ordinary differential equations:
\dot{x}=f(x)−Dx (Eq. 1)

where x=(x₁, x₂, . . . x_{N}) represents the activities of N genes, RNA molecules, proteins, metabolites, or other molecules in the network; where f(x)=(f₁(x), f₂(x), . . . ,f_{N}(x)) is a vector function of x; and where D=diag (d₁, d₂, . . . ,d_{N}) is a diagonal matrix of degradation rate constants for each of the N biochemical species. In general, the equations represent the time evolution of activities of at least one biochemical species in a biological network. In certain embodiments of the invention the equations represent the time evolution of activities of a plurality of biochemical species in a biological network.

According to certain embodiments of the invention the differential equations are nonlinear ordinary differential equations. However, linear differential equations and/or partial differential equations may also be used. If desired, partial differential equations may be transformed into ordinary differential equations using a finite element or finite difference approximation. In addition, ordinary differential equations may be transformed into difference equations using a finite difference approximation. In a finite difference approximation, \dot{x}is approximated as (x(t+Δt)−x(t))/Δt, where t represents time and Δt is any desired time interval.

Eq. 1 may also be written as N separate equations, one for each biochemical species i, as follows:
\dot{x}ᵢ=fᵢ(x)−dᵢxᵢ,i=1, . . . ,N (Eq. 2)

The equations above provide a model of a biological network in accordance with the present invention. However, the parameters of the model as presented above remain undetermined. The following sections describe certain embodiments of the inventive approach, involving approximating the model using a polynomial (thereby constructing an additional model of the biological network), and determining the parameters of this polynomial model of the biological network. Other embodiments are also within the scope of the invention. Table 1 presents a list defining a number of symbols used herein.

TABLE 1
Symbol definitions.

| | |
|---|---|
| a: | first-order model (Taylor series) coefficients |
| b: | second-order model (Taylor series) coefficients |
| c: | non-zero elements of w |
| \tilde{c}: | estimate of non-zero elements of w |
| d: | degradation rate of network species activities |
| e: | error function for Taylor polynomial approximation |
| g: | fitness function |
| g^{tse:} | Total Squared Error fitness function |
| g^{xse:} | maXimum Squared Error fitness function |
| g^{tae:} | Total Absolute Error fitness function |
| f: | nonlinear model of the biochemical network |
| i: | index for output species |
| j, k: | indices for input species |
| l: | index for perturbation experiment |
| m: | order of the Taylor approximation the biochemical network |
| n: | number of regulatory input connections per species |
| p: | external perturbation to rate of synthesis of network species activity |
| q: | normal transformation of steady-state activity ratio, v, of network species |
| r: | normalized first-order Taylor series coefficients |
| s: | normalized second-order Taylor series coefficients |
| u: | = p/(x^{ss} d), activity ratio of steady-state perturbation |
| ũ: | predicted perturbation, u |
| v: | = x/x^{ss}, steady-state activity ratio of network species |
| w: | model coefficients (Taylor series coefficients) in normal form |
| \tilde{w}: | estimate of model coefficients, w |
| x: | activity of biochemical species in network |
| y: | = −u |
| ŷ: | predictor for y |
| z: | data q plus noise, γ |
| B: | matrix of second order Taylor series coefficients |
| Cₖ: | Taylor series coefficient with index k and order \|k\| |
| D: | number of solutions selected in each iteration of Forw-TopD-reest-n search |
| | algorithm |
| D: | diagonal matrix of degradation rates |
| F: | domain of a function f(x) near the point x^{o} |
| R(Δx): | Taylor series terms of order greater than 2 |
| Hₖ: | bound on error of Taylor polynomial approximation of order \|k\| |
| K: | number of non-zero parameters in w |
| N: | number of species in the biochemical network |
| M: | number of experiments |
| P: | number of parameters in w |
| Q: | data points, qₗ, from M experiments |
| W: | matrix of normalized model weights |
| V: | basis vectors for nullspace of Q^{T} |
| α: | fit parameters for minimization of non-zero weights |
| γ: | Gaussian, uncorrelated measurement noise on q |
| ε: | Gaussian, uncorrelated measurement noise on u |
| λ: | fitting parameters for fitness function |
| η: | = c² var(γ) + var(ε), regression model noise |
| ρ: | renormalized model coefficients, w, in case of unperturbed network species |
| X^{2:} | goodness of fit statistic |
| Λ: | diagonal matrix of fitting parameters, λ |
| Σ_{η:} | diagonal matrix of model noise variances |

II. Approximating a Biochemical Network Model with a Polynomial

According to a preferred embodiment of the invention, it is assumed that fᵢ(x) is analytic near a steady state of the network, x^{ss}, i.e., fᵢ(x) is defined and differentiable on some domain, F, near the point x^{ss}. (The meaning of steady state and the requirements for satisfying this assumption when measuring the activities of biochemical species in a network in order to determine the parameters of the model are described below.) Eq. 2 may then be rewritten using a Taylor series as follows:

$${\dot{x}}_{i} = {f}_{i} ( {\underline{x}}^{SS} ) - {d}_{i} {x}_{i}^{SS} + {\sum }_{j} {a}_{ij} Δ {x}_{j} + {\sum }_{j , k} {b}_{jk , i}^{T} Δ {x}_{j} Δ {x}_{k} + {R}_{i} ( Δ \underline{x} ) - {d}_{i} Δ {x}_{i} , \\ i = 1 , … , N \qquad ( Eq . 3 )$$

where Δxⱼ=xⱼ−xⱼ^{ss}, aᵢⱼ, and b_{j,k,i} are the first and second order coefficients of the Taylor series of fᵢ(x), and Rᵢ(Δx) represents all higher order terms. (in general, unless otherwise indicated, the subscripts j and k are understood to run from 1 to N, the number of species in the network.) Taylor series representation of functions and software embodiments thereof are known in the art and described in detail in E. Kreyszig, Advanced Engineering Mathematics, 7^{th} Edition (John Wiley & Sons, New York) 1993 and R. D. Neidinger, Proceedings of the International Conference on Applied Programming Languages, 25: 134-144 (ACM Press, 1995).

At steady state,
\dot{x}ᵢ^{ss}=fᵢ(x^{ss})−dᵢxᵢ^{ss}=0,i=1, . . . ,N (Eq. 4)

Thus Eq. 3 becomes:

$${\dot{x}}_{i} = {\sum }_{j} {a}_{ij} Δ {x}_{j} + {\sum }_{j , k} {b}_{jk , i} Δ {x}_{j} Δ {x}_{k} + {R}_{i} ( Δ \underline{x} ) - {d}_{i} Δ {x}_{i} , \\ i = 1 , … , N \qquad ( Eq . 5 )$$

Eq. 2 may be approximated as a Taylor polynomial of any desired accuracy by truncating higher order terms of Eq. 5. Inclusion of higher order terms improves the accuracy of the approximation.

It will be appreciated that for any given biological network the functions fᵢ(x) are typically not known. Thus the coefficients of the Taylor polynomial approximations (i.e., the parameters of the model) cannot be calculated directly. Instead, according to the invention the coefficients are estimated from multiple measurements of x. In general, the number of measurements required to correctly estimate the parameters of a function (sample complexity) increases exponentially with the number of parameters in the function. (L. Ljung, System Identification: Theory for the User, 2^{nd} Edition (Prentice Hall, Upper Saddle River, N.J.) 1999).

Thus the greater accuracy obtained by including higher order terms in the polynomial approximation comes at the cost of increased sample complexity. Therefore, it is often desirable to sacrifice accuracy in order to maintain a low sample complexity.

In accordance with the inventive methods, it is assumed that the biological network remains in a domain near x^{ss}, so that Δx is small. Then a satisfactory approximation may be obtained using a first order polynomial:

$${\dot{x}}_{i} = {\sum }_{j} {a}_{ij} Δ {x}_{j} - {d}_{i} Δ {x}_{i} , i = 1 , … , N . \qquad ( Eq . 6 )$$

This is the linear approximation to Eq. 1. For larger deviations, Δx, from x^{ss}, the error in the linear approximation will increase. Nevertheless, as described in more detail in the Examples, the inventors have determined that the linear approximation is generally satisfactory for modeling a variety of biological networks. In particular, the linear approximation is preferred in part because it provides an acceptable approximation to Eq. 2 using a relatively small number of measurements.

To improve the accuracy of the approximation for larger deviations, Δx, i.e., for measurements made when the biological network is further from the steady state, the quadratic approximation to Eq. 2 may be used:

$${\dot{x}}_{i} = {\sum }_{j} {a}_{ij} Δ {x}_{j} + {\sum }_{j , k} {b}_{jk , i} Δ {x}_{j} Δ {x}_{k} - {d}_{i} Δ {x}_{i} , i = 1 , … , N \qquad ( Eq . 7 )$$

However, the improved accuracy comes at the cost of significantly increased sample complexity. The sample complexity of the quadratic approximation is of order N² while the sample complexity of the linear approximation is only of order N. Thus according to certain preferred embodiments of the invention the functions fᵢ(x) in the differential equations that comprise the model are approximated by a Taylor polynomial of order m=1, i.e., a linear approximation. According to certain other preferred embodiments of the invention the functions fᵢ(x) in the differential equations that comprise the model are approximated by a Taylor polynomial of order m=2, i.e., a quadratic approximation. According to yet other embodiments of the invention the functions fᵢ(x) in the differential equations that comprise the model are approximated by a Taylor polynomial having a higher order, e.g., an order m=3, m=4, m=5, or higher.

III. Estimating Parameters of the Network Model

A. Overview

In accordance with the inventive approach, the parameters of the network model (Eq. 5) are estimated from multiple measurements of the activities, x, of the biochemical species in the network, near a network steady state. In order to use typical biochemical data (e.g., mRNA expression levels) obtained from measurements on a physical biological system (e.g., a cell), the network is first normalized. For purposes of description, the normalization process is described for a quadratic model of the network (Eq. 7). However, the normalization method may be applied similarly to the linear model or to higher order models. Following a description of the normalization process, this section describes a variety of methods that may be applied to estimate parameters for any model in the normal form (Eq. 11 below), regardless of the order of the model from which the normal form was derived. For purposes of description the quadratic model is used to illustrate the methods, but they may be applied equally well to models of any order.

B. Perturbing the Network.

For a network near its steady-state point, x^{ss}, an external perturbation, pᵢ, is applied to one or more of the biochemical species in the network. For purposes of description, it will be assumed that the activity of the biochemical species represents the expression level of the biochemical species (as will generally be the case for biological networks in accordance with the present invention), in which case the perturbation is a perturbation in the net rate of accumulation of the biochemical species. It will be appreciated that perturbations in the net rate of accumulation may be achieved by perturbing the rate of synthesis, the rate of degradation, or both. Where the activity of the biochemical species represents a property other than expression level, the relevant perturbation is a perturbation in the net rate of alteration in the property. For example, where the activity is phosphorylation, the perturbation is a perturbation in the net rate of phosphorylation, which may be achieved by perturbing either the phosphorylation reaction, the dephosphorylation reaction, or both.

Application of a perturbation, pᵢ, to the rate of accumulation of one or more biochemical species in the network yields:

$${\dot{x}}_{i} = {\sum }_{j} {a}_{ij} Δ {x}_{j} + {\sum }_{j , k} {b}_{jk , i} Δ {x}_{j} Δ {x}_{k} - {d}_{i} Δ {x}_{i} + {p}_{i} , \\ i = 1 , … , N \qquad ( Eq . 8 )$$

In general, measurements will be obtained following l independent perturbations (each of which may perturb one or more biochemical species). Following the perturbation, the system is allowed to settle to steady state, and the activities of all species, x, in the network are measured. Since the measurements are all obtained in steady-state (\dot{x}=0), for each perturbation l, application of the perturbation yields the following from Eq. 8:

$$- \frac{{p}_{il}}{{d}_{i}} = {\sum }_{j} \frac{{a}_{ij}}{{d}_{i}} Δ {x}_{jl} + {\sum }_{j , k} \frac{{b}_{jk , i}}{{d}_{i}} Δ {x}_{jl} Δ {x}_{kl} - Δ {x}_{il} , \\ i = 1 , … , N \qquad ( Eq . 9 )$$

where pᵢₗ/dᵢ may be considered to be the steady-state concentration of the externally applied perturbation pil. Details of how to apply the perturbation to an actual biological network are provided below. For purposes of description, each application of a perturbation is referred to as a perturbation experiment or experiment.

C. Normal Form of the Network Model.

Generally it may not be practical to measure the absolute values of the activity of a particular biochemical species. Rather, according to certain embodiments of the invention activities are measured as ratios relative to some reference state, xⱼ^{o}. In other words, for any biochemical species xⱼ, xⱼ/xⱼ^{o} is measured rather than directly measuring xⱼ. In accordance with these embodiments of the invention it is assumed that the reference state is the unperturbed steady-state activities, x^{ss}. Thus a change of variables may be performed to write Eq. 9 in terms of the measured quantities vⱼₗ=Δxⱼₗ/xⱼ^{ss}=xⱼₗ/xⱼ^{ss}−1 and uᵢₗ=pᵢₗ/(xᵢ^{ss}dᵢ):

$$- {u}_{il} = {\sum }_{j} {r}_{ij} {v}_{jl} + {\sum }_{j , k} {s}_{jk , i} {v}_{jl} {v}_{kl} , i = 1 , … , N \\ where {r}_{ij} = \{ \begin{matrix}\frac{{a}_{ij}}{{d}_{i}} - 1 , & i = j \\ \frac{{x}_{j}^{ss} {a}_{ij}}{{x}_{i}^{ss} {d}_{i}} , & i \neq j\end{matrix} and {s}_{jk , i} = \frac{{x}_{j}^{ss} {x}_{k}^{ss} {b}_{jk , i}}{{x}_{i}^{ss} {d}_{i}} . \qquad ( Eq . 10 )$$

Eqs. 10 can be rewritten more compactly in the normal form:
−uᵢₗ=wᵢ^{T}qₗ,i=1, . . . ,N, (Eq. 11)

where wᵢ=(r_{ij, slk,i},s_{2k,i}, . . . , s_{Nk,i}), for j, k=1, . . . , N are the parameters of the model for each biochemical species i; and qₗ=(vⱼₗ, v₁ₗᵥₖₗ, v₂ₗᵥₖₗ, . . . ,v_{Nlvkl}), for j, k=1, . . . , N, is the transformed steady-state activity data. From Eqs. 11 it is apparent that the parameters, wᵢ, are independent of the data and perturbations. Thus, each equation for each species i in Eqs. 11 may be solved independently.

To estimate wᵢ, N²+N parameters for species i in the quadratic model, the steady-state activities of all N biochemical species are measured in each of M experiments, and the following system of equations is solved:
−uᵢ^{T}=wᵢ^{T}Q, (Eq. 12)

where Q, the data from Mperturbation experiments, is an (N²+N)×M matrix composed of columns qₗ, l=1, . . . ,M, and uᵢ=uᵢₗ, l=1, . . . , M is a vector of steady-state perturbations to species i in each experiment l. Since the coefficients b_{jk,i} are symmetric for each species i, there are only (N²+3N)/2 unique parameters in wᵢ. Note that estimated parameters may vary from the actual parameters because, for example, noise may exist in the data measurements, even if the above equations can be solved exactly. In addition, the estimated parameters may vary from the actual parameters if the solutions to the above equations must be estimated, i.e., if it is not possible or practical to solve the equations exactly.

If a unique perturbation is applied in each of the M experiments and M<(N²+3N)/2, the system is underdetermined, and multiple solutions will generally exist. (A unique perturbation is one that generates a vector qₗ that is linearly independent with respect to the columns of Q. Such perturbations might be obtained using unique combinations of perturbed genes, or in the case of quadratic or higher order models, perturbations of different strengths.) If M=(N²+3N)/2, a unique solution exists, but the estimated parameters, \tilde{w}ᵢ, will be extremely sensitive to noise both in the data, Q, and in the perturbations, uᵢ. In order to obtain a more reliable and unique solution, the number of experiments is increased such that M<(N²+3N)/2 (unconstrained case) or constraints are placed on the solutions to Eqs. 12 such that fewer experiments are needed (the unconstrained case). Suitable procedures for estimating the parameters in accordance with the invention in both the unconstrained cases is described in the following sections.

D. Estimation of Parameters Without Constraints. In this case it is assumed that the number of data points (where each vector of data qₗ is considered to be a single data point), M, is greater than or equal to the number of parameters, P, in wᵢ. (For exmple, in the quadratic case above, P=N²+N). wᵢ may be estimated in three steps: (1) select a fitness function that will be used to determine the estimate \tilde{w}ᵢ of wᵢ; (2) select a search procedure that identifies the \tilde{w}ₗ that optimizes the fitness function; (3) apply the search procedure to the system of equations (Eqs. 12).

In Step (1), a fitness criterion is selected, the application of which identifies an optimal estimate of the true parameters, wᵢ with respect to that particular fitness criterion. Since the true parameters are not known, the estimated parameters cannot be directly compared with the true parameters. Instead, in accordance with the invention, a comparison is made between the measured perturbations and the values obtained by using the model containing the estimated parameters to predict the perturbations that would be required to generate the measured activities. This step may be referred to as “applying the network model to the measured activity values using the estimated parameters”. In other words, \tilde{w}ᵢ and Q are used to predict the perturbations, ûᵢ, and the predicted perturbations, ûᵢ, are then compared to measurements of the actual perturbations, uᵢ, using some fitness function g(u, û, λ), where λ are additional fitting parameters. The predicted perturbations are given by the expression ûᵢ=Q\tilde{w}ᵢ. Thus the invention provides a method of constructing a model of a biological network as described above, wherein parameters of the model are estimated by (i) selecting a fitness function; and either computing the values of the parameters that optimize the fitness function; or (i) selecting a search procedure; and (ii) applying the selected search procedure so as to identify the values of the parameters that optimize (e.g., minimize or maximize) the selected fitness function. In general, the fitness function compares measured values of the perturbations applied in the perturbing step with predictions of the measured values of the perturbations. According to certain embodiments of the invention the predictions are obtained by using the measured activity values, selected values of the parameters, and the model to calculate values of the perturbations that would produce the measured activities, given the selected values of the parameters and the model.

According to certain embodiments of the invention the estimated parameters are considered random variables, and the probability density function for each estimated parameter is estimated. This may involve estimating one or more of the first, second, third or higher moments of the probability density function (K. S. Shanmugan & A. M. Breipohl, Random Signals: Detection Estimation and Data Analysis (John Wiley & Sons, New York, 1988). These moments may be estimated using the measured activity values and the measured perturbation values. According to certain embodiments of the invention the estimated first and second moments of the probability density functions of the estimated parameters are used to calculate the statistical significance of the one or more of the estimated parameters. The statistical significance of one or more of the estimated parameters may be calculated, for example, using one or more of the following tests: z-test, the t-test, and the chi-squared-test. One of ordinary skill in the art will be able to select and apply appropriate methods for estimating the probability density function and moments.

Any of a variety of fitness functions can be used, including, but not limited to, the total square error (TSE), maXimum square error (XSE), total absolute error (TAE), and leave-one-out error. (See van Someren, E. P., et al., Proceedings of the 2^{nd} International Conf. On Systems Biol., Nov. 4-7, 2001, Caltech (www.icsb2001.org)). The first three of these fitness functions will now be described. One of ordinary skill in the art will be able to select other appropriate fitness functions.

The TSE function finds parameters that minimize the Euclidean distance between uᵢ and ûᵢ. Euclidean distance is the length of a straight line connecting two points and corresponds to an intuitive notion of distance. To account for different levels of certainty in the measurements of the activities and the perturbations, the error calculated for each data point may be weighted. Thus the TSE fitness function may be written as follows:

$${g}^{tse} ( {\underline{u}}_{i} , {\hat{\underline{u}}}_{i} , {\underline{λ}}_{i} ) = {\sum }_{l} {{λ}_{il} ( - {u}_{il} - {\underline{w}}_{i}^{T} \cdot {\underline{q}}_{l} )}^{2} \qquad ( Eq . 13 )$$

Three choices for the error parameters, λᵢ, have particular significance:

(1) λᵢₗ=1. This corresponds to the case of no noise, or equal certainty in the measurements of all data points and perturbations.

(2) λᵢₗ=1/var(εᵢₗ) where var(εᵢₗ) is the variance of normally distributed uncorrelated measurement noise in the perturbation measurements uᵢₗ. Thus perturbation measurements with greater certainty are given greater weight in the fit.

(3) λᵢₗ=1/(var(εᵢₗ)+Σⱼwᵢⱼ² var(γⱼₗ)) where var(γⱼₗ) is the variance of normally distributed uncorrelated measurement noise in the data measurements qⱼₗ, and where j runs from 1 to whatever is the length of vector wᵢ. Thus data and perturbation measurements with greater certainty are given greater weight in the fit.

In the case of noise in both the data and the perturbation measurements, any of the choices for λᵢ will produce reasonable estimates of wᵢ, and any of these choices may be used in accordance with the invention. However, choice (3) is generally expected to provide the best estimate and is therefore preferred. Choice (3) is the maximum likelihood estimate (L. Ljung, referenced above; W.H. Press, S. A. Teukolsky, W. T. Vetterling, B. P. Flannery, Numerical Recipies in C: The Art of Scientific Computing, 2^{nd} Edition (Cambridge University Press, Cambridge) 1992).

The XSE fitness function finds parameters such that each predicted perturbation, ûᵢₗ, is close to each measured uᵢₗ, though it may not be the closest solution according to a Euclidean distance metric. The XSE fitness function is more sensitive to noise and outliers in the data set than is the TSE function. The XSE fitness function is given by
g^{xse}(uᵢ,ûᵢ, λₗ)=max λᵢₗ(−uᵢₗ−\tilde{w}ᵢ^{T}·q₁)²,l=1, . . . ,M (Eq. 14)

The TAE fitness function finds parameters such that P of the M predicted perturbations, ûᵢₗ, is equal to the corresponding measured perturbation uᵢₗ. The other M−P predicted perturbations will not be fit exactly. The TAE fitness function is given by:

$${g}^{tae} ( {\underline{u}}_{i} , {\hat{\underline{u}}}_{i} , {\underline{λ}}_{i} ) = {\sum }_{l} {λ}_{il} \vert - {u}_{il} - {\underline{w}}_{i}^{T} \cdot {\underline{q}}_{l} \vert \qquad ( Eq . 15 )$$

As for the TSE fitness function, the errors for the various parameter sets may be weighted according to λᵢₗ.

In Step (2) a search procedure (also referred to as a search strategy) to identify the parameters that optimize the chosen fitness function is selected. In general, it is desirable to utilize a procedure that is able to optimize the fitness function while maximizing computational efficiency, numerical stability, and numerical accuracy to the extent possible. In general, parameters that optimize the chosen fitness function will either minimize or maximize the function, depending on the particular fitness function selected. However, other criteria for defining the optimizing values of a fitness function may also be employed. Examples of search algorithms that may be employed in accordance with the invention include, but are not limited to, Simplex, gradient descent (e.g., Newton algorithms), and simulated annealing. See, e.g., W.H. Press, S. A. Teukolsky, W. T. Vetterling, B. P. Flannery, Numerical Recipies in C: The Art of Scientific Computing, 2^{nd} Edition (Cambridge University Press, Cambridge) 1992; G. Strang, Linear Algebra and Its Applications (Harcourt Brace Jovanovich College Publishers, Fort Worth, Tex.) 1988 for discussions of these search procedures. One of ordinary skill in the art will be able to select other appropriate search algorithms.

The above search methods (and others) may be used with discrete or continuous valued parameters. Use of continuous valued parameters will generally provide a more accurate solution. However, use of discrete parameters reduces the size of the parameter space from an infinite dimensional space to a finite dimensional space and can improve the efficiency of the search.

When discrete valued parameters are used, the number and range of allowable values must be selected. For example, a parameter may be allowed to take on only the values −1, 0, and 1, or the allowed values may be limited to integers between −10 and 10, −20 and 20, etc. It will be evident that there are numerous suitable choices for the number and range of allowable parameters. In general, the use of fewer values for each parameter will increase computational speed but decrease accuracy. The use of discrete valued parameters may allow use of exhaustive search strategies in which the fitness of every possible combination of parameter values is calculated and the best combination is selected.

With certain fitness functions a formula to calculate the parameters that minimize the function can be obtained. For example, using the TSE fitness function with choices (1) or (2) for λ, the derivative of the fitness function, g^{tse}, with respect to w can be set equal to 0 to obtain the pseudo-inverse solution (Press, et al. and Strang, both referenced above): \tilde{w}=(Q^{T}ΛQ)⁻¹Q^{T}Λ(−u), where Λ=diag(λ). In addition, it is possible to calculate the uncertainty in the estimate of the parameters. These calculations are described in detail below.

E. Estimating Parameters With Constraints. Estimation of model parameters, wᵢ, without constraints generally requires a large number of data points. For example, to reliably estimate all parameters in the quadratic model (Eq. 7) for a network of 100 species, the a number of experiments M>5150 is required. In biological experimentation it is often technically or economically infeasible to collect a large number of data points. In such cases the model is typically underdetermined, and multiple solutions may exist that are consistent with the data. To obtain a unique solution, constraints may be placed on the solution space. Examples of constraints include, but are not limited to, restrictions on the number of regulatory inputs to each biochemical species; minimizing the number of non-zero parameters; restricting parameters to discrete values; requiring parameters that result in stable solutions; and requiring non-oscillatory behavior. In order to satisfy one or more such constraints, the search strategy must generally be modified. The following sections describe the implementation of two different constraints: (1) fixing the number of regulatory inputs per biochemical species; and (2) minimizing the number of non-zero parameters in w.

1. Fixing the number of regulatory inputs per biochemical species. This constraint is derived from the assumption that each species i in a biological network comprising N biochemical species receives regulatory inputs from n other species, where n<N. In other words, the network is not fully connected. (The term “connection” refers to the existence of a regulatory relationship between species in a network. Thus if two species are connected, a change in the activity of one of the species results in a net change in the activity of the other species. The connection may be unilateral, in which case one species regulates the other species, or bilateral, in which the species mutually regulate each other.) Therefore, many of the parameters in the model will be zero. Such a network is referred to as a sparsely connected network. For example, in the quadratic model there are only K=n²+n non-zero parameters, thus requiring only M (n²+3n)/2 experiments to reliably estimate the model parameters. Based on previous studies showing that biochemical networks are often sparsely connected (D. Thieffry, A. M. Huerta, E. P'erez-Rueda, J. Collado-Vides, BioEssays 20, 433 (1998); H. Jeong, S. P. Mason, A.-L. Barab'asi, Z. N. Oltvai, Nature 411, 41 (2001).), in accordance with the invention it may often be assumed that n<<N. For example, it may typically be assumed that n 10 for regulatory networks comprising any number of genes.

To estimate the parameters of the constrained model, the inventive method still looks for solutions that minimize the fitness function selected in Step (1) above, but under the additional constraint that many of the parameters will be zero. Thus the search strategy in Step (2) is modified to estimate all K non-zero parameters that correspond to the n connections for each biochemical species in the network. Thus generally the fitness of 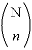
possible network structures must be evaluated and the fittest structure and parameters (i.e., the combination of structure and parameters that minimizes the fitness function) chosen as the desired solution.

According to certain embodiments of the invention an exhaustive search procedure is employed. Thus the invention provides a method of constructing a model of a biological network as described above, wherein parameters of the model are estimated by (i) selecting a fitness function; and either computing the values of the parameters that optimize the fitness function; or (i) selecting a search procedure; and (ii) applying the selected search procedure so as to identify the values of the parameters that optimize (e.g., minimize or maximize) the selected fitness function, wherein the search procedure comprises (a) generating all putative network structures including one or more regulatory inputs per biochemical species, but not more regulatory inputs than the maximum number of regulatory inputs; (b) calculating or searching for parameters that optimize a chosen fitness function for each putative network structure; and (c) selecting as a solution whichever of the putative networks of step (b), comprising a network structure and parameters, optimizes the fitness function.

Because there is an extremely large number of possible network structures for all but small values of n and N, it is often preferable to avoid performing an exhaustive search in which the parameters and fitness of every possible network structure are calculated. Therefore, in preferred embodiments of the invention a more computationally efficient search strategy is used. Generally, such a strategy includes the following steps though it will be appreciated that a number of variations are possible, and the invention encompasses such variations:

(a) Generate one or more putative network structures including one or more regulatory inputs per gene (but not more regulatory inputs than the maximum number of regulatory inputs).

(b) Calculate or search for the parameters that optimize a chosen fitness function for each putative network structure.

(c) Select one or more of the putative networks of step (b) (i.e., network structure/parameter combinations) with optimal fitness as determined by the fitness function.

(d) If the one or more of the putative networks selected in part (c) satisfies some chosen stop criterion, such as a particular level of fitness, then stop the search. One or more of the resulting network structures and parameters are the desired solutions.

(e) If the stop criterion is not met, then generate one or more variants of the network structures selected in step (c). Return to step (b).

The stop criterion may be, for example, a requirement that the putative network attains a predetermined level of fitness, that the putative network comprises a selected number of regulatory inputs, or that the change in the level of fitness between subsequent iterations of the steps (b) and (c) is less than a predetermined amount.

Thus this algorithm involves two types of searches, i.e., a search in which the best parameters are found for a given network structure (which may be referred to as an “inner search”), and a search in which the best combination of network structure and associated parameters is found (which may be referred to as an “outer search”). According to certain embodiments of the invention these searches are performed individually, in which case different search strategies may be selected for each search. According to other embodiments of the invention the inner and outer searches are fused into a single search.

Note that the unconstrained case is just a special case of the constrained algorithm. In the unconstrained case, in step (a) of the algorithm above, there is only one possible network structure to generate (i.e., a network in which each biochemical species has N regulatory inputs). In step (b), the parameters for that single network structure are calculated.

Many search strategies may be used for the inner, outer, and/or fused searches. For example, various search strategies mentioned for the unconstrained case (e.g., Simplex, gradient descent, simulated annealing) may be applied to search for the parameters that minimize the fitness function for each network structure (the inner search), e.g., in cases in which it is not possible or practical to solve directly for a solution that minimizes the fitness function. These and other search strategies may also be used to perform the outer search and/or fused searches.

Additional search strategies that may be used include, for example, strategies referred to as Forw-K, Forw-reest-K, Forw-TopD-reest-K, Forw-Float-K, Back-K, Back-reest-K, Genalg-SteadyState-K, Genalg-Gen-K, and Exhaustive-K. See van Someren, E. P., et al., Proceedings of the 2^{nd} International Conf. On Systems Biol., Nov. 4-7, 2001, Caltech (www.icsb2001.org), and references therein for detailed descriptions of these search strategies. According to certain embodiments of the invention the Forw-TopD-reest-n strategy is used. According to this method, parameters are estimated for all networks with a single connection (i.e., in which each biochemical species has a single regulatory input), and the best D networks are selected. Parameters are then estimated for all networks with two connections, one of which is selected from the connections in the D previously selected networks. This procedure is repeated, each time adding another connection to the D networks chosen previously. The iterations are stopped when n connections are found. The network and parameters with the optimum value of the fitness function are selected as the desired network model.

Generally, the number of regulatory inputs per gene in a typical biological network is not known. Moreover, the number of connections may vary from species to species. Thus according to certain embodiments of the invention the value of n is estimated. One way in which this may be accomplished is to estimate the network with the optimal fit for each of multiple values of n using an algorithm such as Forw-TopD-reest-n. The network and parameters with the optimal fit are selected from this set. However, this result may be misleading. The average fit obtained using models of a particular n will generally improve as n increases because the degrees of freedom in the models increase. Thus models with larger n will usually give better fits, even if they correspond to incorrect network structures. To overcome this problem, according to certain embodiments of the invention the χ² (“chi-squared”) statistical test (goodness of fit test) described below, which accounts for the degrees of freedom in the model and the uncertainly on the data, is used. Of the networks estimated with various connectivities n, the network and parameters with the best χ² score are selected as the desired network model. Another criterion to select a preferred connectivity is to test for stability of the resulting parameter matrix. If a choice of n gives an unstable matrix, then it may be rejected. It will be appreciated that the preferred connectivity may depend on the particular network that is being studied, and a variety of methods may be used to select a preferred connectivity.

2. Minimizing the number of non-zero parameters. This constraint is derived from the observation that n<<N in most biological networks (i.e., most biological networks are sparse). In an underdetermined problem (i.e., P>M), the minimum TSE (mTSE) solution is not unique. In such circumstances, this method chooses one such mTSE solution that minimizes the function |wᵢ|, where wᵢ=wᵢ^{r}+α. Vᵢ; wᵢ^{r} is the minimum length mTSE solution; Vᵢ is a matrix of vectors spanning the nullspace of the data matrix Q^{T} (i.e., Q^{T}Vᵢ=0); and α is a vector of optimization (auxiliary) parameters. The parameters, \tilde{α}, that minimize the function can be found by using the Simplex or other search algorithms. This constraint forces P−M of the parameters to be exactly zero. Thus, for this constraint, the following algorithm may be used:

(a) Identify wᵢ^{r}, the minimum length TSE solution, and Vᵢ, the basis for the nullspace, of the underdetermined normal equations, −uᵢ=wᵢ^{T}Q. This may be done, for example, using singular value decomposition (Press, et al. and Strang, both referenced above; M. K. S. Yeung, J. Tegner, J. J. Collins, PNAS 99, 6163 (2002)) or by other appropriate methods.

(b) Use a Simplex search to identify the parameters, \tilde{α}, that minimize the cost function |wᵢ^{r}+α·Vᵢ; wᵢ^{r}|. The desired solution to the normal equations is then given by \tilde{w}ᵢ=wᵢ^{r}+\tilde{α}·Vᵢ. Since the dimension of the nullspace is P−M (the degrees of freedom of the model, given the data), this search will yield a solution with P−M parameters equal to zero.

F. Representation of the Model.

For each biochemical species i, \tilde{w}ᵢ is a row of a matrix whose elements represent the strength of the regulatory inputs from all other species in the network that modulate the activity of that species i (i.e., each element of \tilde{w}ᵢ represents the magnitude of the effect on the activity of i of a change in the activity of the other species). For example, in the case of a linear Taylor approximation, where the biochemical species are genes and the activity being considered is a level of gene expression, \tilde{w}ᵢ is a vector, each of whose elements represents the strength of the regulatory input to gene i from a biochemical species j in the network. (i.e., the coefficient aᵢⱼ in the Taylor approximation). In the case of higher order approximations, each element in \tilde{w}ᵢ is a vector representing the magnitude of the effect on the activity of species i of a change in the activity of a species j, or the magnitude of the effect on the activity of species i of a combination of expression changes in species j, k, etc. (i.e., the coefficients aᵢⱼ, b_{jk,i}, etc., in the Taylor approximation).

In accordance with the description above, in which the matrix Q of measured activity levels or combinations of measured activity levels comprises column vectors qₗ, each of which contains measured activity levels or a combination of measured activity levels for each biochemical species following a perturbation, \tilde{w}ᵢ is a row vector. The vectors for all genes i=1, . . . , N may be combined into a matrix \tilde{W} in which each row in the matrix shows the influence of the various species in the network, (either independently in the case of a linear approximation or also in combination in the case of higher order approximations) on the activity of a particular species i. In other words, for a given row that represents species i, each element in the row represents a coefficient in the Taylor approximation, which represents the strength of a regulatory input to species i from species j (or from a combination of species in the case of a higher order approximation). The matrix \tilde{W} comprises the parameters of the network model. The examples provide further details and illustrations. According to certain embodiments of the invention species i is assumed to have no self-regulation, in which case the matrix \tilde{W} may contain diagonal elements equal to negative one.

It will be appreciated that the data and the model parameters may be represented in any of a variety of ways, including matrix and non-matrix representations. Details such as whether measured activity levels, parameters, etc., are represented as column vectors, row vectors, etc., are arbitrary, provided that consistency is maintained in accordance with the mathematical descriptions and computations presented herein. The following section presents details for calculating the parameters and variances using a particular fitness function.

G. Calculating Parameters and Variances Using the mTSE Fitness Function.

1. Calculating the parameters. This section describes how to calculate the best estimate of the parameters wᵢ in Eqs. 11, and the uncertainty on that estimate, using the mTSE fit criterion. For any particular choice of K non-zero parameters (where K<<P), Eqs. 11 may be formulated as the following linear regression model:
yᵢₗ=cᵢ^{T}zₗ+εᵢₗ, (Eq. 16)

where yᵢₗ=−uil is the perturbation applied to species i in experiment l; cᵢ is a K×1 vector representing one of the possible combinations of non-zero parameters of wᵢ; εᵢₗ is a scalar stochastic normal variable with zero mean and variance, var(εᵢₗ), representing measurement noise on the perturbation of species i in experiment l, zₗ is a K×1 vector of the elements of qₗ corresponding to the K non-zero parameters of wᵢ, with added uncorrelated Gaussian noise (γₗ). Equation 16 represents a multiple linear regression model with noise ηᵢₗ=cᵢ^{T}·γₗ+εᵢₗ, with zero mean and variance:

$$var ( {η}_{il} ) = {\sum }_{j = 1}^{K} {c}_{ij}^{2} var ( {γ}_{jl} ) + var ( {ɛ}_{il} ) \qquad ( Eq . 17 )$$

assuming εᵢₗ and γⱼₗ are uncorrelated for all i, j, L

If data are collected for M different experiments, Eq. 16 can be written for each experiment, yielding the following system of equations:
yₗ^{T}=cᵢ^{T}Z+εᵢ^{T} (Eq. 18)
where yᵢ=yᵢₗ, l=1, . . . , M; Z is a K×M matrix, where each column is the vector zₗ for one of the M experiments; εᵢ=εᵢₗ, l=1, . . . , M. From Eqs. 18, it follows that a predictor, ŷᵢ, for yᵢ given the data Z is:
ŷᵢ^{T}=cᵢ^{T}Z (Eq. 19)

To estimate the K parameters, cᵢ for species i, the TSE fitness function may be minimized, with λ=1:

$${g}^{tae} ( \underline{{y}_{i}} , {\hat{\underline{y}}}_{i} , 1 ) = {\sum }_{l = 1}^{M} {( {y}_{il} - {\hat{y}}_{il} )}^{2} = {\sum }_{l = 1}^{M} {( {y}_{il} - {\underline{c}}_{i}^{T} {z}_{l} )}^{2} \qquad ( Eq . 20 )$$

The minimizing parameters, \tilde{c}ᵢ, can be obtained by computing the pseudo-inverse of Z:
\tilde{c}ᵢ=(ZZ^{T})⁻¹Zyᵢ (Eq. 21)

Note that \tilde{c}ᵢ in Eq. 21 is not the maximum likelihood estimate for the parameters cᵢ when the regressors Z are stochastic variables, but it is nevertheless a good estimate. If the maximum likelihood estimate is desired, the TSE fitness function with λᵢₗ=1/(var(εᵢₗ)+Σⱼcᵢⱼ² var(γⱼₗ)) may be used. However, with such a choice, the minimum TSE solution is not given by Eq. 21 and must generally be solved numerically using one of the search methods described above.

2. Calculating the variances. This section describes estimation of the variance on the estimated parameters \hat{\tilde{c}}ᵢ and calculation of the goodness of fit. According to certain embodiments of the invention it is assumed that the noise is Gaussian distributed (i.e. the probability density function underlying the noise on the measurements is a Gaussian), so that the distribution may be fully characterized by its mean and variance. Given the Gaussian distribution function, the distribution function for a chi-squared or a t-distribution, and statistical measures (e.g., the P-values) can be calculated. If, in each experiment, the noise is uncorrelated and Gaussian with zero mean and known variance, then the covariance matrix of the estimated parameters \tilde{c}ᵢ is (Ljung, referenced above):
cov(\tilde{c}ᵢ)=(ZZ^{T})⁻¹ZΣ_{η}Z^{T}(ZZ^{T})⁻¹, (Eq. 22)

where Σ_{η}=diag(var(ηᵢₗ), . . . , var(η_{iM})) is an M×M diagonal matrix. In accordance with certain embodiments of the invention it is assumed that var(ηᵢₗ) can be estimated in each experiment, l, by substituting the estimated parameters, \tilde{c}ᵢ, into Eq. 17:

$$var ( {η}_{i l} ) = {\sum }_{j = 1}^{K} {\tilde{c}}_{ij}^{2} var ( {γ}_{jl} ) + var ( {ɛ}_{il} ) \qquad ( Eq . 23 )$$

The variances of the parameters can now be computed using Eq. 22, where Σ_{η} is computed using Eq. 23. A goodness of fit test can also be computed using the χ² statistic (Press, et al., referenced above; E. Kreyszig, Advanced Engineering Mathematics, 7^{th} Edition (Johh Wiley & Sons, New York) 1993):

$${χ}^{2} = {\sum }_{l = 1}^{M} \text{[} {y}_{il} - {c}_{i}^{T} {z}_{l} {\text{)}}^{2} \text{/} var \text{(} {η}_{il} \text{)} \text{]} \qquad ( Eq . 24 )$$

The χ² statistic may also be used to test the goodness of fit for parameters estimated with other choices of λᵢ. A lack of significance of the fit for a given species typically implies that its main regulators lie outside the set of species included in the model. There is, in general, no rigorous definition of significance for the χ² statistic. According to certain embodiments of the invention fits giving χ² 0.001 are considered significant. According to certain other embodiments of the invention fits giving χ² 0.01 are used as the significance threshold. According to yet other embodiments of the invention, fits giving χ² 0.0005, fits giving χ² 0.05, or fits giving χ² 0.01 are used as the significance threshold. Other values of χ2 may also be selected.

H. Estimation of Parameters for Unperturbed Species.

In some cases, some of the species in the biological network will not be perturbed in any of the experiments. For example, fewer experiments may be performed than there are genes in the network. Alternatively, it may not be possible experimentally to perturb a particular species. Assuming that species i has not been perturbed (i.e., uᵢ=0), Eqs. 12 become:
wᵢ^{T}Q=−uᵢ^{T}=0 (Eq. 25)

The trivial solution to Eq. 25, wᵢ^{T}=0, suggests that species i is not regulated, which is not generally true. However, a non-trivial estimate of the parameters for the unperturbed species can still be found by making a minor adjustment to the solution procedure. Eq. 25 is renormalized by dividing all the coefficients wᵢ^{T} by −wᵢᵢ, the self-regulation coefficient of species i. The new parameters, ρᵢ^{t}, will have itsjth element equal to wᵢⱼ/−wᵢᵢ, and hence its ith element equal to −1. Using the renormalized parameters, Eq. 25 may be rewritten as follows:

$${\sum }_{j = 1 , j \neq i}^{P} {ρ}_{ij} {q}_{jl} = {q}_{il} , 1 = 1 , … , M , \qquad ( Eq . 26 )$$

where ρᵢⱼu=wᵢⱼ and ρᵢⱼ=−1. Eqs. 26 are in the normal form and may be solved using the methods described above. Thus all parameters are estimated only relative to the self-regulation parameter. In addition, species i will be treated as having no self-regulation in the final estimated model, \tilde{W}. Therefore, if there is self-regulation in the actual biological network, the predictor ŷᵢ for species i will typically have some error. Nevertheless, this error may be small if the self-regulation strength in the actual physical network is small.

I. Constructing a Model of a Biological Network.

As described in more detail in the Examples, the inventors have applied the methods described above to construct a model of the SOS regulatory network in E. coli, which regulates cell survival and repair following DNA damage. The extensive amount of experimental information and knowledge previously obtained regarding regulatory relationships between species (in this case, genes) in the network made this an appropriate setting in which to evaluate the methods. The SOS pathway is known to involve the lexA and recA genes in addition to numerous genes directly regulated by lexA and recA and perhaps hundreds of indirectly regulated genes (23-27). The network was defined to comprise nine biochemical species (genes), including the principal mediators of the SOS response (lexA and recA), four other core SOS response genes (ssb, recF, dinI, umuDC) and three genes potentially implicated in the SOS response (rpoD, rpoH, rpoS). The activity measured was the expression level of the genes, as reflected by the level of the mRNA transcript for which each gene serves as a template. The implementation employed a linear Taylor polynomial to approximate a set of nonlinear ordinary differential equations, and also an mTSE fitness function. The parameters were calculated using the multiple linear regression model described above. An exhaustive search procedure, performed with the constraints n=3, 4, 5, or 6, was used to identify the network structure and parameters that optimized (in this case, minimized) the fitness function. The data was obtained by applying a set of nine transcriptional perturbations to cells. Perturbations were applied by overexpressing a different one of the genes in individual cultures of cells using an episomal expression plasmid and measuring the change in expression level of all nine species.

To evaluate the model, the number of previously known connections in the network that were correctly identified in the model was determined, where a predicted connection was deemed correct if there exists a known protein or metabolite pathway between the two genes and the sign of the regulatory interaction was correct. As described in more detail in Example 1, the model correctly identified significant regulatory connections in the network, including key connections. For example, the model correctly shows that recA positively regulates lexA and its own transcription, while lexA negatively regulates recA and its own transcription. These results demonstrate the ability of the inventive methods to construct models of biological networks that correctly reflect actual regulatory interactions in physical biological networks. The following sections provide details relevant to implementation of the inventive methods in the context of a wide variety of biological systems.

IV. Biological Implementation.

A. Determining Activities of Biochemical Species

Any of a variety of techniques may be used to determine the activity of a biochemical species. In general, appropriate measurement techniques will depend upon the type of activity being measured. For example, if the biochemical species is a gene, typically the activity to be determined is the level of expression of the gene. The level of expression may be determined, for example, by measuring the amount of mRNA transcribed using that gene as a template, or by measuring the amount of protein encoded by that gene. Other properties that may be considered to be gene activities include the state of methylation. If the biochemical species is an RNA molecule, the activity to be determined is typically the amount or expression level of the RNA. Other properties or features that may be considered activities include the extent of splicing, polyadenylation, or other processing events. Certain RNAs (e.g., ribozymes) possess the ability to catalyze cleavage of either themselves or other nucleic molecules. In the case of such RNAs, the activity may be the catalytic ability of the RNA towards a suitable substrate.

If the biochemical species is a protein, the activity to be determined may be the amount or expression level of the protein. Proteins possess a vast array of different catalytic activities, any of which may be determined in accordance with the present invention. For example, the ability of a protein to catalyze phosphorylation, dephosphorylation, cleavage, or any other modification of a substrate are considered activities. Protein properties such as phosphorylation or glycosylation state, cleavage state, etc., may also be considered activities. In addition, cellular constituents may associate with other cellular constituents and/or be present in complexes with other constituents. The association state of any cellular constituent may be considered an activity in accordance with the invention. In general, RNA or protein catalytic activities and catalytic rates (either of which may be considered an activity) may be measured by any of a wide variety of techniques known in the art (e.g., kinase assays, phosphatase assays, etc). One of ordinary skill in the art will readily be able to select a suitable method, depending upon the particular activity being determined. The following sections present some representative examples of methods for determining activities of RNA and protein, where the activity is the level of expression of a gene, RNA, or protein.

1. Measuring RNA levels. Any of a number of methods known in the art can be used to measure RNA levels. These methods include, but are not limited to, oligonucleotide or cDNA microarray technologies (Schena et al., 1995, “Quantitative monitoring of gene expression patterns with a complementary DNA microarray”, Science, 270:467-470; Shalon et al., 1996, “A DNA microarray system for analyzing complex DNA samples using two-color fluorescent probe hybridization”, Genome Research, 639-645; Lipshutz, R., et al., Nat Genet., 21(1 Suppl):20-4, 1999; Heller, M J, Annu Rev Biomed Eng., 4:129-53, 2002, and references therein); polymerase chain reaction (PCR), with optical, fluorescence-based, or gel-based detection (See, e.g., Bustin S, J Mol Endocrinol., 29(1):23-39, 2002; Giulietti, A., et al., Methods. (4):386-401, 2001 for reviews.) PCR approaches include real-time PCR and competitive PCR, which may be coupled with MALDI-TOF mass spectrometry (32). In general, rapid and accurate methods such as these are preferred, but other approaches such as hybridization-based approaches (e.g., Northern blot) may also be used.

2. Measuring protein levels. A variety of methods may be used to measure protein levels including, but not limited to, immunologically based methods such as standard ELISA, immuno-polymerase chain reaction (immuno-PCR) (Sano, T., et al., Science 258, 120-122, 1992), immunodetection amplified by T7 RNA polymerase (IDAT) (Zhang, H.-T., et al., J. Proc. Natl. Acad. Sci. USA 98, 5497-5502, 2001), radioimmunoassay, immunoblotting, etc. Other approaches include two-dimensional gel electrophoresis, mass spectrometry, and proximity ligation (Fredriksson, S. et al., Nat. Biotechnol. 20, 473-477, 2002).

B. Perturbing Species in a Biological Network.

1. General considerations. A described above, the inventive methods for constructing models of biological networks involve perturbing the activity of the biochemical species in the network being modeled. In general, any manipulation or alteration of the activity of a biochemical species may be considered a perturbation. Where the biochemical species is a gene, perturbation of the activity of one or more of the products of the gene (mRNA or protein) may be considered a perturbation of the activity of the gene. Manipulations involving overexpression, inhibition of synthesis (transcription or translation), enhancement or inhibition of degradation, activation or inhibition of species that modify, activate, or inhibit the biochemical species, mutations, deletions, etc., may all be considered perturbations in accordance with the invention.

According to preferred embodiments of the invention the biological network is in a steady state prior to the perturbation. This may be achieved, for example, by maintaining cells under constant environmental and physiological conditions for a sufficient time interval prior to the perturbation. For example, the cells may be maintained under constant environmental and physiological conditions for between 1 and 24 hours prior to the perturbation. According to certain embodiments of the invention the cells are maintained under constant environmental and physiological conditions for at least 1 hour, at least 2 hours, at least 5 hours, or at least 10 hours prior to the perturbation. By “constant environmental and physiological conditions” is meant, for example, that the environmental conditions (e.g., temperature, nutrient concentrations, osmotic pressure, pH, etc.) change by less than 25%, preferably less than 10%, during the time interval. Other conditions, e.g., cell density, may also be maintained at a constant value or within a range of values, so that cells remain either in an exponential or linear state of cell division, or in a nondividing state. In addition, cells should generally not be allowed to differentiate or switch into different cell types, for example sporulate, or differentiate into a muscle cell or fibroblast from a precursor, of from some other cell type. In addition, constant environmental and physiological conditions generally implies the absence of any exogenous stimulus known or likely to perturb elements in the biological network and preferably also implies the absence of any exogenous stimulus known or likely to perturb other constituents of the biological system comprising the biological network. The use of the terms “environmental” and “physiological” is not intended to imply that any particular condition falls into either category or to otherwise distinguish between them. In general, maintaining cells under standard culture conditions for an appropriate time interval will be sufficient to ensure that the biological network is in steady state.

In general, for purposes of the present invention, a steady state will be deemed to exist where the activity of a substantial proportion of the species in the biological network (e.g., 50%, 75%, 85%, 90%, 95%, 99%, 100%, of the species, or any value within these ranges) remains substantially constant over a specified time interval. According to various embodiments of the invention, by “substantially constant” is meant that the activity varies by less than 25%, less than 20%, less than 15%, less than 10%, less than 5%, less than 1%, less than 0.5%, of its baseline value (i.e., the value at the beginning of the time interval) over the time interval. For example, if the baseline value is denoted by X, then according to certain embodiments of the invention, the activity ranges between X±0.25X, X±0.2X, X±0.15X, X±0.1X, X ±0.05X, X±0.01X of its baseline value. Alternately, rather than determining variation from the baseline value, a different value such as the mean value over the time interval may be used.

In the case of certain biochemical species, the activity normally fluctuates even when cells are maintained under constant environmental conditions. For example, various proteins involved in cell cycle control increase and decrease in abundance as the cell progresses through the cell cycle. For such species, a different notion of steady state, characterized by oscillations within a range of values, may be appropriate. However, unless the population of cells is synchronized, it is likely that even though the activity fluctuates within an individual cell, the average value in a population of cells (which is what is typically determined when measuring activities) is likely to be substantially constant at steady state. One of ordinary skill in the art will be able to select any of a variety of metrics to determine whether the biological network remains in a steady state over a time interval. It is to be understood that there is no specific requirement, rather the closer the biological network is to steady state prior to the perturbation, the more accurately the model will reflect the actual behavior of the network.

According to certain preferred embodiments of the invention the magnitude of the perturbation is sufficiently small so that the biological network remains in a domain near steady state. In general, a perturbation is considered small if it does not drive the network out of the basin of attraction of its steady-state point (i.e., if, when the perturbation is removed, the network returns to the original steady state in which it existed prior to the perturbation), and if the stable manifold in the neighborhood of the steady state point is approximately linear. Under these assumptions the set of equations used to model the network may be linearized as described above. According to certain embodiments of the invention a perturbation changes the baseline value of the activity by less than a factor of 10, less than a factor of 5, less than a factor of 2, less than a factor of 1, less than a factor of 0.5, less than a factor of 0.25, less than a factor of 0.1, or still less. In other words, according to certain embodiments of the invention, if the baseline activity is represented by X, the activity remains within the following ranges following the perturbation, X±10X, X±5X, X±2X, X±X, X±0.5X, X±0.25X, X ±0.1X, or some smaller range. Alternately, the activity may remain within the following ranges: (X/10) to 10X; (X/S) to 5X; (X/2) to 2X; (X/1.5) to 1.5X, (X/1.2) to 1.2X, (X/1.1) to 1.1X, or some smaller range. It is to be understood that there is no specific requirement as to the size of the perturbation, rather there is a tradeoff between the improved accuracy of the Taylor polynomial approximation when the perturbation is small, and the decreased signal to noise ratio.

In general, it is preferred to perturb a substantial proportion of the biochemical species in the network. For example, according to certain embodiments of the invention at least 50%, at least 60%, at least 70%, at least 80%, at least 95%, at least 99%, or all of the species in the network are perturbed, and the response of the network (e.g., the change in activity of some, or preferably all, of the biochemical species in the network) is determined. It is noted that in certain instances the response will be no alteration in the activity of any of the species. For example, it may be the case that none of the species is regulated either directly or indirectly by the species that are perturbed. Alternatively, the response may be below the limits of detection.

According to certain preferred embodiments of the invention the biochemical species are perturbed independently, i.e., only a single species is perturbed prior to determining the activities. This may be accomplished, for example, by preparing a plurality of substantially identical populations of cells (e.g., cultures in individual vessels), each of which may be used to perturb a different biochemical species. For example, each population of cells may contain an expression system (e.g., a plasmid) that can be used to induce expression of a different gene (preferably using the same inducer). The cultures are maintained under substantially identical environmental and physiological conditions, and the perturbation is accomplished by inducing expression of the genes. Alternately, multiple species may be perturbed in the same population of cells, e.g., by introducing two different expression systems into the cells. In general, the higher the proportion of species that are perturbed, the more closely the resulting model will approximate the actual network.

Thus the invention provides methods for constructing a biological network as described above, in which the perturbing step comprises applying a perturbation to a different biochemical species in the biological network in each of at least one of the biological systems, each biological system comprising a cell or a population of cells, and wherein the determining step comprises determining the response of at least one of the biochemical species in the biological network in each of at least one of the biological systems after allowing the biological network to reach a steady state. According to certain embodiments of the invention the perturbing step comprises applying a perturbation to one or more biochemical species in the biological network in each of at least one of the biological systems, each biological system comprising a cell or a population of cells, and wherein the determining step comprises determining the response of at least one of the biochemical species in the biological network in each of at least one of the biological systems after allowing the biological network to reach a steady state. A single biochemical species in the biological network in each biological system may be perturbed, or multiple biochemical species in each biological system may be perturbed simultaneously. According to certain embodiments of the invention each of the biochemical species in the biological network is perturbed in at least one of the biological systems. According to certain embodiments of the invention less than 100% of the biochemical species in the biological network are perturbed.

The perturbing step may comprise (i) applying a perturbation to one or more biochemical species in the biological network in a biological system comprising a cell or a population of cells, and wherein the determining step comprises determining the response of at least one of the biochemical species in the biological network after allowing the biological network to reach a steady state; and (ii) repeating the applying and determining steps for each of at least one of the biochemical species in the biological network.

Any of a variety of methods may be used to apply perturbations to biochemical species in a biological network. In general, the choice of an appropriate method will depend on a number of factors including, for example, the particular biochemical species being perturbed, the nature of the activity being perturbed (e.g., level of expression), the nature of the biological system (e.g., bacterial or eukaryotic cell), and the tools available to manipulate activities in the biological system under study.

According to certain embodiments of the invention the activity to be perturbed is an expression level of a gene, RNA, or protein. As mentioned above, the expression level of a gene generally refers to the abundance of either mRNA transcribed using that gene as a template or the abundance of protein encoded by that gene. Such activities can be perturbed by a number of approaches including, but not limited to, altering (increasing or decreasing) the rate of synthesis of the species or the rate of degradation of the species. In the case of proteins, perturbation of the rate of synthesis may be accomplished by altering the rate of transcription of the mRNA encoding the protein and/or altering the rate of translation of the mRNA. It will be appreciated that many of the reagents described below may act via multiple different mechanisms to perturb the activity of genes, RNAs, and/or proteins. The classification below is not intended to convey any limitation on the ways in which the reagents may be used.

2. Systems for Perturbing Rate of RNA and/or Protein Synthesis.

(a) Inducible and repressible expression systems. According to certain embodiments of the invention the rate of RNA synthesis is perturbed by use of an inducible and/or repressible expression system. Such systems are also referred to as conditional expression systems. For example, the rate of RNA synthesis may be increased by introducing a vector that comprises a nucleic acid molecule comprising a template for synthesis of the RNA (e.g., a cDNA), operably linked to a genetic control element (e.g., a promoter) that directs transcription of the RNA, into the cell. (The term vector is used herein in the biological context to refer to a nucleic acid molecule capable of mediating entry of, e.g., transferring, transporting, etc., another nucleic acid molecule into a cell. The transferred nucleic acid is generally linked to, e.g., inserted into, the vector nucleic acid molecule. A vector may include sequences that direct autonomous replication, or may include sequences sufficient to allow integration into host cell DNA. Useful vectors include, for example, plasmids, cosmids, and viral vectors. Viral vectors include, e.g., replication defective retroviruses, adenoviruses, adeno-associated viruses, and lentiviruses. As will be evident to one of ordinary skill in the art, viral vectors may include various viral components in addition to nucleic acid(s) that mediate entry of the transferred nucleic acid.)

In certain preferred embodiments of the invention the genetic control element is inducible, i.e., its ability to direct transcription of operably linked nucleic acid sequences may be increased (either directly or indirectly) by exogenous application of an appropriate compound or by a change in an environmental condition (e.g., temperature). Alternately, the genetic control element may be repressible, so that addition of an exogenous compound or environmental change results in decreased transcription of the linked nucleic acid. Preferred systems utilize compounds that do not themselves interact with endogenous cellular constituents. In particular, preferred systems utilize compounds whose application does not perturb the activity of any of the biochemical species in the network in the absence of the introduced vector.

In the case of many inducible/repressible expression systems the level of expression may be controlled as desired by varying the amount of exogenous compound added or by varying the environmental change imposed. Thus it is possible to ensure that the magnitude of the perturbation remains small enough so that the biological network remains in a domain near steady state. Although any of the perturbation methods may be used, it is expected that the great majority of genes, RNAs, and proteins can be adequately perturbed by overexpression, e.g., using an inducible expression system such as that described in the Examples (or a similar system appropriate for use in eukaryotic cells, will be sufficient).

A variety of inducible/repressible systems are known in the art. As described in Example 1, the inventors have utilized the arabinose-regulated P_{bad} promoter (L-M. Guzman, et al., J. Bacteriology, 177: 4121-4130, 1995), coupled to a variety of different genes to perturb the activity of those genes in bacterial cells. Other inducible/repressible single or multi-plasmid bacterial expression systems are based on the lac promoter, hybrid lac promoter, or the tetracycline response element, and variants thereof. Examples of such expression systems include the PLtetO-1 (tetracycline-inducible) system & PLlacO-1 (IPTG-inducible) system (R. Lutz & H. Bujard, Nucleic Acids Research, 25: 1203-1210, 1997). See also U.S. Pat. Nos. 4,952,496 and 6,436,694.

Numerous inducible/repressible eukaryotic expression systems are known in the art. Such systems may be based, for example, on genetic elements that are responsive to glucocorticoids and other hormones, responsive to metals such as copper, zinc, or cadmium (e.g., CUP1 promoter, metallothionine promoter), or responsive to endogenous or exogenous peptides such as interferon (e.g., MX-1 promoter), etc. In the case of the hormone-inducible systems, the genetic control element is a promoter and/or enhancer element whose ability to drive transcription of a linked nucleic acid is increased (or decreased) by binding of a receptor for the appropriate hormone (e.g., a glucocorticoid receptor, estrogen receptor, etc.) The receptor may be endogenous or a vector comprising a nucleic acid sequence encoding the receptor may be introduced into the cell to provide a source of the receptor. The latter approach may be referred to as a binary system. In general, in accordance with such approaches to achieving conditional expression gene expression is controlled by the interaction of two components: a “target” nucleic acid (comprising a regulatory element operably linked to a template for RNA synthesis such as a cDNA) and an “effector” nucleic acid, which encodes a product that acts on the target. See, e.g., Lewandoski, M., Nature Reviews Genetics 2, 743-755 (2001) and articles referenced therein, all of which are incorporated herein by reference, reviewing methods for achieving conditional expression in mice, which are generally applicable to eukaryotic, particularly mammalian, cells.

The term regulatory sequence or regulatory element is used herein to describe a region of nucleic acid sequence that directs, enhances, or inhibits the expression (particularly transcription, but in some cases other events such as splicing or other processing) of sequence(s) with which it is operatively linked. The term includes promoters, enhancers and other transcriptional control elements. In some embodiments of the invention, regulatory sequences may direct constitutive expression of a nucleotide sequence; in other embodiments, regulatory sequences may direct tissue-specific and/or inducible expression. For instance, non-limiting examples of tissue-specific promoters appropriate for use in mammalian cells include lymphoid-specific promoters (see, for example, Calame et al., Adv. Immunol. 43:235, 1988) such as promoters of T cell receptors (see, e.g., Winoto et al., EMBO J. 8:729, 1989) and immunoglobulins (see, for example, Banerji et al., Cell 33:729, 1983; Queen et al., Cell 33:741, 1983), and neuron-specific promoters (e.g., the neurofilament promoter; Byrne et al., Proc. Natl. Acad. Sci. USA 86:5473, 1989). Developmentally-regulated promoters are also encompassed, including, for example, the murine hox promoters Kessel et al., Science 249:374, 1990) and the α-fetoprotein promoter (Campes et al., Genes Dev. 3:537, 1989). In some embodiments of the invention regulatory sequences may direct expression of a nucleotide sequence only in cells that have been infected with an infectious agent. For example, the regulatory sequence may comprise a promoter and/or enhancer such as a virus-specific promoter or enhancer that is recognized by a viral protein, e.g., a viral polymerase, transcription factor, etc.

In general, binary expression systems fall into two categories. In the first type of system, the effector transactivates transcription of the target trans nucleic acid. For example, in the tetracycline-dependent regulatory systems (Gossen, M. & Bujard, H, Proc. Natl. Acad. Sci. USA 89, 5547-5551 (1992), the effector is a fusion of sequences that encode the VP16 transactivation domain and the Escherichia coli tetracycline repressor (TetR) protein, which specifically binds both tetracycline and the 19-bp operator sequences (tetO) of the tet operon in the target nucleic acid, resulting in its transcription. In the original system, the tetracycline-controlled transactivator (tTA) cannot bind DNA when the inducer is present, while in a modified version, the ‘reverse tTA’ (rtTA) binds DNA only when the inducer is present (‘tet-on’) (Gossen, M. et al., Science 268, 1766-1769 (1995)). The current inducer of choice is doxycycline (Dox). See also Hoffmann et al., Nucl. Acids Res. 25:1078-1079, 1997; Gossen et al., Science 268:1766-1769, 1995. Gari et al., Yeast 13:837-848, 1997. Another binary inducible system utilizes the receptor for the insect steroid hormone ecdysone, which may be activated by application of ecdysone. See, e.g., D. No, T. P. Yao and R. M. Evans, Proc. Natl. Acad. Sci. USA, 93:3346, 1996.

In the second type of system, the effector is a site-specific DNA recombinase that rearranges the target nucleic acid, thereby activating or silencing it. In general, this is achieved by placing an expression cassette comprising a genetic control element (e.g., a promoter) operably linked to a template for synthesis of the RNA (e.g., a cDNA), between two recognition sites for a recombinase such as Cre, XerD, HP1 and Flp. These enzymes and their recombination sites are well known in the art. See, for example, Sauer, B. & Henderson, N., Nucleic Acids Res. 17, 147-161 (1989), Gorman, C. and Bullock, C., Curr. Op. Biotechnol., 11(5): 455-460, 2000, O'Gorman, S., Fox, D. T. & Wahl, G. M., Science 251, 1351-1355 (1991) and Kolb, A., Cloning Stem Cells, 4(1):65-80, 2002, and U.S. Pat. No. 4,959,317. See also Kuhn, R., and Torres, RM, Methods Mol Biol 2002; 180:175-204.

These recombinases catalyse a conservative DNA recombination event between two 34-bp recognition sites (e.g., loxP and FRT). Placing a heterologous nucleic acid sequence operably linked to a promoter element between two loxp sites (in which case the sequence is “floxed”) allows for controlled expression of the heterologous sequence following transfer into a cell. By inducing expression of Cre within the cell (which may be achieved using any of the inducible expression systems described above, the heterologous nucleic acid sequence is excised, thus preventing further transcription and effectively eliminating expression of the sequence.

An inducible system for eukaryotic cells in which light serves as the inducer may also be employed (Shimizu-Sato, S. et al. Nat. Biotechnol. 20, 1041-1044, 2002). The system exploits the property of phytochromes that they can be interconverted within milliseconds from an inactive form, designated Pr, to an active form, Pfr, by exposure to red light and then back again by exposure to far-red light. In this system the chromophore-containing amino-terminal phytochrome B domain is fused to a DNA-binding domain, such as the GAL4 DNA-binding (GDB) domain, and a target protein such as the basic helix-loop-helix protein PIF3, which interacts with the active Pfr conformer, is linked to a transcriptional activating domain such as the GAL4-activating domain (GAD). GAD. When the N-terminal phytochrome B domain absorbs a red photon, it is converted from the inactive Pr to active Pfr form. When coexpressed in a cell in the presence of exogenous phycocynanobilin chromophore, the Pfr form of N-terminal phytochrome B binds PIF3-GAD to drive expression from the promoter containing the embedded GDB operably linked to a nucleic acid that serves as a template for an RNA of interest. When the N-terminal phytochrome B absorbs a far-red photon, it is converted to the inactive Pr form. The PIF3-GAD dissociates from the phytochrome B-GDB fusion, turning off expression of the RNA.

A variety of inducible/repressible systems based on small molecules such as rapamycin may also be used. See, for example, Pollock, R., and Rivera, V. M., “Regulation of gene expression with synthetic dimerizers”, Methods Enzymol 306:263-81, 1999. Go, W. Y., and Ho, S. N., “Optimization and direct comparison of the dimerizer and reverse tet transcriptional control systems”, J Gene Med 4:258-70, 2002, and V. M. Rivera, et al., Nat. Med., 2:1028, 1996.

(b) Inhibitors of transcription. Inhibitors of transcription may also be used to perturb the activity of genes, RNAs, or proteins. A variety of biochemical compounds can inhibit the transcription of specific genes by binding to the dsDNA of the promoter upstream of the gene, or to the switching sequences positioned upstream, downstream or within the promoter, in a sequence-specific manner. Compounds that exhibit this dsDNA binding activity include: (1) polynucleic acids that form a triple helix with dsDNA; (2) small-molecule compounds that bind specific dsDNA sequences; and (3) dsDNA binding proteins.

Polynucleic acids. Nucleic acids, including DNA and RNA oligonucleotides, and chemically modified variants of RNA and DNA oligonucleotides, are capable of binding to the major groove of the double-stranded DNA helix. Triplex-forming nucleic acids bind specifically and stably, under physiological conditions, to homopurine stretches of dsDNA. Chemical modifications of triplex-forming nucleic acids, such as the coupling of intercalating compounds to the nucleic acid or the substitution of a natural base with a synthetic base analogue, can increase the stability of the triplex DNA. The formation of triplex DNA by triplex-forming nucleic acids can inhibit the initiation or elongation of transcription by RNA polymerase proteins. Previous work describes the design of triplex-forming nucleic acids and their use in the regulation of gene expression [Gowers & Fox, Nucleic Acids Res., 27:1569, 1999; Praseuth, et al., Biochim Biophys Acta, 1489:181, 1999; Kochetkova & Shannon, Methods Mol. Biol., 130:189, 2000; Sun, et al., Curr. Opin. Struct. Biol., 6:327, 1996].

Small molecules. Small-molecule compounds that bind specific dsDNA sequences. A variety of natural and synthetic chemical compounds have been demonstrated to bind to specific dsDNA sequences. The compounds, which act by a variety of mechanisms include netropsin and distamycin [Coll, et al., Proc. Natl. Acad. Sci. USA, 84:8385, 1987], Hoechst 33258 [Pjura, et al., J. Mol. Biol., 197:257, 1987], pentamidine [Edwards, et al., Biochem., 31:7104, 1992], and peptide nucleic acid [Nielsen, in Advances in DNA Sequence-Specific Agents, (London, JAI Press), pp. 267-78, 1998]. Rational modification [Baily, in Advances in DNA Sequence-Specific Agents, (London, JAI Press), pp. 97-156, 1998; Haq and Ladbury, J. Mol. Recog., 13:188, 2000] and combinatorial chemistry [Myers, Curr. Opin. Biotech., 8:701, 1997] can be used to modify the sequence specificity and binding characteristics of these compounds. The binding of such compounds to dsDNA can inhibit the initiation or elongation of transcription by RNA polymerase proteins.

dsDNA binding proteins. A large number of proteins exist naturally that are capable of binding to specific dsDNA sequences. These proteins typically utilize one of several dsDNA binding motifs including the helix-turn-helix motif, the zinc finger motif, the C2 motif, the leucine zipper motif, or the helix-loop-helix motif. The binding of such proteins to dsDNA can inhibit the initiation or elongation of transcription by RNA polymerase proteins. Improved understanding of the principles of DNA sequence recognition by these proteins has permitted rational modification of their sequence-specificity. Previous work describes the design of dsDNA binding proteins and the use of dsDNA binding proteins in the regulation of gene expression [Vinson, et al., Genes Dev., 7:1047, 1993; Cuenoud and Schepartz, Proc. Natl. Acad. Sci. USA, 90:1154, 1993; Park, et al., Proc Natl Acad Sci USA, 89:9094, 1992; O'Neil, Science, 249:774, 1990; Wang, et al., Proc. Natl. Acad. Sci. USA, 96:9568, 1999; Berg, Nature Biotech., 15:323, 1997; Greisman, Science, 275:657, 1997; Beerli, Proc. Natl. Acad. Sci. USA, 97:1495, 2000; Kang, J. Biol. Chem., 275:8742, 2000].

(c) Inhibitors of translation. In general, the systems described above alter the transcription of RNA, which is likely in many cases to lead to an alteration in the level of expression of the encoded protein. This section describes approaches to perturbing the rate of protein synthesis through mechanisms that do not necessarily involve an alteration in the rate of transcription of the corresponding mRNA (though in some cases both effects are operative). A variety of biochemical compounds can inhibit the translation of specific genes by binding to its mRNA sequence, or by binding to and catalyzing the cleavage of its mRNA sequence, in a sequence-specific manner. Compounds that exhibit this dsDNA binding activity include:

Full and partial length antisense RNA transcripts. Antisense RNA transcripts have a base sequence complementary to part or all of any other RNA transcript in the same cell. Such transcripts have been shown to modulate gene expression through a variety of mechanisms including the modulation of RNA splicing, the modulation of RNA transport and the modulation of the translation of mRNA [Denhardt, Annals N Y Acad. Sci., 660:70, 1992, Nellen, Trends Biochem. Sci., 18:419, 1993; Baker and Monia, Biochim. Biophys. Acta, 1489:3, 1999; Xu, et al., Gene Therapy, 7:438, 2000; French and Gerdes, Curr. Opin. Microbiol., 3:159, 2000; Tenyn and Rouze, Trends Plant Sci., 5: 1360, 2000].

Antisense RNA and DNA oligonucleotides. Antisense oligonucleotides can be synthesized with a base sequence that is complementary to a portion of any RNA transcript in the cell. Antisense oligonucleotides may modulate gene expression through a variety of mechanisms including the modulation of RNA splicing, the modulation of RNA transport and the modulation of the translation of mRNA [Denhardt, 1992]. The properties of antisense oligonucleotides including stability, toxicity, tissue distribution, and cellular uptake and binding affinity may be altered through chemical modifications including (i) replacement of the phosphodiester backbone (e.g., peptide nucleic acid, phosphorothioate oligonucleotides, and phosphoramidate oligonucleotides), (ii) modification of the sugar base (e.g., 2′-O-propylribose and 2′-methoxyethoxyribose), and (iii) modification of the nucleoside (e.g., C-5 propynyl U, C-5 thiazole U, and phenoxazine C) [Wagner, Nat. Medicine, 1:1116, 1995; Varga, et al., Immun. Lett., 69:217, 1999; Neilsen, Curr. Opin. Biotech., 10:71, 1999; Woolf, Nucleic Acids Res., 18:1763, 1990].

Sequence-specific RNA-binding chemical compounds. Chemical compounds such as aminoglycoside antibiotics demonstrate the ability to bind to single-stranded RNA molecules with high affinity and some sequence-specificity [Schroeder, et al., EMBO J., 19:1, 2000]. Rational and combinatorial chemical modifications have been employed to increase the affinity and specificity of such RNA-binding compounds [Afshar, et al., Curr. Opin. Biotech., 10:59, 1999]. In particular, compounds may be selected that target the primary, secondary and tertiary structures of RNA molecules. Such compounds may modulate the expression of specific genes through a variety of mechanisms including disruption of RNA splicing or interference with translation. For example, high-throughput screening methods lead to the identification of small molecule inhibitors of group I self-splicing introns [Mei, et al., Bioorg. Med. Chem., 5:1185, 1997].

MicroRNAs. Short interfering RNAs and their mechanism of action are described below. Briefly, classical siRNAs trigger degradation of mRNAs to which they are targeted, thereby also reducing the rate of protein synthesis. In addition to siRNAs that act via the classical pathway described below, certain siRNAs that bind to the 3′ UTR of a template transcript may inhibit expression of a protein encoded by the template transcript by a mechanism related to but distinct from classic RNA interference, e.g., by reducing translation of the transcript rather than decreasing its stability. Such RNAs are referred to as microRNAs (mRNAs) and are typically between approximately 20 and 26 nucleotides in length, e.g., 22 nt in length. It is believed that they are derived from larger precursors known as small temporal RNAs (stRNAs) or mRNA precursors, which are typically approximately 70 nt long with an approximately 4-15 nt loop. (See Grishok, A., et al., Cell 106, 23-24, 2001; Hutvagner, G., et al., Science, 293, 834-838, 2001; Ketting, R., et al., Genes Dev., 15, 2654-2659). Endogenous RNAs of this type have been identified in a number of organisms including mammals, suggesting that this mechanism of post-transcriptional gene silencing may be widespread (Lagos-Quintana, M. et al., Science, 294, 853-858, 2001; Pasquinelli, A., Trends in Genetics, 18(4), 171-173, 2002, and references in the foregoing two articles). MicroRNAs have been shown to block translation of target transcripts containing target sites in mammalian cells (Zeng, Y., et al., Molecular Cell, 9, 1-20, 2002).

siRNAs such as naturally occurring or artificial (i.e., designed by humans) mRNAs that bind within the 3′ UTR (or elsewhere in a target transcript) and inhibit translation may tolerate a larger number of mismatches in the siRNA/template duplex, and particularly may tolerate mismatches within the central region of the duplex. In fact, there is evidence that some mismatches may be desirable or required as naturally occurring siRNAs frequently exhibit such mismatches as do mRNAs that have been shown to inhibit translation in vitro. For example, when hybridized with the target transcript such siRNAs frequently include two stretches of perfect complementarity separated by a region of mismatch. A variety of structures are possible. For example, the miRNA may include multiple areas of nonidentity (mismatch). The areas of nonidentity (mismatch) need not be symmetrical in the sense that both the target and the miRNA include nonpaired nucleotides. Typically the stretches of perfect complementarity are at least 5 nucleotides in length, e.g., 6, 7, or more nucleotides in length, while the regions of mismatch may be, for example, 1, 2, 3, or 4 nucleotides in length.

Hairpin structures designed to mimic siRNAs and miRNA precursors are processed intracellularly into molecules capable of reducing or inhibiting expression of target transcripts (McManus, M. T., et al., RNA, 8:842-850, 2002). These hairpin structures, which are based on classical siRNAs consisting of two RNA strands forming a 19 bp duplex structure are classified as class I or class II hairpins. Class I hairpins incorporate a loop at the 5′ or 3′ end of the antisense siRNA strand (i.e., the strand complementary to the target transcript whose inhibition is desired) but are otherwise identical to classical siRNAs. Class II hairpins resemble mRNA precursors in that they include a 19 nt duplex region and a loop at either the 3′ or 5′ end of the antisense strand of the duplex in addition to one or more nucleotide mismatches in the stem. These molecules are processed intracellularly into small RNA duplex structures capable of mediating silencing. They appear to exert their effects through degradation of the target mRNA rather than through translational repression as is thought to be the case for naturally occurring mRNAs and stRNAs. Thus it is evident that a diverse set of RNA molecules containing duplex structures is able to mediate silencing through different mechanisms and may be useful for perturbing the activity of genes, RNAs, and proteins in the practice of different embodiments of the methods described herein.

3. Perturbing Rate of RNA Degradation

Short interfering RNAs. RNA interference (RNAi) is a mechanism of post-transcriptional gene silencing mediated by double-stranded RNA (dsRNA), which is distinct from antisense and ribozyme-based approaches. dsRNA molecules are believed to direct sequence-specific degradation of mRNA in cells of various types after first undergoing processing by an RNase III-like enzyme called DICER (Bernstein et al., Nature 409:363, 2001) into smaller dsRNA molecules comprised of two 21 nt strands, each of which has a 5′ phosphate group and a 3′ hydroxyl, and includes a 19 nt region precisely complementary with the other strand, so that there is a 19 nt duplex region flanked by 2 nt-3′ overhangs. RNAi is thus mediated by short interfering RNAs (siRNA), which typically comprise a double-stranded region approximately 19 nucleotides in length with 1-2 nucleotide 3′ overhangs on each strand, resulting in a total length of between approximately 21 and 23 nucleotides. In mammalian cells, dsRNA longer than approximately 30 nucleotides typically induces nonspecific mRNA degradation via the interferon response. However, the presence of siRNA in mammalian cells, rather than inducing the interferon response, results in sequence-specific gene silencing.

In general, a short, interfering RNA (siRNA) comprises an RNA duplex that is preferably approximately 19 basepairs long and optionally further comprises one or two single-stranded overhangs or loops. An siRNA may comprise two RNA strands hybridized together, or may alternatively comprise a single RNA strand that includes a self-hybridizing portion. siRNAs may include one or more free strand ends, which may include phosphate and/or hydroxyl groups. siRNAs typically include a portion that hybridizes under stringent conditions with a target transcript. One strand of the siRNA (or, the self-hybridizing portion of the siRNA) is typically precisely complementary with a region of the target transcript, meaning that the siRNA hybridizes to the target transcript without a single mismatch. In most embodiments of the invention in which perfect complementarity is not achieved, it is generally preferred that any mismatches be located at or near the siRNA termini as described in more detail below. For the purposes of the present invention, any RNA comprising a double-stranded portion, one strand of which is complementary to and binds to a target transcript and reduces its expression, whether by triggering degradation, by inhibiting translation, or by other means, is considered to be an siRNA, and any structure that generates such an siRNA is useful in the practice of the present invention.

The term hybridize, as used herein, refers to the interaction between two complementary nucleic acid sequences. The phrase hybridizes under high stringency conditions describes an interaction that is sufficiently stable that it is maintained under art-recognized high stringency conditions. Guidance for performing hybridization reactions can be found, for example, in Current Protocols in Molecular Biology, John Wiley & Sons, N.Y., 6.3.1-6.3.6, 1989, and more recent updated editions, all of which are incorporated by reference. See also Sambrook, Russell, and Sambrook, Molecular Cloning: A Laboratory Manual, 3^{rd} ed., Cold Spring Harbor Laboratory Press, Cold Spring Harbor, 2001. Aqueous and nonaqueous methods are described in that reference and either can be used. Typically, for nucleic acid sequences over approximately 50-100 nucleotides in length, various levels of stringency are defined, such as low stringency (e.g., 6× sodium chloride/sodium citrate (SSC) at about 45° C., followed by two washes in 0.2×SSC, 0.1% SDS at least at 50° C. (the temperature of the washes can be increased to 55° C. for medium-low stringency conditions)); 2) medium stringency hybridization conditions utilize 6×SSC at about 45° C., followed by one or more washes in 0.2×SSC, 0.1% SDS at 60° C.; 3) high stringency hybridization conditions utilize 6×SSC at about 45° C., followed by one or more washes in 0.2×SSC, 0.1% SDS at 65° C.; and 4) very high stringency hybridization conditions are 0.5M sodium phosphate, 0.1% SDS at 65° C., followed by one or more washes at 0.2×SSC, 1% SDS at 65° C.) Hybridization under high stringency conditions only occurs between sequences with a very high degree of complementarity. One of ordinary skill in the art will recognize that the parameters for different degrees of stringency will generally differ based various factors such as the length of the hybridizing sequences, whether they contain RNA or DNA, etc. For example, appropriate temperatures for high, medium, or low stringency hybridization will generally be lower for shorter sequences such as oligonucleotides than for longer sequences.

An siRNA is considered to be targeted for the purposes described herein if 1) the stability of the target gene transcript is reduced in the presence of the siRNA as compared with its absence; and/or 2) the siRNA shows at least about 90%, more preferably at least about 91%, 92%, 93%, 94%, 95%, 96%, 97%, 98%, 99%, or 100% precise sequence complementarity with the target transcript for a stretch of at least about 17, more preferably at least about 18 or 19 to about 21-23 nucleotides; and/or 3) the siRNA hybridizes to the target transcript under stringent conditions.

siRNAs have been shown to downregulate gene expression when transferred into mammalian cells by such methods as transfection, electroporation, or microinjection, or when expressed in cells via any of a variety of plasmid-based approaches. RNA interference using siRNA is reviewed in, e.g., Tuschl, T., Nat. Biotechnol., 20: 446-448, May 2002. See also Yu, J., et al., Proc. Natl. Acad. Sci., 99(9), 6047-6052 (2002); Sui, G., et al., Proc. Natl. Acad. Sci., 99(8), 5515-5520 (2002); Paddison, P., et al., Genes and Dev., 16, 948-958 (2002); Brummelkamp, T., et al., Science, 296, 550-553 (2002); Miyagashi, M. and Taira, K., Nat. Biotech., 20, 497-500 (2002); Paul, C., et al., Nat. Biotech., 20, 505-508 (2002). As described in these and other references, the siRNA may consist of two individual nucleic acid strands or of a single strand with a self-complementary region capable of forming a hairpin (stem-loop) structure. A number of variations in structure, length, number of mismatches, size of loop, identity of nucleotides in overhangs, etc., are consistent with effective siRNA-triggered gene silencing. While not wishing to be bound by any theory, it is thought that intracellular processing (e.g., by DICER) of a variety of different precursors results in production of siRNA capable of effectively mediating gene silencing. Generally it is preferred to target exons rather than introns, and it may also be preferable to select sequences complementary to regions within the 3′ portion of the target transcript. Generally it is preferred to select sequences that contain approximately equimolar ratio of the different nucleotides and to avoid stretches in which a single residue is repeated multiple times.

siRNAs may thus comprise RNA molecules having a double-stranded region approximately 19 nucleotides in length with 1-2 nucleotide 3′ overhangs on each strand, resulting in a total length of between approximately 21 and 23 nucleotides. As used herein, siRNAs also include various RNA structures that may be processed in vivo to generate such molecules. Such structures include RNA strands containing two complementary elements that hybridize to one another to form a stem, a loop, and optionally an overhang, preferably a 3′ overhang. Preferably, the stem is approximately 19 bp long, the loop is about 1-20, more preferably about 4-10, and most preferably about 6-8 nt long and/or the overhang is about 1-20, and more preferably about 2-15 nt long. In certain embodiments of the invention the stem is minimally 19 nucleotides in length and may be up to approximately 29 nucleotides in length. Loops of 4 nucleotides or greater are less likely subject to steric constraints than are shorter loops and therefore may be preferred. The overhang may include a 5′ phosphate and a 3′ hydroxyl. The overhang may but need not comprise a plurality of U residues, e.g., between 1 and 5 U residues. It is thus evident that RNA molecules having a variety of different structures comprising a double-stranded portion, one strand of which is complementary to a target transcript, may effectively mediate RNAi. For the purposes of the present invention, any such RNA, one portion of which binds to a target transcript and reduces its expression, whether by triggering degradation, by inhibiting translation, or by other means, is considered to be an siRNA, and any structure that generates such an siRNA (i.e., serves as a precursor to the RNA) is useful in the practice of the present invention.

siRNAs may be generated by intracellular transcription of small RNA molecules, which may be followed by intracellular processing events. For example, intracellular transcription is achieved by cloning siRNA templates into RNA polymerase III transcription units, e.g., under control of a U6 or H1 promoter. In one approach, sense and antisense strands are transcribed from individual promoters, which may be on the same construct. The promoters may be in opposite orientation so that they drive transcription from a single template, or they may direct synthesis from different templates. In a second approach siRNAs are expressed as stem-loop structures. As is the case for other nucleic acid reagents discussed herein, siRNAs may be introduced into cells by any of a variety of methods. For instance, siRNAs or vectors encoding them can be introduced into cells via conventional transformation or transfection techniques. As used herein, the terms “transformation” and “transfection” are intended to refer to a variety of art-recognized techniques for introducing foreign nucleic acid (e.g., DNA or RNA) into a host cell, including calcium phosphate or calcium chloride co-precipitation, DEAE-dextran-mediated transfection, lipofection, injection, or electroporation. Vectors that direct in vivo synthesis of siRNA constitutively or inducibly can be introduced into cell lines, cells, or tissues. Introduction of the siRNA, or induction of its synthesis, results in degradation of the target transcript, thereby also decreasing the rate of synthesis of the protein encoded by the target trancript.

RNA and DNA enzymes. Both RNA and DNA molecules have demonstrated the ability to accelerate the catalysis of certain chemical reactions such as nucleic acid polymerization, ligation and cleavage [Lilley, Curr. Opin. Struct. Biol., 9:330, 1999; Li and Breaker, Curr. Qpin. Struct. Biol., 9:315, 1999; Sen and Geyer, Curr. Opin. Chem. Biol., 2:680, 1998; Breaker, Nat. Biotech., 15:427, 1997; Couture, et al., Trends Genet., 12:510, 1996; Thompson, et al., Nat. Medicine, 1:277, 1995; U.S. Pat. Nos. 4,987,071; 5,712,128; 5,834,186; 5,773,260; 5,977,343; 6,022,962]. That is, RNA and DNA molecules can act as enzymes by folding into a catalytically active structure that is specified by the nucleotide sequence of the molecule. Certain of these molecules are referred to as ribozymes or deoxyribozymes. In particular, both RNA and DNA molecules have been shown to catalyze the sequence-specific cleavage of RNA molecules. The cleavage site is determined by complementary pairing of nucleotides in the RNA or DNA enzyme with nucleotides in the target RNA. Thus, RNA and DNA enzymes can be designed to cleave to any RNA molecule, thereby increasing its rate of degradation [Cotten and Bimstiel, EMBO J. 8:3861-3866, 1989; Usman, et al., Nucl. Acids Mol. Biol., 10:243, 1996; Usman, et al., Curr. Opin. Struct. Biol., 1:527, 1996; Sun, et al., Pharmacol. Rev., 52:325, 2000]. Hence, RNA and DNA enzymes can disrupt the translation of mRNA by binding to, and cleaving mRNA molecules at specific sequences.

Perturbation of the rate of degradation of RNA species may also be accomplished by inducible expression of an appropriate ribozyme within the cell. See, e.g., Cotten and Birnstiel, “Ribozyme mediated destruction of RNA in vivo”, EMBO J. 8:3861-3866, 1989.

4. Perturbing Properties or Enzymatic Activity of Proteins.

As mentioned above, properties or features of proteins such as phosphorylation state, cellular localization, association with other proteins, etc., may be considered activities within the scope of the invention. Phosphorylation state can be perturbed by treating cells with an appropriate phosphatase and/or by inducibly expressing an appropriate linase or phosphatase within the cell. Belshaw et al., 1996, “Controlling protein association and subcellular localization with a synthetic ligand that induces heterodimerization of proteins”, Proc. Natl. Acad. Sci. USA 93:4604-4607 describe methods that may be used to perturb the localization or association state of proteins. Alterations in phosphorylation state, localization, and/or association state may in turn be used to perturb enzymatic or other activities of proteins that are dependent upon phosphorylation, localization, or association.

According to another approach, any enzymatic or other activity of a protein may be inhibited by expressing an appropriate “dominant negative” form of the protein in the cell. (See, e.g., Herskowitz, 1987, “Functional inactivation of genes by dominant negative mutations”, Nature 329:219-222.) For example, the activity of a transcription factor that contains a DNA binding domain and an activation domain may be inhibited by inducibly expressing a protein containing the DNA binding domain but lacking the activation domain. This protein is capable of binding to the recognition site to which the transcription factor normally binds, but does not activate transcription. However, binding blocks access to the site by the wild type transcription factor, thereby effectively inhibiting its activity. In yet another approach, protein domains known to inhibit activity of other proteins by binding to them may be inducibly expressed.

C. Measuring Response to Perturbations. According to preferred embodiments of the invention the response of a biological network (i.e., the activities of the biochemical species in the network) to perturbations in a plurality of biochemical species (either independently or in combination, as described above) is determined a sufficient time after the perturbation that the biological network has reached a new steady state. Thus rather than using time series data, as is typically done according to various other methods of constructing models of biological networks, one aspect of the invention is the inventors' discovery that steady state measurements are adequate for accurately modeling biological networks as described herein. Methods for measuring different types of activities are described above. In accordance with the invention, the new steady state is preferably close to the initial steady state that existed prior to the perturbation. In general, as mentioned above, according to the invention it is preferable that the network remains near a single steady state throughout the experiment, i.e., prior to the perturbation, through the time when the response is measured.

D. Statistical Considerations, Noise and Error, Robustness and Scalability.

It will be appreciated that measurements of activity obtained using any of the techniques discussed above are subject to measurement error, which may affect the accuracy of the model. A variety of approaches may be employed to reduce or account for the effects of such error. For example, according to preferred embodiments of the invention multiple measurements are performed for each data point. This may involve, for example, growing replicate cultures of cells under substantially identical conditions, applying the same perturbation to each culture, measuring the responses in each culture, and using the mean of the measured activities. Preferably the standard error and variance associated with such measurements is small. According to various embodiments of the invention, between 1 and 20 replicates are used, including any number between 1 and 20. In addition, multiple measurements may be performed on each culture.

As mentioned above, in practice it is generally straightforward to maintain the cells in a substantially constant environmental and physiological state and thereby achieve a steady state, but due to the presence of measurement noise, it may be preferable that the perturbations exceed some lower limit so that the response will not be obscured by noise. Thus errors due to noise can be reduced by improving the signal-to-noise ratio (S/N) by increasing the size of the perturbations. However, larger perturbations can lead to larger nonlinear errors. One of ordinary skill in the art will be able to identify an acceptable balance between noise and nonlinear error. According to preferred embodiments of the invention a measurement technology, number of replicates, and a perturbation level that provides a (S/N) ratio greater than 1.2, more preferably greater than 1.5, yet more preferably greater than 2, should be selected.

According to certain embodiments of the invention a variety of different statistical measures may be used to facilitate identification of parameters that are likely to reflect actual connections in the physical network. For example, where parameters are determined using multiple regression as described above and in the Examples, variances on these estimated parameters may be computed as described above. The square root of the variances may be thought of as error bars. The estimated parameters and their variances are then used in a t-test to generate a P-value. The t-test is designed such that the P-value reflects the probability that a particular value is equal to zero. For example, a P-value of 0.21 on a particular parameter, wᵢⱼ, means that the parameter has a 21% probability of being zero rather than a non-zero value such as the one estimated. Thus a lower P-value provides higher confidence that the parameter represents an real connection in the physical network (i.e. not zero). As used herein, a P-value means the probability that a given parameter or variable is equal to zero.

For example, to determine the confidencd levels on a predicted target of a perturbation (see description of target prediction below), the best prediction of the perturbation is calculated using the estimated parameters (Eq. 27). The estimated parameters, and the variances on the parameters, are then used to calculate the variances of the predicted perturbations (Eq. 28, see below). The predicted perturbations and the variances calculated for those predictions are then used to perform another t-test. The resulting P-values represent the probability that the predicted perturbation is equal to zero. Thus, for example, a low P-value for a the predicted perturbation to a particular biochemical species indicates that it is unlikely that the predicted perturbation is equal to zero, i.e., there is high confidence that the species is indeed a target of the perturbation. Conversely, high P-values indicate that the predicted perturbation is more likely equal to zero, i.e., that the predicted prediction reflects merely noise. Any particular value of P may be selected as a “cutoff” value, or significance threshold, above which parameters will be deemed not to differ significantly from zero. For example, the inventors selected a cutoff value of 0.3 in one implementation of the invention. Any parameter having an associated P-value above 0.3 was considered insignificant (i.e., probably zero), and any parameter having an associated P-value below 0.3 was considered significant (i.e., probably nonzero). However, other values, e.g., 0.05, 0.1, 0.2, 0.4, or any intermediate value, may be selected. Selecting a lower cutoff will result in fewer false positives, but also in more missed detections of actual regulatory influences (false negatives). In general, according to certain embodiments of the invention, P=0.32 (which is roughly one standard deviation, but may vary depending on the degrees of freedom in the data set) is the maximum acceptable cutoff for significance. The foregoing description has been for illustrative purposes only. It will be appreciated that a wide variety of statistical measures may be selected. For example, the statistical significance of estimated parameters, measured activities, predicted perturbations, etc., may be evaluated using a z-test, chi-squared test, etc. Such statistical tests may be used with estimates of the first and second moments of the probability density function of the estimated parameters, measured activities, predicted perturbations, etc.

In those embodiments of the invention in which it is assumed that the network is not fully connected, the problem of modeling a biological network is converted from being underdetermined to being overdetermined. This assumption enables the method of the invention to recover a model of the network even with high levels of measurement noise. For example, as described in Examples 2, 3, 4, and 5, in experiments on the SOS pathway in E. coli and in computational tests on randomized networks, the inventive methods correctly recovered much of the network with relatively few errors, even in the presence of high noise levels. Moreover, the predictive power of the recovered network model was highly robust to both measurement noise and model errors. As described in the Examples, the SOS network model identifies the targets of a compound with nearly 100% coverage and specificity, even at a measurement noise level of 68%.

It is noted that from a practical standpoint, one of the potential advantages of the invention is its scalability. Computationally, the methods described herein may be easily applied to large networks. Experimentally, the scalability of the method is at least in part dependent on the speed with which perturbations can be delivered, and, indeed, this may be the primary limitation. Thus in general it is preferred to select perturbations that may be easily applied to any species in the network. For example, Example 1 describes an embodiment of the invention in which all perturbations are transcriptional overexpression and are delivered from episomal expression plasmids. Thus, the perturbations are easily applied to any gene and do not require chromosomal modifications.

V. Applications

A. Identifying Regulators of Species in the Biological Network.

As mentioned above, the parameters of the network model may be represented as a matrix \tilde{W}, in which for a given row that represents species i, each element in the row represents the strength of a regulatory input to species i from species j (or from a combination of species in the case of a higher order approximation). For any species i, this matrix may be used to identify species in the network that regulate (i.e., influence the activity of) the species. The entry at the jth position in the ith row of W represents the strength of the regulatory influence exerted by species j on species i (or combination of species on species i). Thus any species j for which the entry at the jth position in the ith row is nonzero (preferably with a statistically significant difference from zero) may be a regulator of species i. If the sign of the entry is positive, this indicates that species j is a positive regulator of species i, i.e., that an increase in the activity of species j will result in an increase in the activity of species i (ignoring secondary effects, described below), and conversely, a decrease in the activity of species j, will result in a decrease in the activity of species i, ignoring secondary effects. If the sign of the entry is negative, this indicates that species j is a negative regulator of species i, i.e., that an increase in the activity of species j will result in an decrease in the activity of species i, ignoring secondary effects, and conversely, a decrease in the activity of species j, will result in an increase in the activity of species i, ignoring secondary effects.

However, in general the matrix \tilde{W} does not directly reveal the overall sensitivity of species i to a change in the activity of species j, because, for example, a change in the activity of species j may have effects on multiple other species, which may in turn (either directly or indirectly) exert an effect on the activity of species i. These latter effects may be referred to as secondary effects. According to certain embodiments of the invention, in order to identify species that exert an overall regulatory effect on other species, i.e., to determine the sensitivity of the activity of a first species or set of species to changes in the activity of a second species, the gain matrix G=\tilde{W}⁻¹ is evaluated, if \tilde{W}⁻¹ exists. Each column j in the gain matrix describes the net response of all species in the network to a perturbation to species j, or, in other words, the net effect of a perturbation of speciesj on the activities of the biochemical species in the network. Thus for any species i, the entry at entry at the jth position in the ith row represents a quantitative measure of the sensitivity of the activity of species i to a change in the activity of species j. The quantitative measure may be, for example, the percentage change in the activity of species i to a unit change in the activity of species j. The invention therefore provides a method of performing sensitivity analysis on a biological network comprising steps of: (i) generating a model of the biological network according to any of the inventive methods for constructing a model of a biological network described herein; and (ii) determining the sensitivity of the activities of a first set of one or more species in the network to a change in the activities of a second set of one or more species in the network using the model.

The method may further comprise the step of identifying the second set of species as a major regulator of the first set of species if the sensitivity of the first set of species to a change in the activities of the second set of species meets a predefined criterion. The predefined criterion may be, for example, a requirement that sensitivity of the activities of at least one species in the first set of species to a change in the activities of the second set of activities is statistically different from zero, a requirement that the sensitivity of the activities of at least one species in the first set of species to a change in the activities of the second set of activities exceeds a predetermined value, or a requirement that the sensitivity of the activities of the first set of species to a change in the activities of the second set of species is greater than the sensitivity of the first set of species to change in the activities a third set of one or more species.

According to certain embodiments of the invention the sensitivity of the activities a first set of biochemical species to a change in the activities of a second set of biochemical species may be a measure of the change in activities of the first set of species in response to a change in activities of the second set of species. The measure may be a quantitative measure, for example, the measure may be the mean percentage change in activities of the first set of species in response to a unit change in activities of the second set of species.

The matrix G may be used to identify major regulators of species i. For example, any species j for which the entry at the jth position in the ith row meets a predetermined or predefined criterion, may be identified as a major regulator of species i. (In general, the terms “predetermined” and “predefined” are used interchangeably herein unless otherwise indicated.) According to various embodiments of the invention a variety of predetermined criteria may be used to identify a major regulator of species i. For example, the predetermined criterion may require that the entry exceeds a certain predetermined threshold value, e.g., 5, 10, 15, 20, 25, 30, etc. In general, the larger the threshold, the stronger the regulators identified by the criteria. Thus the methods described above for performing sensitivity analysis on the network may further comprise the step of: identifying the second species as a major regulator of the first species, or of the set of species, if the sensitivity of the first species or set of species to a change in the activity of the second species meets a predefined criterion.

The matrix G may also be used to identify major regulators of the network as a whole, where any of a variety of criteria may be used to define a major regulator. For example, a major regulator may be a regulator for which the mean sensitivity of the activities of a plurality (which may be any number less than or equal to N) of the species in the network exceeds a predetermined value. Alternately, a major regulator may be a regulator for which the mean sensitivity of the activities of a plurality (which may be any number less than or equal to N) of species in the network exceeds a predetermined value. In general, any aggregate measure of the sensitivity of the activities of a plurality of species in the network may be used to define a major regulator. According to certain embodiments of the invention the methods for performing sensitivity analysis further comprise the step of: identifying the second species as a major regulator of the biological network if an aggregate measure of the sensitivity of the set of species to a change in the activity of the second species meets a predefined criterion. Any of a wide variety of predetermined criteria may be used. For example, the criterion may require that the sensitivity of the activity of one or more species is statistically different from zero, or exceeds a predefined value, etc.

It will be appreciated that the absolute magnitudes of the entries in matrix G will depend on the particular implementation choices and species in the network. According to certain embodiments of the invention the criterion involves a measure of the statistical significance of the regulatory interaction (e.g., employing a statistical test such as a t-test), which may involve normalizing the absolute magnitudes of the parameters. For example, a species may be identified as a major regulator if the mean activity change for species i resulting from a perturbation of species j divided by the standard deviation of the activity change for species i exceeds a predetermined value, e.g., 1, 2, 3, etc. Alternately, a species may be identified as a major regulator of species i if the mean activity change for species i resulting from a perturbation of species j divided by the standard deviation of the activity change for species i is different from 0 in a statistically significant manner, e.g., with a P value less than 0.3, 0.2, 0.1, 0.05, 0.01, etc., where a lower P value indicates an increased strength of the interaction. According to other embodiments of the invention a regulator is identified as a major regulator if the mean activity change for species i resulting from a perturbation of species j divided by the standard deviation of the activity change for species i is greater than that of other regulators of species i. According to certain embodiments of the invention the regulators of species i are displayed as a list ordered according to their strength.

Computation of the gain matrix represents one approach to using the model to perform sensitivity analysis of the network. Other approaches that make use of the estimated parameters are also within the scope of the invention.

It will be appreciated that in the case of certain species, the main regulators may lie outside the set of species included in the model. This will likely be the case if none of the entries in row i is statistically significant. For example, the multiple linear regression implementation for finding the solution that minimizes the mTSE fitness function returns the significance of the regression (goodness of fit) and the standard error of each of the recovered parameters. A lack of significance of the regression for a given species implies that its main regulators lie outside the set of regulators included in the model.

B. Identifying Targets

In addition to methods for using the model to identify regulatory interactions and relationships among the biochemical species in the network, the invention also provides methods of using the model to identify species that are targets of external perturbations, e.g., stimuli that alter the activity of one or more biochemical species in the network. Perturbations arising as a result of exposure to compounds and/or changes in environmental conditions are of particular interest.

As used herein, a compounds include: small molecules (e.g., small organic molecules) that may be of interest for research and/or therapeutic purposes; naturally-occurring factors, such as endocrine, paracrine, or autocrine factors; hormones; neurotransmitters; cytokines, other agents that may interact with cellular receptors; intracellular factors, such as components of intracellular signaling pathways; ions; factors isolated from other natural sources; etc. The foregoing list is intended merely to indicate the broad range of substances that are considered compounds within the context of the present invention. The category of environmental conditions is similarly broad, including, but not limited to, temperature, osmotic activity, pH, concentration of O₂, CO₂, etc., in medium, nutrient availability, exposure to energy forms such as radiation, radioactive compounds, etc.

The biological effect(s) of a compound or environmental condition may result, for example, from alterations in the state (e.g., formation of crosslinks or dimers, changes in methylation state, changes in degree of condensation, or changes in physical integrity of DNA), alterations in the rate of transcription or degradation of one or more species of RNA, changes in the rate or extent of translation or post-translational processing of an RNA or polypeptide, changes in the rate or extent of polypeptide degradation, inhibition or stimulation of RNA and/or protein action or activity, opening of ion channels, dissociation or association of cellular constituents, alteration in subcellular localization of cellular constituents, competition with endogenous ligands of receptors, etc. The foregoing list is intended to be representative and not to limit the scope of the invention.

In general, a “target” of a compound or change in environmental condition is a biochemical species, such as a gene(s) or gene product, RNAs, proteins, etc., whose activity is “directly” “affected” by the compound. Any compound may have one or more targets. As used herein, a compound “affects” a biochemical species if the activity of the biological species is detectably altered when a biological system comprising the biological species is contacted with the compound or exposed to the environmental condition. In general, if a compound alters the activity of a protein, the gene and mRNA that encode the protein and the protein itself may be considered targets of the compound, regardless of whether the level of expression of the gene (either in terms of RNA or protein) is altered. Similarly, if a compound alters the activity of an RNA, the gene that serves as a template for that RNA is also considered a target.

According to certain embodiments of the invention a cellular constituent (such as a gene, a gene product, or a gene product activity) is considered to be “directly” affected by a compound when the effect does not depend entirely on the intervening action of a different cellular constituent (such as a different gene or a product of a different gene). In contrast to a direct effect, a second biochemical species may be indirectly affected by a compound, for example, when the compound directly or indirectly changes the activity of a first biochemical species, and this change in turn results in a detectable change in activity of the second biochemical species.

The “direct targets” may be considered to be “entry points” of the perturbation (e.g., compound activity or environmental condition) into the modeled network. i.e., they are where the compound's activity acts as an additional external input into the response (i.e., the change in activity) of a modeled species (other species in the model could be affecting these entry point species, but their effects are not sufficient to explain the change in activity caused by the perturbation). All non-entry point species responses can be explained as a result of changes in the activities of other species in the model in response to the perturbation, i.e., such species do not receive an additional external input from a species (or other factor) not modeled in the network.

In general, therefore, if a particular species is identified as a target, its observed activity cannot be explained solely on the basis of inputs from other species in the network. therefore, there must be an input from some external perturbation that is additionally affecting the targeted species. This external perturbation is assumed to be the result, for example, of a compound or environmental change. However, in the case of a compound, it may not be the compound itself that is physically interacting with the species referred to as a direct target. The compound may be interacting with some other biochemical species (another gene, a protein, a metabolite, etc.) that is not explicitly included in the model. That species may then interact with the species that is included in the model. Under such conditions the inventive methods will identify the species included in the model as the direct target.

In accordance with the invention, once the estimated network parameters, \tilde{W}, have been determined using any of the inventive methods described above, the target species and strength of an unknown perturbation, u₀, can be determined, given the response to that perturbation, q₀. The predicted perturbations û₀ are computed from:
û₀=−\tilde{W}q₀. (Eq. 27)

The variances on the predicted perturbations to species i can be computed as (D. Montgomery, E. A. Peck, G. G. Vining, Introduction to Linear Regression Analysis, John Wiley & Sons, Inc., New York, 2001):

$$var ( {\hat{u}}_{0 i} ) = {{\underline{q}}_{0}^{T} ( Z {Z}^{T} )}^{- 1} Z {Σ}_{η} {{Z}^{T} ( Z {Z}^{T} )}^{- 1} {\underline{q}}_{0} + {\sum }_{j = 1}^{P} {\tilde{w}}_{ij}^{2} var ( {q}_{0 j} ) \qquad ( Eq . 28 )$$

In other words, the inventive method identifies the perturbations (i.e., species being perturbed and strength of perturbation) that, when used in the model to compute the predicted responses of the species in the network, would produce the best fit to the observed responses to the applied perturbation. Those species for which the strength of the required perturbation satisfies a predetermined criterion, e.g., exceeds a predefined value, achieves a predefined level of statistical significance, etc., are identified as targets of the applied perturbation (e.g., targets of a compound with which the biological network is contacted).

Thus the invention provides methods of identifying a target of a perturbation comprising steps of (i) providing a biological system comprising a biological network comprising a plurality of biochemical species having activities; (ii) providing or generating a model of the biological system constructed according to any of the inventive methods for constructing a model of a biological network described herein; (iii) perturbing one or more biochemical species in the network; (iv) allowing the biological network to reach a steady state; (v) determining the response of at least one of the biochemical species in the biological network to the compound; and (vi) calculating predicted perturbations of biochemical species in the biological network that would be expected to yield the determined responses according to the model.

The method may further comprise the step of identifying a biochemical species as a target of the perturbation if the predicted perturbation to that biochemical species meets a predefined criterion or criteria. The predefined criterion may be, for example, a requirement that the strength of the predicted perturbation to the biochemical species exceeds a predetermined value, or a requirement that the strength of the predicted perturbation is identified as statistically significant. According to certain embodimetns of the invention a predicted perturbation is identified as statistically significant by using a statistical test selected from the group consisting of the z-test, the t-test, and the chi-squared-test. The statistical test may be used with estimates of the first and second moments of the probability density functions of the predicted perturbations, wherein the estimates of the first and second moments are calculated from measured values of the responses of the biochemical species and measured values of the perturbations applied in the perturbing step.

Such statistical tests may be used with estimates of the first and second moments of the probability density function of the estimated parameters, measured activities, predicted perturbations, etc. For example, estimates of the first and second moments of predicted perturbations can be calculated from measured values of the responses of biochemical species in the network and measured values of the applied perturbations.

According to certain embodiments of the invention the perturbation is accomplished by contacting the biological system with a compound, thereby causing a response in the biological network, and the identified target is thus a target of the compound. The method may further comprise the step of identifying significant predicted perturbations of biochemical species from among the predicted perturbations calculated in the calculating step and/or may also further comprise the step of explicitly identifying a biochemical species perturbed by the significant predicted perturbations as a target of the perturbation.

According to certain embodiments of the invention a plurality of targets for a perturbation such as that caused by a compound or environmental condition are identified. The sensitivity of the targets to the compound or environmental condition may be evaluated, and the targets may be ranked in a manner that reflects the degree of sensitivity of the targets to the compound or environmental condition.

As described in the Examples, the inventors have constructed a model of the biological network known as the SOS pathway in E. coli according to one of the inventive methods. The inventors then applied the method for identifying targets of a perturbation to identify biochemical species (in this case, genes) in the network that are targets of the compound mitomycin C (MMC). A MMC perturbation was applied by addition of MMC to cultures of cells at steady state, and responses (transcriptional changes) were measured relative to control cells grown in baseline conditions. All genes in the network showed statistically significant upregulation. However, when the network model was applied to the expression data, the recA gene was correctly identified as the transcriptional mediator (target) of MMC (a result known from previous work), with only one false positive (umuD). Furthermore, recA was identified at a substantially higher significance level than umuD, suggesting it as the more likely, or only, true target.

It will be appreciated that in certain embodiments of the invention, e.g., where the activities measured are transcriptional changes, protein and metabolite species may not generally be explicitly represented in the network model. Consequently, the network model will typically specifically identify only the direct transcriptional mediators of bioactivity, but not protein or metabolite targets of a compound. Nevertheless, in accordance with the invention the protein or metabolite regulators of the transcripts can be identified, e.g., using biological databases and/or other information available in the literature or elsewhere. With modest additional experimental effort, such regulators can be confirmed as the true targets. Thus, the network model can accelerate the identification of protein and metabolite targets of a compound, even when proteins and metabolites are not explicitly represented in the model.

Identifying targets of a compound or an environmental change has a number of potential applications. For example, it is frequently the case that the mechanism of action of a therapeutic compound is unknown. In other words, the biochemical pathways and biochemical species whose activity is changed in response to the compound, which change is at least in part responsible for the therapeutic effect of the compound, are unknown. It is thus difficult to rationally identify additional compounds that may be of therapeutic value. Determining the biochemical species that are targets of a particular compound may thus allow the identification of additional compounds that may have similar or improved therapeutic properties. Similarly, it is often the case that the mechanism of action of a deleterious compound (e.g., a pesticide, toxin, etc.) is unknown. Determining the biochemical species that are targets of such a compound may allow identification of additional compounds that may have increased effects (e.g., in the case of a pesticide) or may allow identification of compounds that would antagonize the effect of the compound on its targets (e.g., in the case of a toxin). The foregoing represent merely two of the many possible uses for the inventive methods of identifying targets of a compound or environmental condition.

C. Identifying Phenotypic Mediators. According to certain embodiments of the invention a model of a biological network is generated for each of a plurality of different biological systems, wherein the biological networks for each biological system contain one of one or more of the same biochemical species. In general, the different biological systems will display different phenotypes, where phenotype is interpreted broadly to include any observable difference, which difference may be detected or observed using any suitable method. In general, such different phenotypes reflect differences in genotype, although differences in genotype may not be reflected in differences in genotype. In some instances, a genotypic difference between two biological systems may be reflected as a difference in the parameters of the model for a biological network in that system (which difference may be the most readily detectable difference between the biological systems). Preferably the biological networks in each of the biological systems contain an overlapping, or substantially identical, set of biochemical species. For example, if the biological network in biological system A contains biochemical species I, J, K, L, M, etc., then preferably the biological network in the other biological systems (e.g., systems B and C) contains at least 70%, more preferably at least 80%, more preferably at least 90%, more preferably at least 95% of the biochemical species I, J, K, L, M, etc. According to certain embodiments of the invention the biological networks in each biological system contain the same set of biochemical species.

The biological systems may be, for example, cells of different types, cells from different organs, cells from different species, transformed and untransformed cells, diseased and normal cells (e.g., cells from a diseased and a nondiseased (normal) tissue or subject), cells from a subject that has suffered a side-effect of a drug, cells that have been exposed to different compounds or environmental conditions, unexposed cells, etc.) The biological network models are compared, and parameters (or sensitivities derived from the parameters as described above) that differ significantly among the various models are identified. Biochemical species whose parameters are altered are identified as likely to be significant in term of causing or contributing to the different phenotypes of the biological systems. Such species may be referred to as phenotypic mediators. Accordingly, the invention provides a method for identifying phenotypic mediators comprising steps of: (i) comparing parameters of models of biological networks for a plurality of biological systems, wherein the models are generated according to any of the inventive methods for constructing models of biological networks described herein, and wherein the biological networks comprise overlapping or substantially identical sets of biochemical species; and (ii) identifying biochemical species for which associated parameters differ between the models as candidate phenotypic mediators. Typically, one or more of the biological systems display differences in one or more properties. Such properties may include, for example, the steady-state activities of the biochemical species of the biological system, the phenotype of the biological system, and the genotype of the biological system. According to certain embodiments of the invention a species is identified as a phenotypic mediator if the difference between the parameters for that species in some or all of the models satisfies a predefined criterion, e.g., a requirement that the difference exceeds a predefined value, a requirement that the difference achieves a particular level of statistical significance, etc. Identification of phenotypic mediators has a number of practical applications. For example, where the biological systems are associated with different disease states, phenotypic mediators may be preferred targets for therapies for the disease.

VI. Computer Implementation Systems and Methods

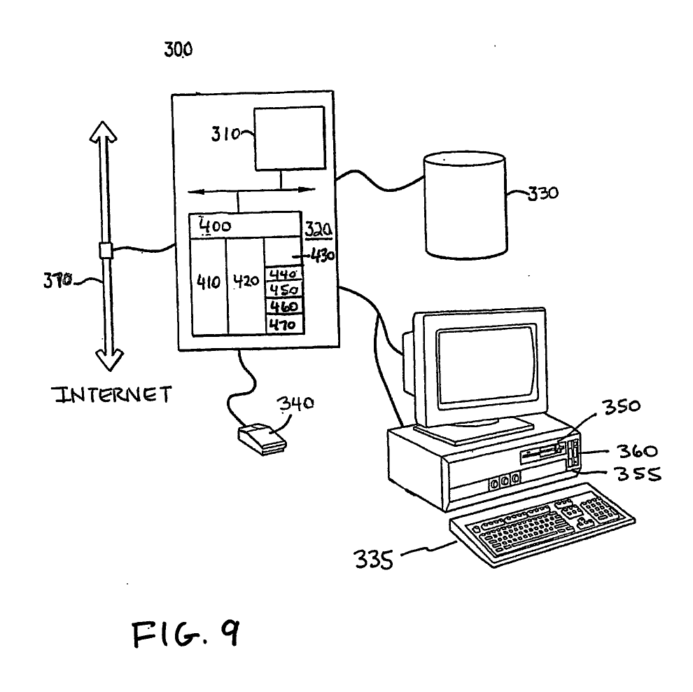

The methods described above may advantageously be implemented using a computer-based approach, and the present invention therefore includes a computer system for practicing the methods. FIG. 9 depicts a representative embodiment of a computer system that may be used for this purpose. Computer system 300 comprises a number of internal components and is also linked to external components. The internal components include processor element 310 interconnected with main memory 320. For example, computer system 310 can be a Intel Pentium™-based processor such as are typically found in modern personal computer systems. The external components include mass storage 330, which can be, e.g., one or more hard disks (typically of 1 GB or greater storage capacity). Additional external components include user interface device 335, which can be a keyboard and a monitor including a display screen, together with pointing device 340, such as a “mouse”, or other graphic input device. The interface allows the user to interact with the computer system, e.g., to cause the execution of particular application programs, to enter inputs such as data and instructions, to receive output, etc. The computer system may further include disk drive 350, CD drive 355, and zip disk drive 360 for reading and/or writing information from or to floppy disk, CD, or zip disk respectively. Additional components such as DVD drives, etc., may also be included.

The computer system is typically connected to one or more network lines or connections 370, which can be part of an Ethernet link to other local computer systems, remote computer systems, or wide area communication networks, such as the Internet. This network link allows computer system 300 to share data and processing tasks with other computer systems and to communicate with remotely located users. The computer system may also include components such as a display screen, printer, etc., for presenting information, e.g., for displaying graphical representations of gene networks.

A variety of software components, which are typically stored on mass storage 330, will generally be loaded into memory during operation of the inventive system. These components function in concert to implement the methods described herein. The software components include operating system 400, which manages the operation of computer system 300 and its network connections. This operating system can be, e.g., a Microsoft Windows™ operating system such as Windows 98, Windows 2000, or Windows NT, a Macintosh operating system, a Unix or Linux operating system, an OS/2 or MS/DOS operating system, etc.

Software component 410 is intended to embody various languages and functions present on the system to enable execution of application programs that implement the inventive methods. Such components, include, for example, language-specific compilers, interpreters, and the like. Any of a wide variety of programming languages may be used to code the methods of the invention. Such languages include, but are not limited to, C (see, for example, Press et al., 1993, Numerical Recipes in C: The Art of Scientific Computing, Cambridge Univ. Press, Cambridge, or the Web site having URL www.nr.com for implementations of various matrix operations in C), C++, Fortran, JAVA™, various languages suitable for development of rule-based expert systems such as are well known in the field of artificial intelligence, etc. According to certain embodiments of the invention the software components include Web browser 420, e.g., Internet Explorer™ or Netscape Navigator™ for interacting with the World Wide Web.

Software component 430 represents the methods of the present invention as embodied in a programming language of choice. In particular, software component 430 includes code to accept a set of activity measurements and code to estimate parameters of an approximation to a set of differential equations or difference equations representing a biological network. Included within the latter is code to implement one or more fitness functions, code to implement one, or more search procedures, and code to apply the search procedures. Code to calculate variances and other statistical metrics, as described above, may also be included. Additional software components 440 to display the network model may also be included. According to certain embodiments of the invention a user is allowed to select various among different options for fitness function, search strategy, statistical measures and significance etc. The user may also select various criteria and threshold values for use in identifying major regulators of particular species and/or of the network as a whole. The invention may also include one or more databases 450, that contains sets of parameters for a plurality of different models, sets of targets for different compounds, sets of phenotypic mediators, etc., statistical package 460, and other software components 470 such as sequence analysis software, etc.

Thus the invention provides a computer system for constructing a model of a biological network, the computer system comprising: (i) memory that stores a program comprising computer-executable process steps; and (ii) a processor which executes the process steps so as to construct a model of a biological network, the model comprising an approximation to a set of differential equations or a set of difference equations that represent evolution over time of activities of at least one biochemical species in a biological network. According to certain embodiments of the invention the process steps estimate parameters of and select a structure for a model of a biological network. The process steps may perform any of the inventive methods described herein. According to certain aspects of the invention rather than constructing the model, the computer system receives an externally supplied model of a biological network and applies the model to biological data (e.g., activity data), which may be entered by a user. The computer system may use the model and data to, for example, perform sensitivity analysis, identify targets of a perturbation, identify phenotypic mediators, etc. Thus certain aspects of the invention do not require that the computer system and/or the computer-executable process steps are actually equipped to construct the model.

The invention further provides computer-executable process steps stored on a computer-readable medium, the computer-executable process steps comprising code to construct a model of a biological network, the model comprising an approximation to a set of differential equations or a set of difference equations that represent evolution over time of activities of at least one biochemical species in a biological network. According to certain embodiments of the invention the computer-executable process steps comprise code to estimate parameters of and select a structure for a model of a biological network. The code may implement any of the inventive methods described herein. The model may displayed or presented to the user in any of a variety of ways. For example, the parameters may be displayed in tables, as matrices, as weights on a graphical representation of the network, etc. Major regulators, targets, etc., identified by the inventive methods may be listed.

Example 7 presents an implementation of the inventive method using the programming language Matlab®. The variable “store” represents the matrix of measured activity values for a given perturbation. The variable out.a=theta_gene_eps represents the matrix \tilde{W}. The variable out.theta_gene_eps represents the variances on the elements of \tilde{W}. The variable out.d represents the chi-squared statistic for the goodness of fit.

The foregoing description is to be understood as being representative only and is not intended to be limiting. Alternative systems and techniques for implementing the methods of the invention will be apparent to one of skill in the art and are intended to be included within the accompanying claims. In particular, the accompanying claims are intended to include alternative program structures for implementing the methods of this invention that will be readily apparent to one of skill in the art.

### EXEMPLIFICATION

### Example 1

### Constructing a Model of a Nine Gene Biological Network Using Nine Perturbations

Materials and Methods

Plasmids, strains, growth conditions, and chemicals. The pBADX53 expression plasmid was constructed by making the following modifications to the pBAD30 plasmid obtained from American Type Culture Collection (ATCC): (i) the origin of replication was replaced with the low-copy SC101 origin of replication; (ii) the araC gene was removed, leaving the araC promoter intact; (iii) the ribosome binding site from the P_{bad} promoter in the pBAD18s (ATCC) plasmid was inserted for use with the luciferase gene in control cells; and (iv) an n-myc DNA fragment was inserted upstream of the rrn T1/T2 transcription terminators to provide an alternative unique priming site for real-time PCR. Plasmids were constructed using basic molecular cloning techniques described in standard cloning manuals (1, 2). Copies of all transcripts in the SOS test network were obtained by PCR amplification of cDNA using PfuTurbo. cDNA was prepared from total RNA as described below. PCR primers included overhanging ends containing the appropriate restriction sites for cloning into the pBADX53 plasmid. Endogenous ribosome binding sites were included in the cDNA fragments for all SOS test network genes that were cloned into the pBADX53 plasmid. Sequences of the cloned SOS test network genes and their ribosome binding sites were verified using an Applied Biosystems Prism 377 Sequencer. All cloning was performed by TSS transformation (F. M. Ausubel, Current Protocols in Molecular Biology (Wiley, New York, 1987).

The host cell for all cloning and experiments was wild-type E. coli strain MG1655. All cells were grown in LB medium with 50 μg/ml ampicillin at 37±0.5° C. 0.5 μg/ml Mitomycin C and L-arabinose at 37±0.5° C. were added as indicated herein.

Antibiotics, media and chemicals were obtained from Sigma-Aldrich or Fisher Scientific, unless otherwise indicated. PfuTurbo polymerase was purchased from Stratagene. All other enzymes were purchased from New England Biolabs, unless otherwise indicated. All synthetic oligonucleotides were purchased from Integrated DNA Technologies.

RNA extraction and reverse transcription. Eight replicate E. coli cultures containing the pBADX53/luciferase vector (control group) and eight replicate cultures containing the pBADX53/perturbed-gene vector (perturbed group) were grown to a density of ˜5×10⁸ cells/mL as measured by absorbance at 600 nm in a Tecan SPECTRAFluor Plus plate reader (Tecan, Research Triangle Park, N.C.). 0.5 mL samples of each replicate culture were stabilized in 1 mL of RNAprotect Bacterial Reagent (Qiagen, Valencia, Calif.). Approximately 25 μg total RNA was extracted with Qiagen RNeasy Mini spin columns using Lysozyme for bacterial cell wall disruption. Total RNA was treated with RNase-free DNase (Ambion, Austin, Tex.), and its integrity was routinely verified using ethidium bromide-stained agarose gel electrophoresis. For each replicate, reverse transcription of 1 μg total RNA was performed with 1.25 units/mL MultiScribe Reverse Transcriptase (Applied Biosystems, Foster City, Calif.) using 2.5 mM random hexamers in a total volume of 50 μL, according to the manufacturer's instructions. Reactions were incubated 10 minutes at 25° C. for hexamer annealing, 30 minutes at 48° C. for reverse transcriptase elongation, and 5 minutes at 95° C. for enzyme inactivation.

Real-time quantitative PCR. Quantitative PCR primers for each transcript in the SOS test network and the normalization transcripts, gapa and rrsB, were designed using Primer Express Software v2.0 (Applied Biosystems, Foster City, Calif.), according to the recommendations of the manufacturer for SYBR Green detection. Primers were selected such that all amplicons were 100-107 bp, calculated primer annealing temperatures were 60° C., and probabilities of primer-dimer/hairpin formations were minimized. DNA sequences for primer selection were obtained from the EcoGene database (Available at Web site having URL bmb.med.miami.edu/EcoGene/EcoWeb/). PCR reactions were prepared using 1.4 μL cDNA (corresponding to 30 ng of total RNA) in a total volume of 10 μL containing 10 nM of forward and 10 nM of reverse primers and 5 μL 2×SYBR Green Master Mix (Applied Biosystems, Foster City, Calif.). Duplicate PCR reactions were performed for each of the replicate samples. Reactions were carried out on 384-well optical microplates (Applied Biosystems) using an ABI Prism 7900 for real-time amplification and SYBR Green I detection. PCR parameters were: denaturation (95° C. for 10 minutes), 40 cycles of two-segment amplification (95° C. for 15 seconds, 60° C. for 60 seconds). The thermal cycling program was concluded with a dissociation curve (60° C. ramped to 95° C., 15 seconds at each 1° C. interval) to detect non-specific amplification or primer-dimer formation; specificity was confirmed during optimization reactions by agarose gel electrophoresis/ethidium bromide staining. All RNA extractions were checked for genomic DNA contamination by using 1 μg total RNA in PCR reactions containing primers specific for the gapa and rrsB (16S)RNA amplicons. No-template control reactions for every primer pair were also included on each reaction plate to check for external DNA contamination.

Quantitative PCR data analysis. Cₜ (crossing-point threshold) and real-time fluorescence data were obtained using the ABI Prism Sequence Detection Software v2.0. Default software parameters were used except for adjustments made to the pre-exponential phase baseline used to calculate Cₜ for the higher abundance RNAs.

The PCR reaction efficiency of each amplicon in each reaction was calculated from the real time fluorescence data by fitting the equation F=Eₙ to the three data points closest to Cₜ, where F is the normalized fluorescence, E is the reaction efficiency, and n is the PCR cycle number. Aberrant and inefficient reactions were removed from the data set by eliminating reactions with E or Cₜ values outside of their joint 95% confidence interval. The values of E remaining from all 32 reactions performed for each amplicon in each perturbation experiment (2 reactions/sample×8 samples/group×2 groups) were averaged. The values of Cₜ remaining from all 16 reactions performed for each amplicon in each experimental group in each perturbation experiment were averaged.
For each gene, i, the RNA expression ratio between the perturbed and control groups of cells were calculated from:

$$\frac{{[ {RNA}_{i} ]}^{pert}}{{[ {RNA}_{i} ]}^{cont}} = \frac{{\hat{E}}_{i}^{{\hat{C}}_{lu} - {\hat{C}}_{lp}}}{{\hat{E}}_{r}^{{\hat{C}}_{ru} - {\hat{C}}_{rp}}}$$

Êᵢ is the mean PCR efficiency for gene i,
Êᵣ is the mean PCR efficiency for the gapA or rrsB normalization gene,
iₚ is the mean Cₜ for gene i in the perturbed cell group,
iᵤ is the mean Cₜ for gene i in the control (unperturbed) cell group,
rₚ is the mean Cₜ for the normalization gene in the perturbed cell group, and
rᵤ is the mean Cₜ for the normalization gene in the control (unperturbed) cell group.

RNA expression changes were calculated as:

$${x}_{l} = \frac{{[ {RNA}_{i} ]}^{pert}}{{[ {RNA}_{i} ]}^{cont}} - 1 ,$$

and were provided to the computer-based implementation of the method for construction of the network model and prediction of compound bioactivity targets. The standard errors, Sₓᵢ, on the expression changes, xi, were calculated from the standard errors on Êᵢ, Êᵣ, ᵢₚ, ᵢₜ, ᵢᵤ, and ᵣᵤ using the propagation of error formula:

$${S}_{{x}_{i}} = \sqrt{{( \frac{\partial {x}_{i}}{\partial {\hat{E}}_{i}} {S}_{{\hat{E}}_{i}} )}^{2} + … + {( \frac{\partial {x}_{i}}{\partial {\hat{C}}_{ru}} {S}_{{\hat{C}}_{ru}} )}^{2}}$$

Numerics. All computations and data analysis were performed using Matlab (Mathworks, Waltham, Mass.) unless otherwise specified. Example 7 presents the Matlab implementation.

Construction of the network model. Response data was obtained by applying a set of nine transcriptional perturbations to cells. Perturbations were applied by overexpressing a different one of the genes in individual cultures of cells using an episomal expression plasmid and measuring the change in expression level of all nine species as described above. In the baseline condition, cells containing the pBADX53 plasmid were maintained in exponential growth in LB medium with 0.5 μg/mlMMC and 50 μg/ml Ampicillin (to maintain plasmid survival). MMC is a highly specific DNA-damaging agent and was applied to ensure moderate activation of the SOS response. One group of cells (the perturbed group) was grown in the baseline condition with the pBADX53 plasmid coupled to one of the test network genes. A second group of cells (the control group) was grown in the baseline condition with the pBADX53 plasmid coupled to the luciferase reporter gene. Transcriptional perturbations were then induced by adding an amount of arabinose sufficient to induce expression of the perturbed gene at levels typically 100-500% in excess of endogenous expression levels. Although arabinose was added to both the perturbed and control cell groups, the luciferase gene does not interact with the SOS pathway. Thus, luciferase RNA was used to estimate the level of overexpression of the perturbed gene. RNA expression ratios ([RNA] perturbed/[RNA] control) were assayed using real-time PCR and the gapA or 16s gene as a normalization reference. Note that our use of luciferase mRNA to estimate the magnitude of the perturbations in our experiments is prone to systematic error. This can lead to error in our identification of self-interactions in the model. Therefore, when we used the model to identify perturbed genes, we excluded the self-interaction weights by setting the diagonal elements of \tilde{W}=−1 (i.e., no self-interaction). As a result, the perturbations we recovered are equivalent to the net effect of the drug and the self-interaction (if one exists) on the expression of the targeted transcript.

A linear Taylor polynomial approximation to a set of nonlinear ordinary differential equations was generated as described above. The parameters were calculated using the mTSE fitness function using multiple linear regression. An exhaustive search procedure, performed with the constraints n=3, 4, 5, or 6, where n represents the number of regulatory inputs to each gene was used to identify the network structure and parameters that optimized (in this case, minimized) the fitness function. The data was processed using the Matlab program listed in Example 7, to generate a matrix of parameters, \tilde{W}, representing the model. This matrix was inverted to arrive at the gain matrix, G, from which major regulators of the network were identified.

Results

Experimental design. To test our method for constructing models of biological networks, we applied it to a nine-transcript subnetwork of the SOS pathway in E. coli (the “test network”). The SOS pathway, which regulates cell survival and repair following DNA damage, involves the lexA and recA genes, more than 30 genes directly regulated by lexA and recA, and tens or possibly hundreds of indirectly regulated genes (23-27). We chose the nine transcripts in our test network to include the principal mediators of the SOS response (lexA and recA), four other core SOS response genes (ssb, recF, dinI, umuDC) and three genes potentially implicated in the SOS response (rpoD, rpoH, rpoS).

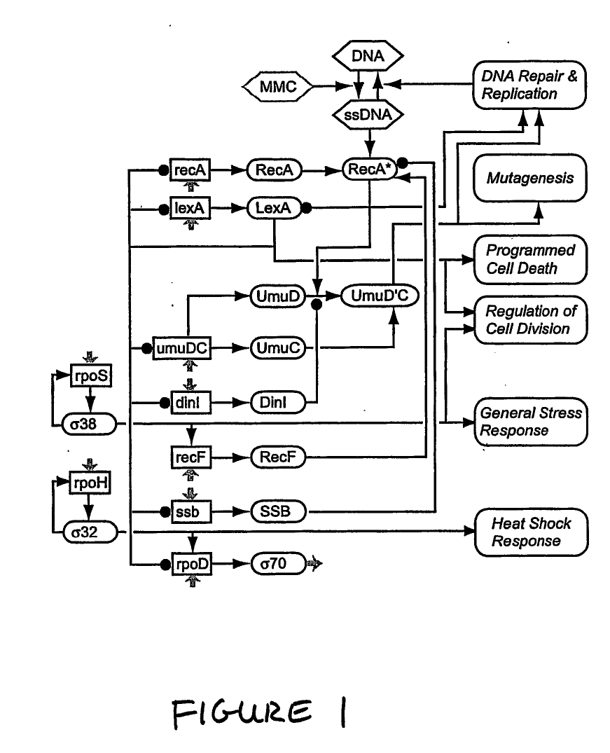

FIG. 1 presents a diagram of interactions in the SOS network. DNA lesions caused by Mitomycin C (hexagon labeled MMC) are converted to single-stranded DNA during chromosomal replication (24,33). Upon binding to ssDNA, the RecA protein is activated (RecA*) and serves as a co-protease for the LexA protein. The LexA protein is cleaved, thereby diminishing the repression of genes that mediate multiple protective responses. Boxes denote genes, ellipses denote proteins, hexagons indicate other components of or input to the biological system, arrows denote positive regulation (lightly shaded arrows represent positive regulatory inputs from the rpoD gene—connecting lines are omitted for the sake of clarity), filled circles denote negative regulation. Thick lines denote the primary pathway by which the network is activated following DNA damage.

Because much of the regulatory structure of our test-network has been previously mapped, it serves as a suitable subject for the validation of our method. In addition, it serves as an entry point for further study of the SOS pathway. The SOS pathway has been shown to regulate genes associated with important protective pathways, including heat shock response, general stress response (osmotic, pH, nutritional, oxidative), mutagenesis, cell division and programmed cell death (25, 28-30). Moreover, key features and genes in the SOS pathway are conserved in multiple bacterial species and animal cells. Thus, a deeper understanding of the SOS pathway may provide insight into regulatory mechanisms of bacterial homeostasis, general insight into the mechanisms of cross-talk and signal isolation in regulatory networks, and may serve as a productive target for the development of novel anti-infective compounds with greater lethality and lower rate of resistance.

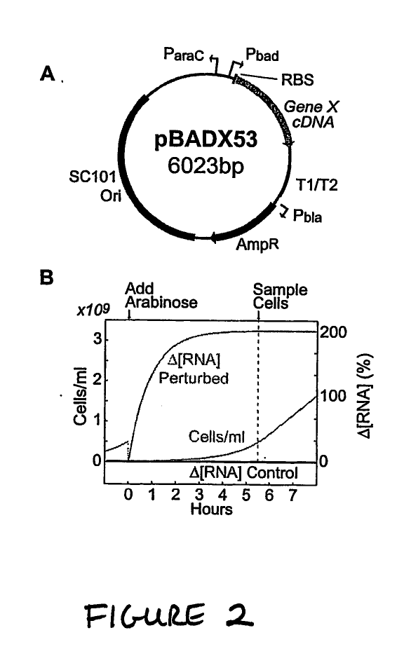

We applied a set of nine transcriptional perturbations to the test network in E. coli cells. In each perturbation, we overexpressed a different one of the nine genes in the test network using an episomal expression plasmid. The expression plasmid (pBADX53) contained the arabinose-regulated Pbad promoter coupled to a cDNA encoding the gene to be perturbed (FIG. 2A). We grew the cells under constant physiological conditions to their steady state (approximately 5.5 hours following addition of arabinose). FIG. 2B illustrates the induction of RNA synthesis following addition of arabinose to a culture, and the achievement of steady state after several hours. For all nine transcripts, we used quantitative real-time PCR (qPCR) to measure the change in expression relative to unperturbed cells. For each transcript, two qPCR reactions from each of eight replicate cultures were obtained, qPCR data were filtered to eliminate outliers (aberrant or inefficient reactions), and the mean expression change was computed. Only those mean transcript changes that were greater than their standard error were accepted as significant and used for further analysis (i.e., xᵢ=0 if |xᵢ| Sₓᵢ, where xᵢ is the mean expression change and Sₓᵢ is the standard error for transcript i).

Network model recovery. We processed the nine-perturbation expression data (the training set) using the methods described above to obtain a model, W, of the regulatory interactions in the test network. The model is presented in matrix format in Table 2.

TABLE 2

| | recA | lexA | ssb | recF | dinI | umuDC | rpoD | rpoH | rpoS |
|---|---|---|---|---|---|---|---|---|---|
| recA | −0.597 | −0.179 | −0.010 | 0 | 0.096 | 0 | −0.011 | 0 | 0 |
| lexA | 0.387 | −1.670 | −0.014 | 0 | 0.087 | −0.068 | 0 | 0 | 0 |
| ssb | 0.044 | −0.189 | −1.275 | 0 | 0.053 | 0 | 0.027 | 0 | 0 |
| recF^{†} | −0.1808 | 0.2377 | −0.0251 | −1 | −0.0554 | 0 | 0 | 0 | 0.39 |
| dinI | 0.281 | 0 | 0 | 0 | −2.094 | 0.156 | −0.037 | 0.012 | 0 |
| umuDC | 0.112 | −0.403 | −0.016 | 0 | 0.205 | −1.147 | 0 | 0 | 0 |
| rpoD | −0.171 | 0 | −0.017 | 0 | 0.025 | 0 | −1.513 | 0.021 | 0 |
| rpoH | 0.096 | 0 | 0.001 | 0 | −0.009 | −0.031 | 0 | −0.483 | 0 |
| rpoS | 0.217 | 0 | 0 | −1.678 | 0.672 | 0 | 0.077 | 0 | −3.921 |

Each row in the matrix shows the influence of the genes listed in the columns on the gene in the row. The values on the diagonal represent self-feedback. A positive self-feedback is any value greater than −1; a negative feedback is any value less than −1. † indicates statistically non-significant fit for the row. Table 3 presents the standard errors on the parameters of the recovered model. † indicates statistically non-significant fit for the row.

TABLE 3

| | recA | lexA | ssb | recF | dinI | umuDC | rpoD | rpoH | rpoS |
|---|---|---|---|---|---|---|---|---|---|
| recA | 0.199 | 0.176 | 0.006 | 0 | 0.039 | 0 | 0.013 | 0 | 0 |
| lexA | 0.248 | 0.859 | 0.015 | 0 | 0.081 | 0.084 | 0 | 0 | 0 |
| ssb | 0.118 | 0.307 | 0.087 | 0 | 0.043 | 0 | 0.025 | 0 | 0 |
| recF^{†} | 0.189 | 0.352 | 0.011 | 0 | 0.072 | 0 | 0 | 0 | 0.236 |
| dinI | 0.243 | 0 | 0 | 0 | 0.583 | 0.113 | 0.046 | 0.011 | 0 |
| umuDC | 0.150 | 0.405 | 0.013 | 0 | 0.091 | 0.311 | 0 | 0 | 0 |
| rpoD | 0.122 | 0 | 0.013 | 0 | 0.066 | 0 | 0.336 | 0.011 | 0 |
| rpoH | 0.047 | 0 | 0.005 | 0 | 0.015 | 0.024 | 0 | 0.134 | 0 |
| rpoS | 0.470 | 0 | 0 | 1.765 | 0.355 | 0 | 0.112 | 0 | 1.794 |

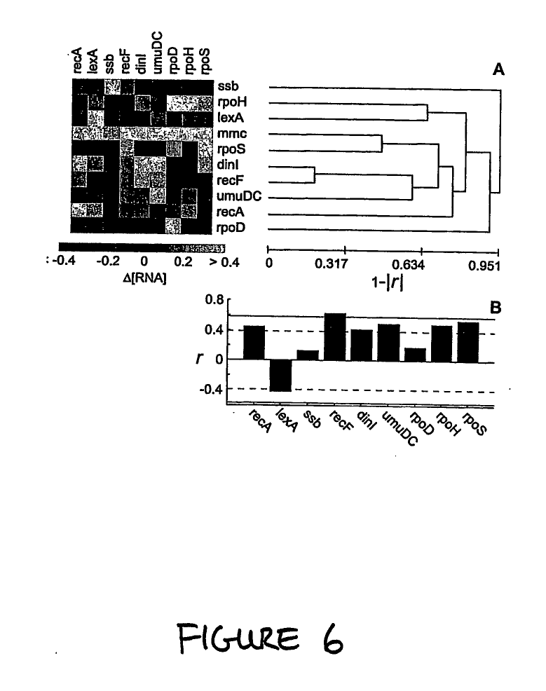

The maximum connectivity (n) chosen for the model can affect the goodness of fit of the model to the data, the number of regulatory interactions correctly recovered (coverage), and the number of false interactions recovered (false positives—see FIG. 6). Thus, the goodness of fit of the network model to the data was determined for n={3, 4, 5, 6}. Acceptable fits were obtained for n=4, n=5, and n=6. However, we did not obtain an acceptable fit for regulatory inputs to the recF gene for any value of n. This suggests that, under the growth conditions used in the experiments, recF is not significantly regulated by any of the genes included in the test network. n=5 was selected for further analysis as providing the best balance between coverage and false positives.

To evaluate the performance of the inventive methods, we determined the number of known connections in the test network correctly identified by the recovered model. Table 4 shows known regulatory interactions in the SOS test network. The regulatory interactions are derived from published literature, as explained in the main text. +, −, or 0 indicates a positive, negative, or no regulatory input from the gene in the column to the gene in the row.

TABLE 4

| | recA | lexA | ssb | recF | dinI | umuDC | rpoD | rpoH | rpoS |
|---|---|---|---|---|---|---|---|---|---|
| recA | + | − | − | + | + | − | + | 0 | 0 |
| lexA | + | − | − | + | + | − | + | 0 | 0 |
| ssb | + | − | − | + | + | − | + | 0 | 0 |
| recF | 0 | 0 | 0 | 0 | 0 | 0 | + | 0 | + |
| dinI | + | − | − | + | + | − | + | 0 | 0 |
| umuDC | + | − | − | + | + | − | + | 0 | 0 |
| rpoD | + | − | − | + | + | − | + | + | 0 |
| rpoH | 0 | 0 | 0 | 0 | 0 | 0 | + | + | 0 |
| rpoS | 0 | 0 | 0 | 0 | 0 | 0 | + | 0 | + |

A recovered connection was considered correct if there exists a known protein or metabolite pathway between the two 5 transcripts and the sign of the regulatory interaction is correct, as determined by the currently known network in FIG. 1. For example, the lexA transcript, through the LexA protein, represses transcription of the ssb gene. Thus, a negative regulatory connection between lexA and ssb in our recovered model was considered correct.

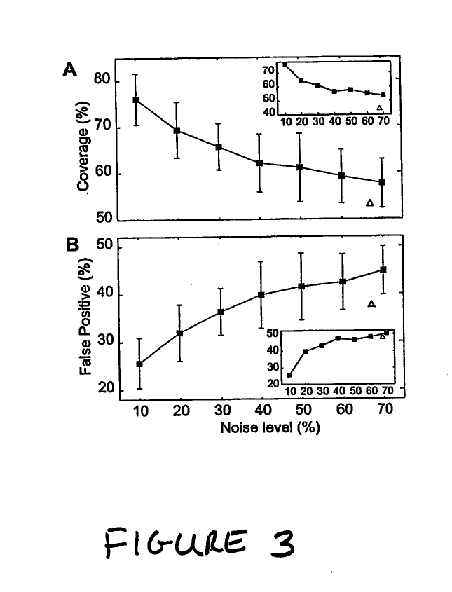

Detailed inspection of the recovered connections reveals that the algorithm correctly identifies the key regulatory connections in the network. For example, the model correctly shows that recA positively regulates lexA and its own transcription, while lexA negatively regulates recA and its own transcription. Overall, the performance (coverage and false positives) of the method is equivalent to that expected based on simulations of 50 random nine-gene networks (FIG. 3). Moreover, for the subnetwork of 6 genes typically considered part of the SOS network (recA, lexA, ssb, recF, dinI, and umuDC) the performance of the algorithm shows a significant increase. This suggests that some of the false positives identified for the three sigma factors in our model (rpoD, rpoH, rpoS), may be true connections mediated by genes not included in our test network. Furthermore, our simulation results (described below) suggest that even modest reduction in the measurement noise observed in our experiments (mean noise level=mean(Sₓᵢ)/mean(xi)=68%) could lead to dramatic improvements in coverage and errors in the network model (FIG. 3). Reductions in experimental noise could be achieved using improved RNA measurement technologies such as competitive PCR coupled with MALDI-TOF mass spectrometry (32) or DNA microarray technologies.

### Example 2

### Constructing and Testing a Model of a Nine Gene Biological Network Using Seven Perturbations

We also tested the performance of the inventive methods using an incomplete training set consisting of perturbations to only 7 of the 9 genes (i.e., data for perturbations to lexA and recA was not included). We recovered network models using all 36 combinations of 7 perturbations and found that the methods performed comparably to simulations, albeit with slightly reduced performance (in terms of the number of false positives at various noise levels) than the full nine-perturbation training set, as illustrated in the insets in FIG. 3. These results demonstrate the ability of the inventive methods to accurately construct models of biological networks without requiring perturbation of each biochemical species in the network.

### Example 3

### Performing Sensitivity Analysis Using the Model

We examined whether the first-order model recovered as described in Example 1 could be used to determine the sensitivity of the activities of one or more biological species in the network to changes in the activities of one or more species (i.e., to determine the sensitivity of species to other species). In particular, we sought to identify the major regulators of SOS response in the test network. We considered major regulators to be those transcripts that, when perturbed, cause largest relative changes in expression of the other genes in the network. In other words, the species (transcripts, and thus the corresponding genes) to which the activities of other species were most sensitive in response to a perturbation were considered to be major regulators. To this end, we examined the gain matrix, G=\tilde{W}⁻¹, as described above. Each column of the gain matrix describes the response of all transcripts in the network to a perturbation to one of the transcripts. The mean |Gⱼ| of all absolute responses to the perturbation of gene j was calculated for each of the genes j. (Self-feedback effects were not included in the calculation of the mean.). Those genes j for which the mean gain was greatest were considered to be major regulators, i.e., these are the genes to which the biological network displays the greatest overall sensitivity. It will be appreciated that this approach represents merely one of numerous methods for designating one or more species as major regulators. As shown in Table 5, the gain matrix correctly identifies recA (|Gⱼ|=14.2) and lexA (|Gⱼ|=6.49) as the major regulators in the network.

TABLE 5

| Gain Matrix (G) | recA | lexA | ssb | recF | dinI | umuDC | rpoD | rpoH | rpoS |
|---|---|---|---|---|---|---|---|---|---|
| recA | — | −17.49 | −1.08 | 0.00 | 6.75 | 1.95 | −1.39 | 0.10 | 0.00 |
| lexA | 38.01 | — | −0.89 | 0.00 | 3.8 | −2.82 | −0.39 | 0.07 | 0.00 |
| ssb | 0.43 | −9.11 | — | 0.00 | 1.72 | 0.77 | 1.37 | 0.10 | 0.00 |
| recF | 0.00 | 0.00 | 0.00 | — | 0.00 | 0.00 | 0.00 | 0.00 | 0.00 |
| dinI | 22.43 | −4.05 | −0.20 | 0.00 | — | 6.92 | −1.37 | 1.14 | 0.00 |
| umuDC | 6.23 | −22.19 | −0.94 | 0.00 | 8.11 | — | −0.26 | 0.19 | 0.00 |
| rpoD | −17.31 | 1.99 | −0.75 | 0.00 | 0.03 | −0.19 | — | 2.86 | 0.00 |
| rpoH | 31.02 | −2.00 | 0.01 | 0.00 | −0.06 | −5.50 | −0.23 | — | 0.00 |
| rpoS | 12.35 | −1.62 | −0.11 | −42.8 | 8.82 | 1.29 | 0.98 | 0.26 | — |
| Mean (\|Gⱼ\|) | 14.20 | 6.49 | 0.44 | 4.76 | 3.25 | 2.16 | 0.67 | 0.52 | 0.00 |

### Example 4

### Identifying Targets of a Pharmacological Agent Using a Biological Network Model

The network model obtained as described in Example 1 can also be used to identify the species (e.g., genes) that directly mediate the bioactivity of a pharmacological compound (i.e., the compound mode of action), even when the compound interacts with multiple genes simultaneously. This is accomplished by treating the cells with a compound and measuring the resulting RNA expression changes. The network model, \tilde{W}, can then be used to recover the minimal subset of transcriptional changes that mediate the observed expression pattern. This retrieved subset of genes represents the most direct transcriptional targets of the compound (possibly through protein or metabolite intermediates).

As described above, to identify the targets of a pharmacological perturbation, it was treated as an unknown transcriptional perturbation, uₚ, that produces the measured RNA expression changes, xₚ. Therefore, uₚ was calculated as uₚ=−\tilde{W}xₚ, where \tilde{W} is the matrix representing the network model. Calculation of the statistical significance of up was performed as described above. This approach was applied to RNA expression changes that result from the simultaneous controlled perturbation of the lexA and reca genes.

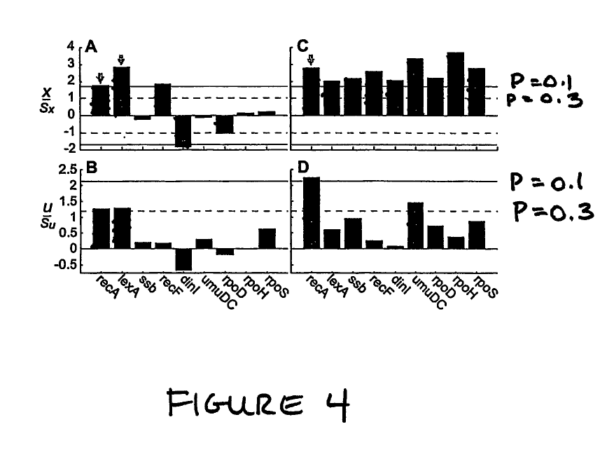

FIG. 4A shows the mean relative expression changes (x), normalized by their standard deviations (Sx), for the double perturbation. Arrows indicate the genes targeted by the perturbation. The network model recovered using the nine-perturbation training set was applied to the expression data in A (31, 34). The predicted perturbations to each gene ( )), normalized by their standard deviations (S), are illustrated for the double perturbation in FIG. 4B. Hatched bars indicate statistically significant, and solid bars indicate statistically non-significant. Horizontal lines denote significance levels: P=0.3 (dashed), P=0.1 (solid).

Although five of the nine genes in the network responded with statistically significant transcriptional changes application of our network model correctly identified only lexA and recA as the perturbed genes (2/2=100% coverage, 7/7=100% specificity, as shown in FIG. 4B. Thus the network model is able to precisely distinguish direct from indirect transcriptional responses to a perturbation.

We next applied a Mitomycin C (MMC) perturbation to determine if our scheme could identify the transcriptional mediators of MMC bioactivity in the SOS network. Perturbed cells were 7 grown in 0.75 μg/ml MMC and transcriptional changes were measured relative to control cells grown in the normal baseline condition (0.5 μg/mlMMC). FIG. 4C shows the mean relative expression changes (x), normalized by their standard deviations (Sx), for the MMC perturbation. Arrows indicate the genes targeted by the perturbation. The network model recovered using the nine-perturbation training set was applied to the expression data in C (31, 34). The predicted perturbations to each gene ( ), normalized by their standard deviations (S), are illustrated for the MMC perturbation in FIG. 4D. Hatched bars indicate statistically significant, and solid bars indicate statistically non-significant. Horizontal lines denote significance levels: P=0.3 (dashed), P=0.1 (solid).

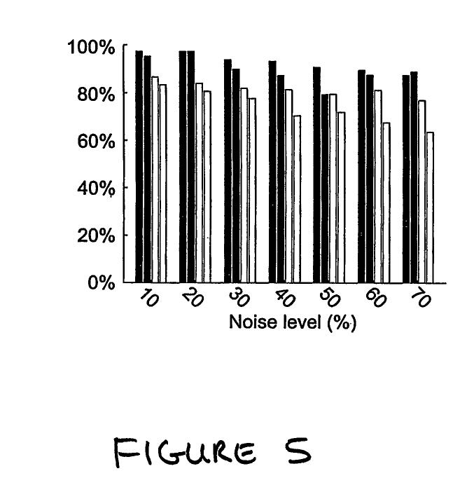

As shown in FIG. 4C, all genes in the test network showed statistically significant upregulation in response to MMC. When we applied the network model to the expression data, we correctly identified recA as the transcriptional mediator of MMC bioactivity, with only one false positive, umuDC (1/1=100% coverage, 7/8=88% specificity. Thus as shown in FIG. 4D, only the predicted perturbations to recA and umuDC achieved statistical significance. Moreover, recA is identified at a substantially higher significance level (P 0.09) than umuDC (P 0.22), suggesting it is the more likely, if not the only, true target. Our experimental results are confirmed by simulation results which show that the network model can identify perturbed genes with high coverage and specificity even at high levels of measurement noise (FIG. 5).

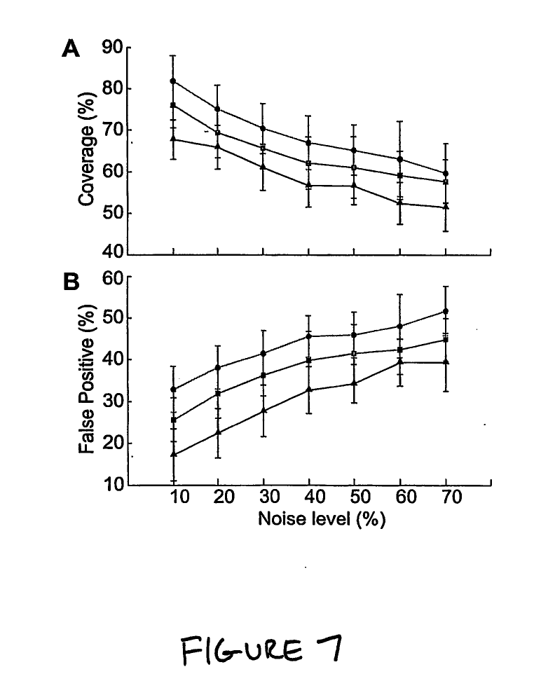

We also tested the predictive power of a network model in a “worst case scenario” in which the model is recovered using a seven-perturbation training set that excludes the lexA and recA training perturbations. This reduced model performs nearly as well as the model recovered using a full training set. FIG. 7 shows the mean relative expression changes (x) normalized by their standard errors (Sx) for the double perturbation (7A) and the MMC perturbation (7C). Arrows indicate the genes targeted by the perturbation. The network model recovered using the seven-perturbation training set was applied to the expression data in A and C (16). The predicted perturbations to each gene ( ), normalized by their standard deviations (S), are illustrated for the double perturbation (7B) and the MMC perturbation (7D). In all panels, hatched bars indicate statistically significant, solid bars indicate statistically non-significant. Horizontal lines denote significance levels: P=0.3 dashed, P=0.1 solid.

For the MMC perturbation, the model again identifies recA as a target, and it also identifies two false targets, umuDC and lexA (1/1=100% coverage, 6/8=75% specificity). For the lexA/recA double perturbation, it identifies lexA but not recA as a target with no false positives (1/2=50% coverage, 7/7=100% specificity). These results agree with simulations showing that the reduced model retains high coverage and specificity in predicting perturbation targets, albeit slightly reduced from that of the full model (FIG. 5).

Table 6 shows the relative RNA expression changes xi=[RNAi]ₚₑᵣₜ[RNAi]_{cont}−1, for the SOS test network genes in all perturbation experiments. Table 7 shows the standard errors on the expression data.

TABLE 6

| | Training | | | | | | | | | Test | |
|---|---|---|---|---|---|---|---|---|---|---|---|
| | Perturbations | | | | | | | | | Perturbations | |
| Genes | recA | lexA | ssb | recF | dinI | umuDC | rpoD | rpoH | rpoS | double | MMC |
| recA | 0.906 | −0.132 | −0.139 | 0.187 | 0.291 | −0.061 | −0.077 | −0.017 | −0.025 | 0.313 | 0.496 |
| lexA | 0.212 | 0.383 | −0.117 | 0.064 | 0.169 | −0.087 | 0.039 | 0.125 | 0.084 | 0.688 | 0.321 |
| ssb | 0.018 | −0.107 | 10.524 | 0.061 | 0.080 | 0.013 | 0.064 | 0.089 | −0.070 | −0.028 | 0.251 |
| recF | 0.104 | −0.050 | −0.273 | 0.139 | 0.180 | 0.146 | 0.069 | −0.004 | 0.275 | 0.441 | 0.523 |
| dinI | 0.119 | −0.097 | 0.056 | 0.315 | 2.147 | 0.142 | −0.068 | 0.135 | 0.113 | −0.240 | 0.334 |
| umuDC | 0.076 | −0.189 | −0.124 | 0.250 | 0.347 | 2.017 | −0.067 | −0.172 | −0.022 | −0.022 | 0.834 |
| rpoD | −0.122 | −0.047 | −0.102 | −0.107 | −0.011 | 0.104 | 3.068 | 0.365 | 0.217 | −0.139 | 0.327 |
| rpoH | 0.178 | −0.183 | 0.036 | −0.070 | −0.034 | −0.155 | 0.008 | 26.633 | 0.087 | 0.026 | 0.786 |
| rpoS | 0.072 | −0.128 | 0.073 | 0.081 | 0.305 | 0.051 | −0.061 | 0.274 | 0.672 | 0.035 | 0.672 |

TABLE 7

| | Training | | | | | | | | | Test | |
|---|---|---|---|---|---|---|---|---|---|---|---|
| | Perturbations | | | | | | | | | Perturbations | |
| Genes | recA | lexA | ssb | recF | dinI | umuDC | rpoD | rpoH | rpoS | double | MMC |
| recA | 0.128 | 0.107 | 0.080 | 0.112 | 0.057 | 0.077 | 0.057 | 0.104 | 0.098 | 0.174 | 0.177 |
| lexA | 0.092 | 0.180 | 0.075 | 0.088 | 0.067 | 0.078 | 0.058 | 0.120 | 0.109 | 0.240 | 0.158 |
| ssb | 0.071 | 0.102 | 0.677 | 0.089 | 0.060 | 0.104 | 0.057 | 0.095 | 0.076 | 0.118 | 0.115 |
| recF | 0.095 | 0.117 | 0.097 | 0.103 | 0.069 | 0.100 | 0.070 | 0.101 | 0.136 | 0.235 | 0.201 |
| dinI | 0.096 | 0.111 | 0.101 | 0.120 | 0.187 | 0.096 | 0.064 | 0.126 | 0.118 | 0.130 | 0.161 |
| umuDC | 0.095 | 0.113 | 0.094 | 0.116 | 0.102 | 0.271 | 0.064 | 0.078 | 0.096 | 0.162 | 0.248 |
| rpoD | 0.062 | 0.124 | 0.082 | 0.136 | 0.089 | 0.123 | 0.259 | 0.164 | 0.184 | 0.131 | 0.148 |
| rpoH | 0.063 | 0.104 | 0.103 | 0.086 | 0.055 | 0.091 | 0.059 | 3.607 | 0.120 | 0.183 | 0.212 |
| rpoS | 0.082 | 0.108 | 0.131 | 0.118 | 0.096 | 0.090 | 0.063 | 0.198 | 0.256 | 0.150 | 0.240 |

### Example 5

### Comparison of Predictive Power of Model with Alternative Approaches

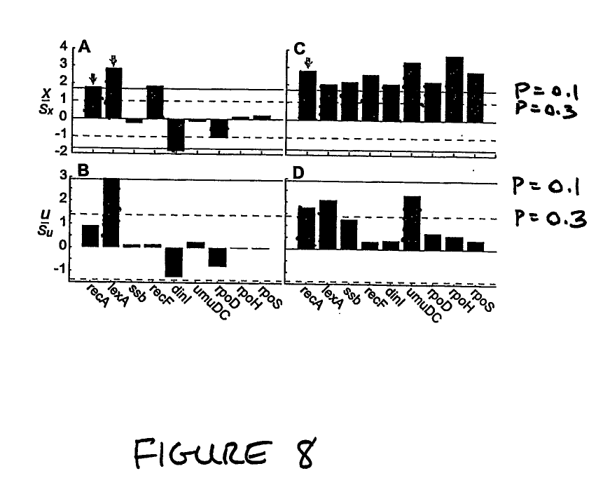

A large compendium of transcriptional responses to genetic perturbations, combined with pairwise clustering, has been used to identify mediators of bioactivity for unknown pharmacological compounds (15). Although this method is successful under certain conditions, it may not perform adequately if a compound's bioactivity is mediated by multiple interacting genes or pathways, or if a perturbation to the targeted gene or pathway is not represented in the compendium. Moreover, it often cannot differentiate between genes that are highly interconnected in a pathway. As shown in FIG. 8, unlike the inventive methods described above, neither pairwise hierarchical clustering nor pairwise correlation can unambiguously identify the mediators of MMC activity in the test network.

FIG. 8 illustrates performance of clustering and correlation for identifying perturbed genes. (A) Expression profiles for the MMC perturbation and all perturbations in the training set are compared using average-linkage clustering with the absolute linear uncentered correlation metric (i.e., 1−|r| where r is the uncentered correlation coefficient) (35). The MMC perturbation profile is incorrectly clustered with the rpoS perturbation profile. (B) Pair-wise correlation of the MMC perturbation profile with each perturbation in the training set. All but two perturbations show statistically significant correlation with the MMC perturbation. Hatched bars indicate statistically significant; solid bars indicate statistically non-significant. Horizontal lines (other than at 0) denote significance levels: P=0.3 (dashed), P=0.1 (solid).

Clustering was performed using the European Bioinformatics Institute EPCLUST tool available at http://www.ebi.ac.uk/microarray/ExpressionProfiler/ep.html.36.

### Example 6

### Testing Network Models Using Simulated Biological Networks

The inventive methods were further tested using computer simulations of networks. Perturbations of magnitude ui=1 (arbitrary units) were applied to fifty randomly connected networks of nine genes with an average of five regulatory inputs per gene. For each perturbation to each random network, the mRNA concentrations at steady state were calculated, and normally-distributed, uncorrelated noise was added both to the mRNA concentrations and to the perturbations to represent measurement error. The noise (noise=Sₓ/μₓ, where Sₓ is the standard deviation of the mean of x, μₓ) on the perturbations was set to 20% (equivalent to that observed on perturbations in our experiments). The noise on the mRNA concentrations was varied from 10% to 70%. FIG. 3 illustrates model recovery performance for simulations and experiment. Coverage (correct connections in the recovered network model/total connections in the true network) and false positives (incorrect connections in the recovered model/total number of recovered connections) were calculated for models recovered using a nine-perturbation training set (main figures) and a seven-perturbation training set (insets). Error bars are not included in the inset for clarity. Experiment (open triangles): A model of the test network was recovered setting n=5. Coverage and false positives for the recovered model were calculated by comparison to the known network (Table 4 and FIG. 1). The mean noise observed on the mRNA measurements in our experiments was 68%. Weights for recF were not included in the calculations because an acceptable fit for recF was not obtained.

### Example 6

### Comparison of Predictive Power of Model with Alternative Approaches

A large compendium of transcriptional responses to genetic perturbations, combined with pairwise clustering, has been used to identify mediators of bioactivity for unknown pharmacological compounds (15). Although this method is successful under certain conditions, it may not perform adequately if a compound's bioactivity is mediated by multiple interacting genes or pathways, or if a perturbation to the targeted gene or pathway is not represented in the compendium. Moreover, it often cannot differentiate between genes that are highly interconnected in a pathway. As shown in FIG. 8, unlike the inventive methods described above, neither pairwise hierarchical clustering nor pairwise correlation can unambiguously identify the mediators of MMC activity in the test network.

FIG. 8 illustrates performance of clustering and correlation for identifying perturbed genes. (A) Expression profiles for the MMC perturbation and all perturbations in the training set are compared using average-linkage clustering with the absolute linear uncentered correlation metric (i.e., 1−|r| where r is the uncentered correlation coefficient) (35). The MMC perturbation profile is incorrectly clustered with the rpoS perturbation profile. (B) Pair-wise correlation of the MMC perturbation profile with each perturbation in the training set. All but two perturbations show statistically significant correlation with the MMC perturbation. Hatched bars indicate statistically significant; solid bars indicate statistically non-significant. Horizontal lines (other than at 0) denote significance levels: P=0.3 (dashed), P=0.1 (solid).

Clustering was performed using the European Bioinformatics Institute EPCLUST tool available at http://www.ebi.ac.uk/microarray/ExpressionProfiler/ep.html.36.

### Example 7

### Software Implementation of Methods to Generate Models of Biological Networks

The following Matlab code implements one embodiment of the method for generating a model of a biological network, used to generate the models of biological networks presented in Examples 1 through 6. The model employs a linear Taylor approximation to a set of nonlinear, ordinary differential equations, and the program uses the mTSE fitness function. The search strategy is an exhaustive search.

```
    function
out=netgene_final_reg_wt(P,store,k_input,N_genes,norm,cost,err,gene_err);
    % store contains the experiments in the columns
    % err VARIANCE of perturbations
    % gene_err STDDEV of genes with each COLUMN A GENE
    %normalisation of the data
    [numgene,numexps]=size(store);
    bkp_y=store;
    bkp_P=P;
    fake=[ ];
    T=ones(numgene,numgene);
    if (norm==1)
      for ll=1:numexps
        fake(:,ll)=(store(:,ll))./abs(P(ll,ll));
        P(ll,ll)=−1;
      end
      store=fake;
    end
    % data normalised
    index=nchoosek([1:N_genes],k_input);
    [nr,nc]=size(index);
    map_exps=[1:N_genes];
    theta_gene_eps=zeros(N_genes,N_genes);
    param_var=zeros(N_genes,1);
    y=store;
    U=P’;
    delta=0.1;
    for n=1:N_genes
      for j=1:nr
        % Try solution out with perturbations in U and data in y(t,genes)
        [nr_y,nc_y]=size(y);
        cond_list(j)=cond(y(index(j,:),:)*(y(index(j,:),:))’);
        Q=eye(numexps,numexps);
        if (cond((y(index(j,:),:))*(y(index(j,:),:))’)<=1000 &
isempty(find(index(j,:)==n))==0)
    %  Q(4,4)=.01;
    %  Q(2,2)=100;
    %  Q(3,3)=100;
    %  Q(5,5)=100;
        X=y(index(j,:),:)’;
        b=P(n,:)’;
        theta_final(j,:)=(inv(X’*Q*X+delta*eye(size(X’*X)))*X’*Q*b)’;
        eps_final_a(j)=sum(([P(n,:)]−theta_final(j,:)*y(index(j,:),:)).\hat{ }2);
        coeff(j)=eps_final_a(j)/sum((P(n,:)+.00001).\hat{ }2);
        err_in_p=zeros(numexps,1);
        if n<=numexps
          err_in_p(n)=err(n);
        end
        wts=(theta_final(j,:).\hat{ }2*(gene_err(:,index(j,:))’.\hat{ }2)+err_in_p’);
        if (prod(abs(wts)))==0
          chi(j)=1e6;
        else
          chi(j)=sum((([P(n,:)]−theta_final(j,:)*y(index(j,:),:)).\hat{ }2)./wts);
        end
        theta_final(j,:)=theta_final(j,:).*T(n,index(j,:));
      elseif (cond((y(index(j,:),:))*(y(index(j,:),:))’)<=1000 &
isempty(find(index(j,:)==n))==1)
    %  Q(4,4)=.01;
    %  Q(2,2)=100;
    %  Q(3,3)=100;
    %  Q(5,5)=100;
        mod_y=y(index(j,:),:);
        mod_P=P(n,:)+y(map_exps(n),:);
        X=mod_y’;
        b=mod_P’;
        theta_final(j,:)=(inv(X’*Q*X+delta*eye(size(X’*X)))*X’*Q*b)’;
        eps_final_a(j)=sum(([P(n,:)+y(map_exps(n),:)]−
theta_final(j,:)*y(index(j,:),:)).\hat{ }2);
        coeff(j)=eps_final_a(j)/sum((P(n,:)+y(n,:)).\hat{ }2);
        err_in_p=zeros(numexps,1);
        if n<=numexps
          err_in_p(n)=err(n);
        end
wts=(theta_final(j,:).\hat{ }2*(gene_err(:,index(j,:)’.\hat{ }2)+err_in_p’+gene_err(:,n)’);
        if prod(abs(wts))==0
          chi(j)=1e6;
        else
          chi(j)=sum((([P(n,:)+y(map_exps(n),:)]−
theta_final(j,:)*y(index(j,:),:)).\hat{ }2)./wts);
        end
        theta_final(j,:)=theta_final(j,:).*T(n,index(j,:));
        else
          theta_final(j,:)=zeros(size(index(j,:)));
          eps_final_a(j)=1e6;
          coeff(j)=1e6;
          chi(j)=1e6;
        end
        % confidence interval for each solution
        lambda_hat(j)=(1/(numexps−k_input))*eps_final_a(j);
        if (cond((y(index(j,:),:))*(y(index(j,:),:))’)<=1000)
var_hat(j,:)=sqrt(diag(lambda_hat(j)*(inv(store(index(j,:),:)*store(index(j,:),:)’)))’);
        else
          var_hat(j,:)=ones(size(index(j,:)))*1e6;
        end
      end;
      aa=find(sum(abs(theta_final’))>0);
      if (isempty(aa))
        msg=‘something wrong’
        more_one=1;
      else
        more_one=0;
      end;
      if (more_one==0 & max(abs(U(:,map_exps(n))))>0 )
        if cost==1
          rr=find(lambda_hat<=min(lambda_hat));
        else
          rr=find(sum(var_hat’)<=min(sum(var_hat’)));
        end
        if length(rr)>1
          msg=‘more than one sol with small variance’
          rr=rr(1);
        end
        theta_gene_eps(map_exps(n),index(rr,:))=theta_final(rr,:);
        if (theta_gene_eps(map_exps(n),map_exps(n))==0)
          theta_gene_eps(map_exps(n),map_exps(n))=−1;
        end
        yy=bkp_y(index(rr,:),:);
        err_in_p=zeros(numexps,1);
        if n<=numexps
          err_in_p(n)=err(n);
        end
        R=diag(err_in_p’+(theta_gene_eps(n,:).\hat{ }2*(gene_err’.\hat{ }2)));
cov_param(map_exps(n),index(rr,:))=diag(inv(yy*Q*yy’)*yy*Q*R*Q*yy’*inv(yy*Q*
yy’))’;
        out.c(n)=1−coeff(rr);
        out.d(n)=chi(rr);
%%%%%%%%%%%%%%%%%%%%%%%%%%%%%%%%%%%%%%%
        % correct if converged to null solution
%%%%%%%%%%%%%%%%%%%%%%%%%%%%%%%%%%%%%%%
        new_theta_final=[ ];
        new_eps_final=0;
        new_std_eps=0;
        new_lambda_hat=[ ];
      elseif (( max(abs(U(:,map_exps(n))))==0 & k_input<N_genes) |
more_one==1)
        msg=‘correction for gene’
        j=0;
        selected=[ ];
        for jtemp=1:nr
          row=[1:N_genes];
          kin=row(index(jtemp,:));
          if (isempty(find(kin==map_exps(n)))==1)
            j=j+1;
            selected(j)=jtemp;
          end
        end
        % cond_list=[ ];
        % confidence interval for each solution
        new_var_hat=var_hat(selected,:);
        new_theta_final=theta_final(selected,:);
        new_lambda_hat=lambda_hat(selected);
        %rr=find(sum(new_var_hat’)<=min(sum(new_var_hat’)));
        if cost==1
          rr=find(new_lambda_hat<=min(new_lambda_hat));
        else
          rr=find(sum(new_var_hat’)<=min(sum(new_var_hat’)));
        end
        if (min(eps_final_a(selected))==1e6)
          msg=‘all greater than cond 10’
        elseif(length(rr)>1)
          rr=rr(1);
          ‘null: more than one solution with eps’
        end;
theta_gene_eps(map_exps(n),:)=zeros(size(theta_gene_eps(map_exps(n),:)));
theta_gene_eps(map_exps(n),index(selected(rr),:))=new_theta_final(rr,:);
        theta_gene_eps(map_exps(n),map_exps(n))=−1;
        eps_gene(map_exps(n))=eps_final_a(selected(rr));
        yy=bkp_y(index(selected(rr),:),:);
        err_in_p=zeros(numexps,1);
        if n<=numexps
          err_in_p(n)=err(n);
        end
%R=diag(err_in_p(n)+gene_err(:,n)’.\hat{ }2+(theta_final(selected(rr),:).\hat{ }2*(gene_err(:,index
(selected(rr),:))’.\hat{ }2)));
        R=diag(err_in_p‘+theta_gene_eps(n,:).\hat{ }2*(gene_err’.\hat{ }2));
cov_param(map_exps(n),index(selected(rr),:))=diag(inv(yy*Q*yy’)*yy*Q*R*Q*yy’*in
v(yy*Q*yy’))’;
        out.c(n)=1−coeff(selected(rr));
        out.d(n)=chi(selected(rr));
      end
      %%%%%%%%%%%%%%%%%%%%%%%%%%
      % corrected
      %%%%%%%%%%%%%%%%%%%%%%%%%%
      clear theta_final eps_final std_eps
      clear theta R row kin kout temp kout cont phi theta_st eps_st
    end;
    out.a=theta_gene_eps;
    out.b=cov_param;
    clear temp theta_gene_std y rr rrs theta_gene_epslklklk
    llklk
```

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the appended claims.

### REFERENCES

1. A. H. Y. Tong, et al, Science 295, 321 (2002).
2. T. I. Lee, et al., Science 298, 799 (2002).
3. T. Ideker, et al., Science 292, 929 (2001).
4. E. H. Davidson, et al., Science 295, 1669 (2002).
5. A. Arkin, P. D. Shen, J. Ross, Science 277, 1275 (1997).
6. S. Maslov, K. Sneppen, Science 296, 910 (2002).
7. E. Ravasz, A. L. Somera, D. A. Mongru, Z. N. Oltvai, A.-L. Barab'asi, Science 297, 1551 (2002).
8. J. Ihmels, et al., Nature Genetics 31, 370 (2002).
9. B. Schwikowski, P. Uetz, S. Fields, Nature Biotechnology 18, 1257 (2000).
10. S. S. Shen-Orr, R. Milo, S. Mangan, U. Alon, Nature Genetics 31, 64 (2002).
11. U.S. Bhalla, R Iyengar, Science 283, 381 (1999).
12. J. S. Edwards, B. O. Palsson, Proceedings of the National Academy of Science USA 97, 5528 (2000).
13. B. Schoeberl, C. Eichler-Jonsson, E. D. Dilles, G. Müller, Nature Biotechnology 20, 370 (2002).
14. H. H. McAdams, L. Shapiro, Science 269, 650 (1995).
15. T. R. Hughes, et al., Cell 102, 109 (2000).
16. H. H. McAdams, A. Arkin, Annual Reviews of Biophysics and Biomolecular Structure 27, 199 (1998).
17. H. de Jong, Journal of Computational Biology 9, 67 (2002).
18. D. Montgomery, E. A. Peck, G. G. Vining, Introduction to Linear Regression Analysis (John Wiley & Sons, Inc., New York, 2001).
19. L. Ljung, System Identification: Theoryfor the User (Prentice Hall, Upper Saddle River, N.J., 1999).
20. A. de la Fuente, P. Brazhnik, P. Mendes, TRENDS in Genetics 18, 395 (2002).
21. D. Thieffry, A. M. Huerta, E. P'erez-Rueda, J. Collado-Vides, BioEssays 20, 433 (1998).
22. H. Jeong, S. P. Mason, A.-L. Barab'asi, Z. N. Oltvai, Nature 411, 41 (2001).
23. J. Courcelle, A. Khodursky, B. Peter, P. O. Brown, P. C. Hanawalt, Genetics 158, 41 (2001).
24. G. C. Walker, in Escherichia Coli and Salmonella: Typhimurium Cellular and Molecular Biology (American Society for Microbiology, Washington D.C., 1996), pp. 1400-1416, second edn.
25. W. H. Koch, R. Woodgate, in DNA Damage and Repair, Vol. 1: DNA Repair in Prokaryotes and Lower Eukaryotes (Humana Press, Inc., Totowa, N.J., 1998), vol. 1, pp. 107-134.
26. A. R. Fern'andez de Henestrosa, et al., Molecular Microbiology 35, 1560 (2000).
27. P. D. Karp, et al., Nucleic Acids Research 2002, 56 (30).
28. K. Lewis, Microbiology and Molecular Biology Reviews 64, 503 (2000).
29. M. R. Volkert, P. Landini, Current Opinion in Microbiology 4, 178 (2001).
30. R. Hengge-Aronis, Cell 72, 165 (1993).
31. Materials and methods are available as supporting material on Science Online.
32. Chunning Ding and Charles Cantor, unpublished results.
33. M. Tomasz, Chemistry and Biology 2, 575 (1995).

We claim:

1. A method of constructing a model of a biological network comprising steps of:
providing a biological system or a plurality of biological systems, each biological system comprising a biological network comprising a plurality of biochemical species having activities;
perturbing the activity of at least one of the biochemical species, thereby causing a response in the biological network;
allowing the biological network to reach a steady state;
determining the response of at least one of the biochemical species in the biological network; and
estimating parameters of the model.

2. The method of claim 1, wherein the model comprises a set of differential equations or a set of difference equations that represent evolution over time of the activities of at least one of the biochemical species.

3. The method of claim 1, wherein the model comprises a polynomial approximation of a set of differential equations or a set of difference equations that represent evolution over time of the activities of at least one of the biochemical species.

4. The method of claim 1, wherein the model comprises a linear approximation of a set of differential equations or a set of difference equations that represent evolution over time of the activities of at least one of the biochemical species.

5. The method of claim 2, 3, or 4, wherein the differential or difference equations are nonlinear.

6. The method of claim 1, wherein determining the response of a biochemical species comprises measuring the activity of the biochemical species.

7. The method of claim 1, wherein the response comprises an alteration in the activity of one or more of the biochemical species in the biological network or no alteration in any of the biochemical species.

8. The method of claim 1, wherein the perturbing step comprises:
applying a perturbation to a different biochemical species in the biological network in each of at least one of the biological systems, each biological system comprising a cell or a population of cells, and wherein the determining step comprises determining the response of at least one of the biochemical species in the biological network in each of at least one of the biological systems after allowing the biological network to reach a steady state.

9. The method of claim 1, wherein the perturbing step comprises:
applying a perturbation to one or more biochemical species in the biological network in each of at least one of the biological systems, each biological system comprising a cell or a population of cells, and wherein the determining step comprises determining the response of at least one of the biochemical species in the biological network in each of at least one of the biological systems after allowing the biological network to reach a steady state.

10. The method of claim 8 or 9, wherein a single biochemical species in the biological network in each biological system is perturbed.

11. The method of claim 8 or 9, wherein multiple biochemical species in each biological system are perturbed simultaneously.

12. The method of claim 8 or 9, wherein each of the biochemical species in the biological network is perturbed in at least one of the biological systems.

13. The method of claim 8 or 9, wherein each of the biological species in the biological network is perturbed in exactly one of the biological systems.

14. The method of claim 8 or 9, wherein less than 100% of the biochemical species in the biological network are perturbed.

15. The method of claim 1, wherein the perturbing step comprises:
applying a perturbation to one or more biochemical species in the biological network in a biological system comprising a cell or a population of cells, and wherein the determining step comprises determining the response of at least one of the biochemical species in the biological network after allowing the biological network to reach a steady state; and
repeating the applying and determining steps for each of at least one of the biochemical species in the biological network.

16. The method of claim 15, wherein a single biochemical species in the biological network is perturbed in each applying step.

17. The method of claim 15, wherein multiple biochemical species are perturbed simultaneously in each applying step.

18. The method of claim 15, wherein each of the biochemical species in the biological network is perturbed in at least one of the applying steps.

19. The method of claim 15, wherein each of the biological species in the biological network is perturbed in exactly one of the applying steps.

20. The method of claim 15, wherein less than 100% of the biochemical species in the biological network are perturbed.

21. The method of claim 1, wherein the biological system is a cell or a population of cells.

22. The method of claim 21, wherein the cell or population of cells is prokaryotic or eukaryotic.

23. The method of claim 1, wherein the activity of a biochemical species is its expression level.

24. The method of claim 1, wherein the biochemical species comprise at least one of genes, deoxyribonucleic acids, ribonucleic acids, polypeptides, and metabolites, and wherein the activity of a biochemical species is its amount, concentration, maximum catalytic rate or expression level.

25. The method of claim 1, wherein the step of estimating parameters comprises steps of:
selecting a fitness function; and
either computing the values of the parameters that optimize the fitness function; or
(i) selecting a search procedure; and
(ii) applying the selected search procedure so as to identify the values of the parameters that optimize the selected fitness function.

26. The method of claim 25, wherein determining the response of a biochemical species comprises measuring the activity of the biochemical species, and wherein the fitness function compares measured values of the perturbations applied in the perturbing step with predictions of the measured values of the perturbations.

27. The method of claim 26, wherein the predictions are obtained by using the measured activity values, selected values of the parameters, and the model to calculate values of the perturbations that would produce the measured activities, given the selected values of the parameters and the model.

28. The method of claim 25, wherein the fitness function is selected from the group consisting of: a minimum total square error function, a maximum square error function, and a total absolute error function.

29. The method of claim 25, wherein the search procedure is selected from the group consisting of: a Simplex algorithm, a gradient descent algorithm, and a simulated annealing algorithm.

30. The method of claim 25, further comprising the step of:
imposing a constraint on the biological network so as to limit values that may be used to optimize the fitness function.

31. The method of claim 30, wherein the search procedure is selected from the group consisting of: a Simplex algorithm, a gradient descent algorithm, and a simulated annealing algorithm.

32. The method of claim 30, wherein the constraint comprises one or more constraints selected from the group consisting of: (i) fixing the number of regulatory inputs to each biochemical species; (ii) minimizing the number of non-zero parameters; (iii) restricting parameters to discrete values; and (iv) requiring parameters that provide a dynamically stable model.

33. The method of claim 32, further comprising the step of:
estimating the number of regulatory inputs to each biochemical species, wherein the constraint comprises fixing the number of regulatory inputs to each biochemical species.

34. The method of claim 32, wherein the constraint comprises selecting the maximum number of regulatory inputs to each biochemical species and, wherein the search procedure comprises:
(a) generating all putative network structures including one or more regulatory inputs per biochemical species, but not more regulatory inputs than the maximum number of regulatory inputs;
(b) calculating or searching for parameters that optimize a chosen fitness function for each putative network structure; and
(c) selecting as a solution whichever of the putative networks of step (b), comprising a network structure and parameters, optimizes the fitness function.

35. The method of claim 34, wherein the fitness function compares measured values for perturbations applied in the perturbing step with predictions of the measured values of the perturbations.

36. The method of claim 35, wherein the predictions are obtained by using the measured activity values, selected values of the parameters, and the model to calculate values of the perturbations that would produce the measured activities, given the selected values of the parameters and the model.

37. The method of claim 32, wherein the constraint comprises fixing the number of regulatory inputs to each biochemical species; and wherein the search procedure comprises steps of:
(a) generating one or more putative network structures including one or more input connections per biochemical species;
(b) calculating or searching for parameters that optimize a chosen fitness function for each putative network structure;
(c) selecting one or more of the networks of step (b), each putative network comprising a structure and parameters, with optimal fitness as determined by the fitness function;
(d) determining whether any of the putative networks selected in part (c) satisfies some chosen stop criterion;
(e) if the stop criterion is met, stopping the search and selecting one or more putative network structures and parameters; and
(f) if the stop criterion is not met, generating one or more variants of the network structures selected in step (c) and returning to step (b).

38. The method of claim 37, wherein the fitness function compares measured values for perturbations applied in the perturbing step with predictions of the measured values of the perturbations.

39. The method of claim 38, wherein the predictions are obtained by using the measured activity values, selected values of the parameters, and the model to calculate values of the perturbations that would produce the measured activities, given the selected values of the parameters and the model.

40. The method of claim 37, wherein the searching in step (b) is performed using a search procedure selected from the group consisting of: a Simplex algorithm, a gradient descent algorithm, and a simulated annealing algorithm.

41. The method of claim 37, wherein the search procedure is selected from the group consisting of: Forw-reest-K, Forw-TopD-reest-K, Forw-Float-K, Back-K, Back-reest-K, Genalg-SteadyState-K, Genalg-Gen-K, and Exhaustive-K.

42. The method of claim 37, wherein the stop criterion requires that the putative network attains a predetermined level of fitness, that the putative network comprises a selected number of regulatory inputs, or that the change in the level of fitness between subsequent iterations of the steps (b) and (c) is less than a predetermined amount.

43. The method of claim 32, wherein the constraint comprises minimizing the number of nonzero parameters.

44. The method of claim 43, wherein the fitness function is the total square error function and the search procedure identifies auxiliary parameters that minimize a function consisting of the sum of (i) the minimum length vector of the parameters that minimize the total square error fitness function and (ii) the product of (a) the auxiliary parameters and (b) a matrix of vectors spanning the nullspace of a matrix comprising the measured activities.

45. The method of claim 1, wherein the estimated parameters are considered random variables; and comprising the additional step of estimating the probability density function for each estimated parameter.

46. The method of claim 45, wherein estimating the probability density function for each estimated parameter comprises estimating one or more of the first, second, third or higher moments of the probability density function.

47. The method of claim 46, wherein one or more of the first, second, third or higher moments of the probability density function for each parameter are estimated using the measured activity values and the measured perturbation values.

48. The method of claim 47, wherein the estimated first and second moments of the probability density functions of the estimated parameters are used to calculate the statistical significance of the one or more of the estimated parameters.

49. The method of claim 48, wherein the statistical significance of one or more of the estimated parameters are calculated using one or more tests selected from the group consisting of the z-test, the t-test, and the chi-squared-test.

50. A method of performing sensitivity analysis on a biological network comprising steps of:
generating or providing a model of the biological network according to the method of claim 1; and
determining the sensitivity of the activities of a first set of one or more species in the network to a change in the activities of a second set of one or more species in the network using the model.

51. The method of claim 50, further comprising the step of:
identifying the second set of species as a major regulator of the first set of species if the sensitivity of the first set of species to a change in the activities of the second set of species meets a predefined criterion.

52. The method of claim 50, wherein the determining step comprises:
inverting a matrix of parameters of the model, wherein the parameters quantify regulatory relationships between species in the model, thereby obtaining a gain matrix, wherein each column or row of the gain matrix represents the sensitivity of species in the model to a perturbation of one of the species.

53. The method of claim 50, wherein the sensitivity of the activities a first set of biochemical species to a change in the activities of a second set of biochemical species is a measure of the change in activities of the first set of species in response to a change in activities of the second set of species.

54. The method of claim 53, wherein the measure is a quantitative measure.

55. The method of claim 54, wherein the quantitative measure is the mean percentage change in activities of the first set of species in response to a unit change in activities of the second set of species.

56. The method of claim 51, wherein the predefined criterion is a requirement that sensitivity of the activities of at least one species in the first set of species to a change in the activities of the second set of activities is statistically different from zero.

57. The method of claim 51, wherein the predefined criterion is a requirement that the sensitivity of the activities of at least one species in the first set of species to a change in the activities of the second set of activities exceeds a predetermined value.

58. The method of claim 51, wherein the predefined criterion is a requirement that the sensitivity of the activities of the first set of species to a change in the activities of the second set of species is greater than the sensitivity of the first set of species to a change in the activities of a third set of one or more species.

59. A method of identifying a target of a perturbation comprising steps of:
providing a biological system comprising a biological network comprising a plurality of biochemical species having activities;
providing or generating a model of the biological system constructed according to the method of claim 1;
perturbing one or more biochemical species in the network;
allowing the biological network to reach a steady state;
determining the response of at least one of the biochemical species in the biological network to the compound; and
calculating predicted perturbations of biochemical species in the biological network that would be expected to yield the determined responses according to the model.

60. The method of claim 59, wherein the perturbing step comprises contacting the biological system with a compound, thereby causing a response in the biological network, and wherein the target is a target of the compound.

61. The method of claim 59, further comprising the step of:
identifying a biochemical species as a target of the perturbation if the predicted perturbation to that biochemical species meets a predefined criterion.

62. The method of claim 61, wherein the predefined criterion is a requirement that the strength of the predicted perturbation to the biochemical species exceeds a predetermined value.

63. The method of claim 61, wherein the predefined criterion is a requirement that the strength of the predicted perturbation is identified as statistically significant.

64. The method of claim 63, wherein apredicted perturbation is identified as statistically significant by using a statistical test selected from the group consisting of the z-test, the t-test, and the chi-squared-test.

65. The method of claim 64, wherein the statistical test is used with estimates of the first and second moments of the probability density functions of the predicted perturbations, wherein the estimates of the first and second moments are calculated from measured values of the responses of the biochemical species and measured values of the perturbations applied in the perturbing step.

66. A method for identifying phenotypic mediators comprising steps of:
comparing parameters of models of biological networks for a plurality of biological systems, wherein the models are generated according to the method of claim 1, and wherein the biological networks comprise overlapping or substantially identical sets of biochemical species; and
identifying biochemical species for which associated parameters differ between the models as candidate phenotypic mediators.

67. The method of claim 66, wherein one or more of the biological systems display differences in one or more properties.

68. The method of claim 66, wherein the properties include the steady-state activities of the biochemical species of the biological system, the phenotype of the biological system, and the genotype of the biological system.

69. The method of claim 66, wherein a species is identified as a phenotypic mediator if the difference between the parameters for that species in some or all of the models satisfies a predefined criterion.

70. The method of claim 69, wherein the predefined criterion is a requirement that the difference exceeds a predefined value.

71. The method of claim 69, wherein the predefined criterion is a requirement that the difference achieves a particular level of statistical significance.

72. A computer system for constructing a model of a biological network, the computer system comprising:
memory that stores a program comprising computer-executable process steps; and
a processor which executes the process steps so as to construct a model of a biological network, the model comprising an approximation to a set of differential equations or a set of difference equations that represent evolution over time of activities of at least one biochemical species in a biological network.

73. The computer system of claim 72, wherein the process steps estimate parameters of and select a structure for a model of a biological network.

74. The computer system of claim 73, wherein the process steps comprise steps of:
(a) selecting or receiving a selection of a fitness function; and
(b) either computing the values of the parameters that optimize the fitness function; or
(i) selecting or receiving a selection of a search procedure; and
(ii) applying the search procedure so as to identify the values of the parameters that optimize the fitness function.

75. The computer system of claim 74, wherein the search procedure comprises:
(a) generating all putative network structures including one or more regulatory inputs per biochemical species, but not more regulatory inputs than the maximum number of regulatory inputs;
(b) calculating or searching for parameters that optimize a chosen fitness function for each putative network structure; and
(c) selecting as a solution whichever of the putative networks of step (b), comprising a network structure and parameters, optimizes the fitness function.

76. A computer system for performing sensitivity analysis of a biological network, the computer system comprising:
memory that stores a program comprising computer-executable process steps; and
a processor which executes the process steps so as to
(i) generate or receive a model of a biological network, the model comprising an approximation to a set of differential equations or a set of difference equations that represent evolution over time of activities of at least one biochemical species in a biological network; and
(ii) determine the sensitivity of the activities of a first set of one or more species in the network to a change in the activities of a second set of one or more species in the network using the model.

77. A computer system for identifying a target of a perturbation comprising
memory that stores a program comprising computer-executable process steps; and
a processor which executes the process steps so as to
(i) construct or receive a model of a biological network, the model comprising an approximation to a set of differential equations or a set of difference equations that represent evolution over time of activities of at least one biochemical species in a biological network; and
(ii) receive data comprising responses of at least one of the biochemical species to the perturbation; and
(iii) calculate predicted perturbations of biochemical species in the biological network that would be expected to yield the determined responses according to the model.

78. A computer system for identifying a phenotypic mediator, the computer system comprising:
memory that stores a program comprising computer-executable process steps; and
a processor which executes the process steps so as to
(i) compare parameters of models of biological networks for a plurality of biological systems, wherein the models comprise an approximation to a set of differential equations or a set of difference equations that represent evolution over time of activities of at least one biochemical species in a biological network, and wherein the biological networks comprise overlapping or substantially identical sets of biochemical species; and
(ii) identify one or more biochemical species for which associated parameters differ between the models as candidate phenotypic mediators.

79. Computer-executable process steps stored on a computer-readable medium, the computer-executable process steps to construct a model of a biological network, the computer-executable process steps comprising:
code to construct a model of a biological network, the model comprising an approximation to a set of differential equations or a set of difference equations that represent evolution over time of activities of at least one biochemical species in a biological network.

80. Computer-executable process steps as set forth in claim 79, wherein the code comprises code to estimate parameters of and select a structure for a model of a biological network.

81. Computer-executable process steps as set forth in claim 80, wherein the code to estimate parameters and select a structure comprises
code to select or receive a selection of a fitness function; and
code to perform either or both of (a) and (b), where (a) and (b) are:
(a) code to compute the values of the parameters that optimize the fitness function;
(b) code to
(i) select or receive a selection of a search procedure; and
(ii) apply the selected search procedure so as to identify the values of the parameters that optimize the selected fitness function.

82. Computer-executable process steps as set forth in claim 80, wherein the search procedure comprises steps of:
(a) generating all putative network structures including one or more regulatory inputs per biochemical species, but not more regulatory inputs than the maximum number of regulatory inputs;
(b) calculating or searching for parameters that optimize a chosen fitness function for each putative network structure; and
(c) selecting as a solution whichever of the putative networks of step (b), comprising a network structure and parameters, optimizes the fitness function.

83. Computer-executable process steps stored on a computer-readable medium, the computer-executable process steps to perform sensitivity analysis of a biological network, the computer-executable process steps comprising:
(i) code to generate or receive a model of a biological network, the model comprising an approximation to a set of differential equations or a set of difference equations that represent evolution over time of activities of at least one biochemical species in a biological network; and
(ii) code to determine the sensitivity of the activities of a first set of one or more species in the network to a change in the activities of a second set of one or more species in the network using the model.

84. Computer-executable process steps stored on a computer-readable medium, the computer-executable process steps to identify a target of a perturbation, the computer-executable process steps comprising:
(i) code to estimate parameters of and select a structure for a model of a biological network or to receive estimated parameters of and a structure for a model of a biological network, the model comprising an approximation to a set of differential equations or a set of difference equations that represent evolution over time of activities of at least one biochemical species in a biological network;
(ii) code to receive data comprising responses of at least one of the biochemical species to the perturbation; and
(iii) code to calculate predicted perturbations of biochemical species in the biological network that would be expected to yield the determined responses according to the model.

85. Computer-executable process steps stored on a computer-readable medium, the computer-executable process steps to identify a phenotypic mediator, the computer-executable process steps comprising:
(i) code to compare parameters of models of biological networks for a plurality of biological systems, wherein the models comprise an approximation to a set of differential equations or a set of difference equations that represent evolution over time of activities of at least one biochemical species in a biological network, and wherein the biological networks comprise overlapping or substantially identical sets of biochemical species; and
(ii) code to identify one or more biochemical species for which associated parameters differ between the models as candidate phenotypic mediators.
